(19) United States
(12) Patent Application Publication
(10) Pub. No.: US 2022/0300874 A1
(43) Pub. Date: Sep. 22, 2022

(54) RISK ASSESSMENT METHOD AND PROJECT MANAGEMENT SYSTEM USING SAME

(71) Applicant: Jean-Paul PAQUIN, Longueuil (CA)

(72) Inventor: Jean-Paul PAQUIN, Longueuil (CA)

(21) Appl. No.: 17/686,527

(22) Filed: Mar. 4, 2022

Related U.S. Application Data
(60) Provisional application No. 63/158,104, filed on Mar. 8, 2021.

(51) Int. Cl. G06Q 10/06; G06Q 10/10; G06Q 10/04

(52) U.S. Cl. CPC G06Q 10/0635; G06Q 10/103; G06Q 10/04

(57) ABSTRACT

Described are various embodiments of a risk assessment method and project management system using same. In some embodiments, the system is operable, for each set of risk factors in at least one set of risk factors in a project, to compute a baseline and an overrun contingency reserve corresponding to the associated risk acceptance policy of said each set of risk factors and to a designated assessment metric; and combine said baseline and said overrun contingency reserve for each of said at least one set of risk factors into a single program baseline and program overrun contingency reserve, respectively. The overrun contingency reserve from a probability distribution at said associated risk acceptance policy comprises computing an overrun tail expectation of said single probability distribution above said baseline at a (1−α) significance level corresponding to said risk acceptance policy z(α).

### CROSS-REFERENCE TO RELATED APPLICATIONS

This application claims priority to U.S. Provisional Patent Application No. 63/158,104, filed Mar. 8, 2021, which is incorporated by reference herein in its entirety.

### FIELD OF THE DISCLOSURE

The present disclosure relates to project management, and, in particular, to a risk assessment method and project management system using same.

### BACKGROUND

All the systems and methods that have been developed over the last decades for assessing project cost budgets, and in particular project contingency reserves, have relied on the project cost percentile paradigm, a probabilistic approach defining project contingency reserves from the percentile of a project cost probability distribution. However, despite the plethora of evermore sophisticated methods and models based on the cost percentile paradigm (Baccarini, 2006; Touran, 2010; Khayani, 2011), empirical results show that these methods and models have not lived up to their promises. Considering their low predictive power, one must come to the conclusion that current cost budgeting methods are far from having reached the status of “settled science”, that a paradigm shift is in dire need in order to remedy such a dismal situation. A similar paradigm shift addressing the same fundamental issues has already taken place decades ago in the banking and capital investment industries.

Data on the construction and transportation industries are of great interest to anyone investigating the success rate and efficacy of budgeting techniques and models for one may find a trove of information to that effect. Moreover, such an investigation may focus on the effectiveness of the cost percentile paradigm to the extent that all major construction and transportation projects have been and are still based on the standard cost percentile paradigm. Hence, despite claims of improved methods and models, these have shown since their very inception two decades ago a low predictive power in budget accuracy in the construction and transportation capital projects, particularly in public transit projects. (Touran, 2010; Flyvbj erg, 2006). Specific examples from Khayani (2011) show that nearly 50% of all large transportation projects in the U.S. overran their initial budget (Sinnette (2004), that 9 out of 10 reviewed transit projects of the U.S. Department of Transportation sponsored by the Federal Transit Administration (FTA) experienced an average 50.06% cost overrun with respect to their initial cost estimate (Pickrell, 1990). Out of a sample of 258 worldwide transportation projects such as rail, tunnel and bridge construction projects 9 out of 10 projects experienced cost overrun exceeding by 27.6% on average their initial cost estimates, with train projects overrunning their initial cost estimates by 44.7% (Flyvbj erg, 2002).

An FTA (2003) study showed that 16 out of 21, that is 76.2% of transit projects completed in the U.S. between 1990 and 2002 experienced cost overruns exceeding by 20.9% their initial cost estimate. Booz et al. (2005) reviewed 28 transit projects in the U.S. and found that 26 of them, that is 92.8%, experienced cost overrun exceeding by 36.3% their initial cost estimate. Finally, an FTA (2008) study of transit projects completed in the U.S. between 2003 and 2007 showed that 17 out of 21 projects, i.e. 81% of inflation-adjusted projects experienced cost overruns amounting to an average 40.2% over their initial cost estimate. The construction and transportation industries are not the only industries subjected to such frequent and severe cost overruns.

The Standish Group (2004) industry report found that the IT industry had experienced even more dismal results with higher frequency and greater severity of project cost overruns as 43% of IT projects overran their budget by 71%. In short, these results clearly indicate that the use of the standard cost percentile metric leads to the systemic under-estimation of project costs and that a paradigm shift in cost budgeting is needed.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for a risk assessment method and project management system using same that overcome some of the drawbacks of known techniques, or at least, provides a useful alternative thereto. Some aspects of this disclosure provide examples there is provided systems and methods for assessing risk in a project or a multiplicity of projects that rely, in accordance with different embodiments, on a novel risk compounding process, and similarly novel risk assessment metrics, namely the Expected Cost Overrun (ECO), the Expected Time Overrun (ETO) and the Expected Time Overrun Penalty (ETOP) risks measures.

In accordance with one aspect, there is provided a risk assessment and project management system, said project comprising a plurality of project-related activities, the system comprising: a computing device comprising internal memory and an input interface, said input interface operable to receive and store in said internal memory project-related information comprising: for each activity in said plurality of project-related activities: a set of input values corresponding to a designated assessment metric of said project; and at least one set of risk factors, each of said at least one set of risk factors comprising: an associated risk acceptance policy z(α); and a plurality of risk factors, each risk factor comprising: a probability of occurrence; a set of percentage-wise most likely impact values said each activity; and the computing device further comprising at least one digital processor communicatively linked to said internal memory and said input interface and programmed to: derive, for each set of risk factors in said at least one set of risk factors, a baseline and an overrun contingency reserve corresponding to the associated risk acceptance policy of said each set of risk factors and to said designated assessment metric; and combine said baseline and said overrun contingency reserve for each of said at least one set of risk factors into a single program baseline and program overrun contingency reserve, respectively.

In one embodiment, said deriving includes: computing, for each of said at least one set of risk factors, a single probability distribution; generating said baseline from said single probability distribution at said associated risk acceptance policy; and defining said overrun contingency reserve from said single probability distribution at said associated risk acceptance policy.

In one embodiment, said baseline is generated at least from the expectation value and variance of said single probability distribution at said associated risk acceptance policy.

In one embodiment, said defining said overrun contingency reserve from said single probability distribution at said associated risk acceptance policy comprises computing an overrun tail expectation of said single probability distribution above said baseline at a (1−α) significance level corresponding to said risk acceptance policy z(α).

In one embodiment, said overrun tail expectation is computed using an overrun loss function.

In one embodiment, said computing said single probability distribution characterizing each of said at least one set of risk factors comprises the steps of: for each set of risk factors in said at least one set of risk factors, independently: for each activity in said project-related activities: compound said probability of occurrence and said percentage-wise most likely impact value on said set of input values for said activity to obtain a corresponding set of compounded values; characterize said activity via a probability distribution from said set of compounded values; combine said probability distribution characterizing each activity into said single probability distribution characterizing said plurality of project-related activities for said each set of risk factors in at least one set of risk factors on said project.

In one embodiment, said set input values comprises an estimated minimum value and an estimated maximum value of said assessment metric, and wherein said set of compounded values comprises a corresponding compounded minimum value and a compounded maximum value.

In one embodiment, said probability distribution is a uniform probability distribution bounded by said compounded minimum value and said compounded maximum value.

In one embodiment, said probability distribution is a Normal probability distribution.

In one embodiment, said set of input values further comprise an estimated most likely value of said assessment metric, and wherein said set of compounded values comprises a corresponding compounded most likely value.

In one embodiment, said characterizing said activity via a probability distribution from said set of compounded values comprises: constructing a PERT-Beta probability distribution using said compounded minimum value, compounded maximum value and compounded most likely value; defining said normal probability distribution as having the same expected value and variance as said PERT-Beta probability distribution.

In one embodiment, said at least one set of risk factors comprises at least one of a set of endogenous risk factors and a set of exogenous risk factors.

In one embodiment, said project is included in a project portfolio, said project portfolio comprising a multiplicity of projects, the system further being operable to, via said input interface, to receive: said project-related information for each project in said project portfolio; a set of correlation coefficients characterizing the correlation between the assessment metric of each project in said project portfolio; and wherein said at least one digital processor being further programmed to: for each set of risk factors in said at least one set of risk factors: for each project in said project portfolio: computing said one probability distribution; and combining the one probability distribution of each project to define a corresponding portfolio probability distribution; deriving a portfolio baseline and portfolio overrun contingency reserve at said corresponding risk acceptance policy; combining each portfolio baseline to obtain a portfolio program baseline and each portfolio overrun contingency reserve to obtain a portfolio program overrun contingency reserve.

In one embodiment, said designated assessment metric is execution cost.

In one embodiment, said designated assessment metric is execution time.

In one embodiment, the system further comprises a remote database, said remote database having stored therein at least some of said project-related information; and a network interface communicatively linked to said at least one processor and said internal memory, and operable to retrieve from said remote database said at least some of said project-related information.

In one embodiment, the system further comprises an output interface communicatively linked to said at least one processor, and operable to display information on a pixel display; and said at least one digital processor programmed to generate a Graphical User Interface (GUI) on said pixel display.

In accordance with another aspect, there is provided a risk-assessment method, implemented by one or more digital processors, for assessing execution costs in a project at a risk measure policy, said risk measure policy corresponding to a given (1−α) significance level, the process comprising the steps of: characterizing the costs of said project by a designated probability distribution; and computing a project cost overrun tail expectation above a project cost baseline at the (1−α) significance level via said probability distribution.

In one embodiment, said project cost baseline is defined as the expectation value of said designated probability distribution added to the product of said z(α) risk acceptance policy with the standard deviation of said designated probability distribution.

In one embodiment, said project cost overrun tail expectation is computed via the use of a project cost overrun loss function.

In one embodiment, said designated probability distribution is a uniform probability distribution.

In one embodiment, said project comprises a multiplicity of project-related activities, each activity in said multiplicity of project-related activities being characterized by a set of input cost values, said input cost values comprising an estimated minimum cost and an estimated maximum cost of said activity; and wherein said designated probability distribution is characterized by: for each activity in said multiplicity of project-related activities: deriving from said set of input values a corresponding set of compounded values; computing for that activity a uniform probability distribution bounded by said set of compounded values; and constructing said designated probability distribution by combining the expectation value and variance of said uniform probability distribution for each activity.

In one embodiment, said project comprises a multiplicity of risk factors, each risk factor being characterized by a probability of occurrence and a cost impact on each activity in said multiplicity of project-related activities; and wherein said deriving of said set of compounded values comprises the steps of: compounding the probability of occurrence and the cost impact of each risk factor with the activity cost triplet to obtain said set of compounded values.

In one embodiment, said multiplicity of risk factors comprises at least one of a set of endogenous risk factors and a set of exogenous risk factors.

In one embodiment, said designated probability distribution is a normal probability distribution.

In one embodiment, said project comprises a multiplicity of project-related activities, each activity in said multiplicity of project-related activities being characterized by an activity cost triplet, said triplet comprising the most likely estimated cost, the minimum estimated cost and the maximum estimated cost of said project; and wherein said PERT-Beta Risk Compounding Process comprises the steps of: for each activity: deriving from said activity cost triplet a corresponding compounded PERT-Beta cost triplet; computing a corresponding activity PERT-Beta cost probability distribution from said compounded PERT-Beta triplet; and constructing a project PERT-Beta cost probability distribution by combining the expectation value and variance of each of said activity PERT-Beta cost probability distribution; defining said designated probability distribution as having the same expected value and variance as the project PERT-Beta cost probability Distribution.

In one embodiment, said project comprises a multiplicity of risk factors, each risk factor being characterized by a probability of occurrence and a cost impact on each activity in said multiplicity of project-related activities; and wherein said deriving of said compounded PERT-Beta cost triplet comprises the steps of: compounding the probability of occurrence and the cost impact of each risk factor with the activity cost triplet to obtain said compounded PERT-Beta cost triplet.

In one embodiment, said multiplicity of risk factors comprises at least one of a set of endogenous risk factors and a set of exogenous risk factors.

In accordance with another aspect, there is provided a risk-assessment method, implemented by one or more digital processors, for assessing execution time in a project at a risk measure policy, said risk measure policy corresponding to a given (1−α) significance level, the process comprising the steps of: characterizing the execution time of said project by a designated probability distribution; and computing a project execution cost overrun tail expectation above a project execution time baseline at the (1−α) significance level via said probability distribution.

In one embodiment, said project execution time baseline is defined as the expectation value of said designated probability distribution added to the product of said z(α) risk acceptance policy with the standard deviation of said designated probability distribution.

In one embodiment, said project execution time overrun tail expectation is computed via the use of a project execution time overrun loss function.

In one embodiment, said designated probability distribution is a uniform probability distribution.

In one embodiment, said project comprises a multiplicity of project-related activities, each activity in said multiplicity of project-related activities being characterized by a set of input execution time values, said input execution time values comprising an estimated minimum execution time and an estimated maximum execution time of said activity; and wherein said designated probability distribution is characterized by: for each activity in said multiplicity of project-related activities deriving from said set of input values a corresponding set of compounded values; computing for that activity a uniform probability distribution bounded by said set of compounded values; and constructing said designated probability distribution by combining the expectation value and variance of said uniform probability distribution for each activity.

In one embodiment, said project comprises a multiplicity of risk factors, each risk factor being characterized by a probability of occurrence and an execution time impact on each activity in said multiplicity of project-related activities; and wherein said deriving of said set of compounded values comprises the steps of: compounding the probability of occurrence and the execution time impact of each risk factor with the activity execution time triplet to obtain said set of compounded values.

In one embodiment, said multiplicity of risk factors comprises at least one of a set of endogenous risk factors and a set of exogenous risk factors.

In one embodiment, said designated probability distribution is a normal probability distribution.

In one embodiment, said project comprises a multiplicity of project-related activities, each activity in said multiplicity of project-related activities being characterized by an activity execution time triplet, said triplet comprising the most likely estimated execution time, the minimum estimated execution time and the maximum estimated execution time of said project; and wherein said PERT-Beta Risk Compounding Process comprises the steps of: for each activity: deriving from said activity execution time triplet a corresponding compounded PERT-Beta cost triplet; computing a corresponding activity PERT-Beta execution time probability distribution from said compounded PERT-Beta triplet; and constructing a project PERT-Beta cost probability distribution by combining the expectation value and variance of each of said activity PERT-Beta execution time probability distribution; defining said designated probability distribution as having the same expected value and variance as the project PERT-Beta execution time probability Distribution.

In one embodiment, said project comprises a multiplicity of risk factors, each risk factor being characterized by a probability of occurrence and an execution time impact on each activity in said multiplicity of project-related activities; and wherein said deriving of said compounded PERT-Beta execution time triplet comprises the steps of: compounding the probability of occurrence and the execution time impact of each risk factor with the activity execution time triplet to obtain said compounded PERT-Beta execution time triplet.

In one embodiment, said multiplicity of risk factors comprises at least one of a set of endogenous risk factors and a set of exogenous risk factors.

In one embodiment, the method further comprises the step of: deriving an execution time overrun penalty by multiplying said project execution time overrun tail expectation with a constant cost penalty per unit of execution time overrun.

In accordance with another aspect, there is provided a non-transitory computer-readable medium having statements and instructions stored thereon to be executed by a digital processor to automatically receive: project-related information comprising: for each activity in said plurality of project-related activities: a set of input values corresponding to a designated assessment metric of said project; and at least one set of risk factors, each of said at least one set of risk factors comprising: an associated risk acceptance policy z (a); and a plurality of risk factors, each risk factor comprising: a probability of occurrence; a set of percentage-wise most likely impact values said each activity; and derive, for each set of risk factors in said at least one set of risk factors, a baseline and an overrun contingency reserve corresponding to the associated risk acceptance policy of said each set of risk factors and to said designated assessment metric; and combine said baseline and said overrun contingency reserve for each of said at least one set of risk factors into a single program baseline and program overrun contingency reserve, respectively.

In one embodiment, said deriving includes: computing, for each of said at least one set of risk factors, a single probability distribution; generating said baseline from said single probability distribution at said associated risk acceptance policy; and defining said overrun contingency reserve from said single probability distribution at said associated risk acceptance policy.

In one embodiment, said baseline is generated at least from the expectation value and variance of said single probability distribution at said associated risk acceptance policy.

In one embodiment, said defining said overrun contingency reserve from said single probability distribution at said associated risk acceptance policy comprises: computing an overrun tail expectation of said single probability distribution above said baseline at a (1−α) significance level corresponding to said risk acceptance policy z(α).

In one embodiment, said overrun tail expectation is computed using an overrun loss function.

In one embodiment, said computing said single probability distribution characterizing each of said at least one set of risk factors comprises the steps of: for each set of risk factors in said at least one set of risk factors, independently: for each activity in said project-related activities: compound said probability of occurrence and said percentage-wise most likely impact value on said set of input values for said activity to obtain a corresponding set of compounded values; characterize said activity via a probability distribution from said set of compounded values; combine said probability distribution characterizing each activity into said single probability distribution characterizing said plurality of project-related activities for said each set of risk factors in at least one set of risk factors on said project.

In one embodiment, said set input values comprises an estimated minimum value and an estimated maximum value of said assessment metric, and wherein said set of compounded values comprises a corresponding compounded minimum value and a compounded maximum value.

In one embodiment, said probability distribution is a uniform probability distribution bounded by said compounded minimum value and said compounded maximum value.

In one embodiment, said probability distribution is a Normal probability distribution.

In one embodiment, said set of input values further comprise an estimated most likely value of said assessment metric, and wherein said set of compounded values comprises a corresponding compounded most likely value.

In one embodiment, said characterizing said activity via a probability distribution from said set of compounded values comprises: constructing a PERT-Beta probability distribution using said compounded minimum value, compounded maximum value and compounded most likely value; defining said normal probability distribution as having the same expected value and variance as said PERT-Beta probability distribution.

In one embodiment, said at least one set of risk factors comprises at least one of a set of endogenous risk factors and a set of exogenous risk factors.

In one embodiment, said project is included in a project portfolio, said project portfolio comprising a multiplicity of projects, the system further being operable to, via said input interface, to receive: said project-related information for each project in said project portfolio; a set of correlation coefficients characterizing the correlation between the assessment metric of each project in said project portfolio; and wherein said at least one digital processor being further programmed to: for each set of risk factors in said at least one set of risk factors: for each project in said project portfolio: computing said one probability distribution; and combining the one probability distribution of each project to define a corresponding portfolio probability distribution; deriving a portfolio baseline and portfolio overrun contingency reserve at said corresponding risk acceptance policy; combining each portfolio baseline to obtain a portfolio program baseline and each portfolio overrun contingency reserve to obtain a portfolio program overrun contingency reserve.

In one embodiment, said designated assessment metric is execution cost.

In one embodiment, said designated assessment metric is execution time.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 is a schematic diagram of an exemplary risk assessment and project management system, in accordance with one exemplary embodiment;

FIG. 2 is a schematic diagram of a project and its associated plurality of project activities, which in combination with a plurality of endogenous and exogenous risk factors lead to cost and time overrun, in accordance with one exemplary embodiment;

FIG. 3 is a schematic diagram illustrated an exemplary computing device for executing the system of FIG. 1, in accordance with one embodiment;

FIG. 4 is a process flow diagram of an exemplary project budgeting process for assessing execution costs of a single project, in accordance with one embodiment;

FIG. 5 is a schematic diagram illustrating different examples of single-project-related information used in the process of FIG. 4, in accordance with one embodiment;

FIG. 6 is a schematic diagram illustrating the different examples of project activity parameters used in the process of FIG. 4, in accordance with one embodiment;

FIGS. 7A and 7B are schematic diagrams illustrating different examples of endogenous (7A) and exogenous (7B) related parameters used the process of FIG. 4, in accordance with one embodiment;

FIG. 8 is a schematic diagram illustrating different examples of program-related outputs as generated by the process of FIG. 4, in accordance with one embodiment;

FIG. 9 is a process flow diagram illustrating certain process steps of FIG. 4, in accordance with one embodiment;

FIG. 10 is a process flow diagram illustrating certain process steps of FIG. 4, in accordance with one embodiment;

FIGS. 11A and 11B are process flow diagram illustrating certain process steps of FIG. 9, in accordance with one embodiment;

FIGS. 12A and 12B are graphical plots illustrating an exemplary project endogenous N-cost Normal Probability Distribution and an exemplary project exogenous X-cost probability distribution, respectively, in accordance with one embodiment;

FIG. 13A is a graphical plot illustrating an exemplary project cost overrun loss function under a normal probability distribution, in accordance with one embodiment;

FIG. 13B is a graphical plot illustrating the Expected Cost Overrun Risk Measure as a project cost overrun contingency reserve under a Normal Probability Distribution at the 15% Significance level, in accordance with one embodiment;

FIGS. 14A and 14B are graphical plots illustrating an exemplary project endogenous overrun loss function and Normal N-cost Probability Distribution; and an exemplary project exogenous overrun loss function and Normal X-cost Probability Distribution, respectively, in accordance with one embodiment;

FIG. 15 is a process flow diagram illustrating an exemplary project budgeting process for assessing execution time of a single project, in accordance with one embodiment;

FIG. 16 is a process flow diagram illustrating certain process steps of FIG. 15, in accordance with one embodiment;

FIG. 17 is a process flow diagram illustrating certain process steps of FIG. 15, in accordance with one embodiment;

FIGS. 18A and 18B are process flow diagram illustrating certain process steps of FIG. 16, in accordance with one embodiment;

FIGS. 19A to 19C are exemplary plots of the project time overrun loss function under a normal probability distribution (19A), the project time overrun penalty under the normal probability distribution (19B), and the project time overrun contingency reserve under a normal probability distribution at the 50% significance level with the expected time overrun risk measure (19C), in accordance with one embodiment;

FIG. 20 is an exemplary flow process diagram illustrating a process flow diagram illustrating an exemplary project budgeting process for assessing both execution cost and execution time of a single project, in accordance with one embodiment;

FIGS. 21A and 21B are schematic diagrams illustrating examples of portfolio-related information used by the processes of FIGS. 23 and 24, in accordance with one embodiment;

FIG. 22A to 22C are plots illustrating a Program/Portfolio Cost Baseline and Cost Overrun Loss Function under a Normal Probability Distribution (22A), the Cost Standard Deviation of a Replicated-Project Portfolio under a Normal Probability Distribution (22B), the Expected Cost Overrun of a Replicated-Project Portfolio under a Normal Cost Probability Distribution (22C), in accordance with one embodiment;

FIG. 23 is a process flow diagram of an exemplary an exemplary project budgeting process for assessing execution costs of a portfolio of projects, in accordance with one embodiment;

FIG. 24 is a process flow diagram of an exemplary budgeting process for assessing execution time of a portfolio of projects, in accordance with one embodiment;

FIGS. 25 to 30 are images illustrating exemplary instances of a Graphical User Interface (GUI) used by the BUDGET PRO computer software, in accordance with one embodiment;

FIGS. 31A to 31C are plots illustrating an exemplary project uniform cost probability distribution (31A), a project cost overrun loss function under a uniform probability distribution (31B), and a project expected cost overrun under a uniform probability distribution (31C), respectively, in accordance with one embodiment;

FIGS. 32A to 32D are plots illustrating an exemplary project uniform time probability distribution (32A), a project time overrun loss function under a uniform probability distribution (32B), a project time overrun contingency reserve under a uniform probability distribution (32C), and the project time overrun penalty function over a uniform probability distribution (32D), respectively, in accordance with one embodiment; and

FIGS. 33A to 33D are plots illustrating an exemplary project lognormal cost probability distribution (33A), a project cost overrun loss function under a lognormal probability distribution (33B), a project cost overrun contingency reserve under a lognormal probability distribution (33C), and an exemplary project lognormal cost probability distribution based on an exemplary numeral example (33D), respectively, in accordance with one embodiment; and

FIGS. 34A to 34D are plots illustrating an exemplary project triangular cost probability distribution (34A), a project cost overrun loss function under a triangular probability distribution (34B), a project cost overrun contingency reserve under a triangular probability distribution (34C), and an exemplary project triangular cost probability distribution based on an exemplary numeral example (34D), respectively, in accordance with one embodiment.

Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Various apparatuses and processes will be described below to provide examples of implementations of the system disclosed herein. No implementation described below limits any claimed implementation and any claimed implementations may cover processes or apparatuses that differ from those described below. The claimed implementations are not limited to apparatuses or processes having all of the features of any one apparatus or process described below or to features common to multiple or all of the apparatuses or processes described below. It is possible that an apparatus or process described below is not an implementation of any claimed subject matter.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” may be construed as X only, Y only, Z only, or any combination of two or more items X, Y, and Z (e.g., XYZ, XY, YZ, ZZ, and the like). Similar logic may be applied for two or more items in any occurrence of “at least one . . . ” and “one or more . . . ” language.

Unless defined otherwise, all technical and scientific terms used herein have the same meaning as commonly understood by one of ordinary skill in the art to which this disclosure pertains.

Throughout the specification and claims, the following terms take the meanings explicitly associated herein, unless the context clearly dictates otherwise. The phrase “in one of the embodiments” or “in at least one of the various embodiments” as used herein does not necessarily refer to the same embodiment, though it may. Furthermore, the phrase “in another embodiment” or “in some embodiments” as used herein does not necessarily refer to a different embodiment, although it may. Thus, as described below, various embodiments may be readily combined, without departing from the scope or spirit of the innovations disclosed herein.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or element(s) as appropriate.

As will be described below in more detail, the system and methods described herein rely, in accordance with different embodiments, on novel and more coherent risk measures, so as to allow a user to engineer project costs and/or execution time.

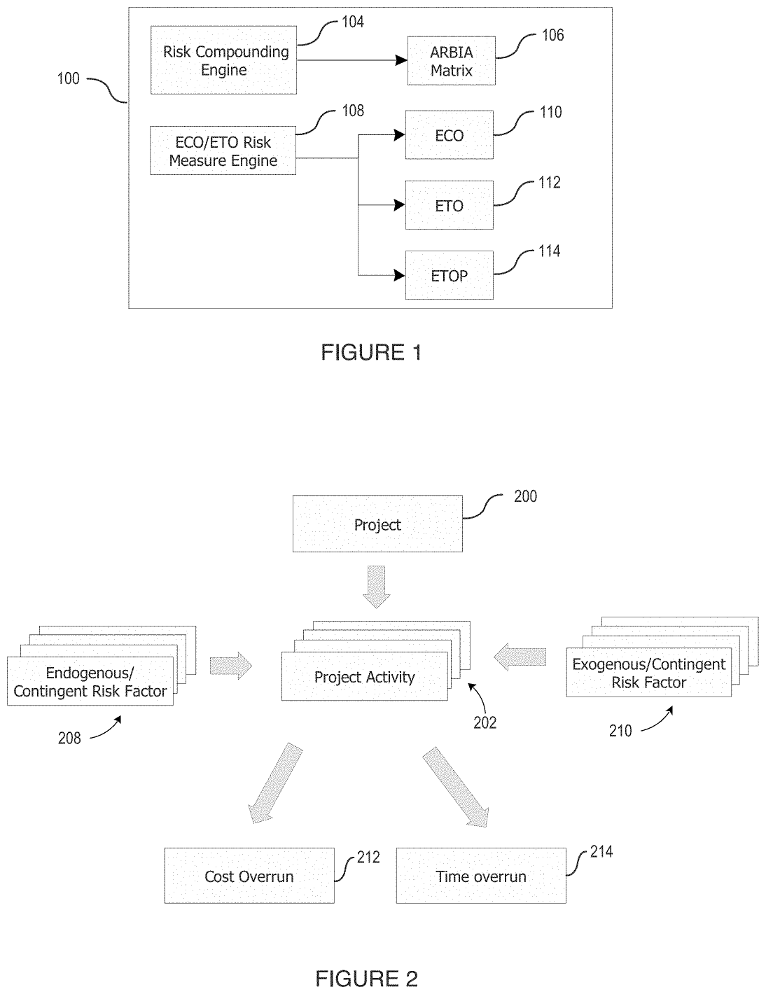

With reference to FIG. 1, and in accordance with one exemplary embodiment, a risk assessment and project management system, generally referred to using the numeral 100, will now be described. System 100 generally takes the form of a computer software product operable to receive or acquire project-related information (or in the case of a program comprising multiple projects, portfolio or program-related information) and automatically generate therefrom a plurality of Program and/or Project-related Budgeting outputs. In accordance with different embodiments, system 100 generally comprises a risk compounding Engine 104 operable to generate a Project Activity Risk Breakdown & Impact Assessment Matrix (ARBIA Matrix 106) and apply thereto a novel risk compounding procedure. In addition, system 100 also generally comprises an ECO/ETO Risk Measuring Engine 108 operable to produce the novel risk measures which will be referred to below as the Expected Cost Overrun risk measure (ECO) 110, the Expected Time Overrun Risk Measure (ETO) 112 and the Expected Time Overrun Penalty (ETOP) 114. These will be described in more details below, and will be used to derive important budgeting information and enable users to correctly assess risk in a single project or project portfolio.

Generally, system 100 and the methods described below rely on a novel way to frame risk assessment in a project or plurality of projects. For example, with reference to FIG. 2, a project 200 herein may be defined as comprising a plurality of project activities 202. As will be made clear below, these activities may be assessed, evaluated or quantified using different types of assessment metrics. For example, in some embodiments, assessment metrics such as execution cost and/or execution time may be used. In addition, a plurality of Risk Factors may be defined which may have an adverse effect on each of activities 202 may also be considered. Herein, in accordance with different embodiments, and as will be discussed further below, the risk factors considered herein will be categorized as including a plurality of Endogenous Risk Factors 208 and a plurality of Exogenous Risk Factors 210. Each risk factor may individually cause an increase of the project's assessment metric, for example the execution costs and/or execution time for each activity, thus causing a cost overrun 212 or a time overrun 214, respectively.

Thus, in some embodiments, system 100 is operable to automatically assess risk and provide budgeting information, including for example cost/time baselines and cost/time contingency reserves. In contrast with known systems, and as will be discussed in detail below, system 100 uses a more precise risk measure for any given project or plurality of projects and thus provides the means to Project Managers (PM) and Program Directors (PD) for automatically assessing risk and managing project overruns, namely the Execution Cost Overrun (ECO) and Execution Time Overrun (ETO) risk measures.

Notably, these are used herein in conjunction with a novel risk compounding process, which allows system 100 to apply a novel risk-assessment procedure using selected probability distributions. Thus, risk compounding engine 104, as will be further described below and in accordance with one embodiment, is operable to model risk using a designated probability distribution. This may include, for example, a PERT-Beta Risk compounding process so as to model risk using a PERT-Beta probability distribution, which may be extended to a Normal Probability Distribution, and/or using a uniform risk compounding process so as to model risk using a uniform probability distribution. These will be described in detail below, in accordance with different embodiments. However, risk compounding engine 104 is not limited to the use of these two designated probability distributions, which are only given as examples, and other types of probability distributions may readily be used as well, without limitation.

In addition, the presently discussed system and method may equally be used in a single-project setting or a multiple-project setting, including for example a portfolio or program comprising a multiplicity of different projects or replicated-projects, as will be made clear below.

The fundamental issue plaguing systems or computer software using the standard cost percentile project contingency reserve definition concerns its basic property as an alleged risk measure. Hence, the project cost baseline, as a cost percentile, is not a coherent risk measure because it is not sub-additive. Sub-additivity is an important property in financial economics to the extent that it ensures that the risk of a project portfolio must be lower than the sum of the risk of the portfolio projects taken on their own. A project cost baseline will prove to measure at any significance level only the minimum value of a project cost overrun and will yield no information on the expected magnitude of project costs that might be overrunning the project cost baseline. The cost percentile suffers from the same fundamental flaw plaguing the loss quantile and therefore disqualifies itself as an appropriate coherent risk measure for assessing project cost overrun contingency reserves. This reason explains by itself the demise of the Value-at-Risk or VaR metric in the capital investment and banking industries following the 2008 financial crisis and its replacement by the Expected Shortfall (ES) risk measure. The ES risk measure proved to be a coherent risk measure for it assesses the tail expectation of the profit & loss (P&L) probability distribution. Hence, as will be discussed below, system 100 uses a new measure, the Expected Cost Overrun (ECO) risk measure, which is a coherent risk measure derived from the tail expectation of project cost probability distributions, is better suited than the project cost percentile metric and may be used to more appropriately to provide cost budgeting information.

Given that all major project budgets are still being determined on the basis of the cost percentile paradigm, a probabilistic approach based on project cost probability distributions, one may assume that most project cost under-estimation issues, and therefore most project cost overrun issues, follow from the following two potent intrinsic causes:
1) Project risk assessment procedures that fail to identify, capture, and assess all and only relevant endogenous risk factors 208 and exogenous risk factors 210 impacting their respective project cost probability distributions;
2) A percentile risk metric that provides information only on the minimum value of a project cost overrun and, therefore, that fails to provide any information on the expected magnitude of costs potentially overrunning the project cost baseline.

Hence, failing to identify, capture, and assess all and only the relevant endogenous and exogenous risk factors impacting project cost probability distributions implies that project risks will be significantly and systematically underestimated. Hence, cost percentile-based methods will therefore always be yielding underestimated cost baselines, cost overrun contingency reserves, and, therefore, underestimated budgets; a perfect recipe for systematically engendering project cost overruns. Secondly, assessing only the minimum value of a project cost overrun and, therefore, failing to cover costs potential overrunning the project cost baseline implies that the project cost percentile contingency reserve will continue to systematically underestimate the project budget and, therefore, to systematically engender project cost overruns. In fact, both potent causes are interrelated for any one of them is sufficient to jeopardize the proper assessment of project cost overrun contingency reserves and budgets, let alone when one combines both of these potent causes together as currently is the case. On the one hand, one must realize that assessing the project contingency reserve with a proper risk measure will nevertheless yield an underestimated cost estimate if the project cost probability distribution does not capture all the relevant risk factors, thus failing to account for potential cost increases from relevant risk factors. On the other hand, assessing the project contingency reserve with a proper project cost probability distribution will still yield an underestimated budget if the risk metric used for assessing the project contingency reserve systematically underestimates the project risk. Consequently, properly assessing a proper project time and cost contingency reserve from its proper project time and cost probability distributions requires the simultaneous fulfillment of two critical conditions, namely that:

(a) The time and cost impacts of all and only relevant project endogenous risk factors 208 and exogenous risk factors 210 be captured by their respective project time and cost probability distributions;
(b) Project time and cost overrun contingency reserves be assessed by the tail expectation of their respective project endogenous and exogenous time and cost probability distributions.

In short, underestimating the project time and cost expected values and/or standard deviations, or adopting a risk metric systematically underestimating the project expected time and cost overruns will always lead, in both cases, to systematic project time and cost underestimations with the resulting project time and cost overruns. It goes without saying that these two intrinsic time and cost estimation issues are to be considered as the most potent causes for project time and cost underestimations. Moreover, as projects are subjected to time overrun cost penalties, it follows that time and cost overrun contingency reserves become interrelated features of time and cost budgeting.

Systematic project cost overruns resulting from cost underestimation methods based on the cost percentile paradigm have been affecting most projects in various industries at the very least the for the last four decades two potent causes can explain such project cost overruns:

(a) An inexistent procedure or an inappropriate method for capturing and incorporating the time and/or cost impacts of relevant endogenous and exogenous risk factors into their respective project time and/or cost probability distributions;
(b) An inappropriate time and cost percentile risk metric measuring but the minimum value of a time or a cost overrun instead of the tail expectation of any project time and/or cost probability distributions.

In order to bring about a workable solution to these two critical issues, in some embodiments, system 100 thus implements, as discussed above, two novel methods that should be at the origin of a paradigm shift in a similar fashion to what happened in the banking and capital investment industries. Thus, system 100 comprises, in accordance with different embodiments, a Risk Compounding Engine 104 and an ECO/ETO risk measure Engine 106. These will be discussed further below.

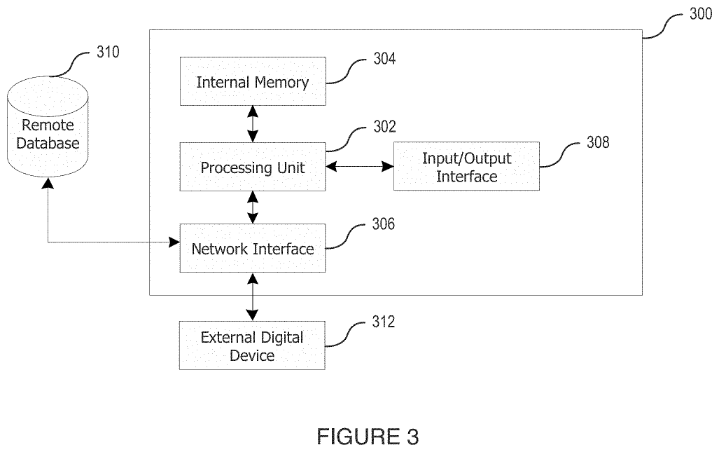

With reference to FIG. 3 and as mentioned above, system 100 may be implemented, in some embodiments, as a computer software product to be executed on a computing device 300. It will be appreciated that computing device 300 may include, for example, a desktop computer, a server, a laptop, tablet and/or smartphone, and/or other computing device, including a plurality of networked computing devices, as may be readily appreciated by the skilled artisan. Thus, computing device 300 generally comprises a processing unit 302 communicatively linked to internal memory 304, a network interface 306 and an input/output interface 308. In some embodiments, computing device 300 may also be communicatively linked, via network interface 306, to at least one remote database 310 and/or to at least one remote digital device 312.

According to some embodiments, internal memory 304 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

In some embodiments, input/output interface 308 may be configured to present information to a user and/or receive inputs from the user. It may include, without limitation, output components such as pixel displays (LCDs, LEDs, etc.) and input components such as keyboards, touch sensitive input panels, buttons, etc. In some embodiments, the input and output components may be integrated, for example in the case of a touch screen or similar.

In some embodiments, system 100 may comprise a graphical user interface (GUI) to be interacted with via input/output interface 308. The GUI may be used both to input Program or Project-related information 102 and to view Program or/and output Project-related Risk Assessment and Budgeting Information 108. In some embodiments, the GUI may also be used to configure system 100 for customizing the GUI interface or similar.

Network interface 306 may comprise a network adapter or similar operable to transmit and receive data via a computer network. The skilled artisan will understand that different means of connecting electronic devices may be considered herein, such as, but not limited to, Ethernet, Wi-Fi, Bluetooth, NFC, Cellular, 2G, 3G, 4G, 5G or similar.

In some embodiments, remote database 310 may be one or more computing devices operable to remotely store information or data used by system 100. In addition, in some embodiments, system 100 may be provided to a user as a pre-compiled executable (or a suite of pre-compiled executables), to be stored and executed on the stand-alone computing device 300, while other embodiments may include implementing system 100 as a Software-as-a-Service (SaaS), thus enabling continuous feature updates, performance improvements and bug fixes to the main software line that can automatically role out to all users. In this case, remote database 310 may take the form of one or more remote servers accessible via a dedicated website or application.

In some embodiments, system 100 may be provided as a pre-compiled (static or dynamic) library comprising a set of functions or data and operable to provide 3^{rd}-party software access to system 100 or at least some features or functionalities thereof. For example, this may include allowing 3^{rd}-party software to use the Risk Compounding Engine 104 or the ECO/ETO risk measure engine 106, but more generally this may also include accessing any feature described herein, without limitation, via a function call or similar. Interfacing between system 100 and 3^{rd}-party software may be done, in some embodiments, via an application programming interface (API).

In some embodiments, system 100 may be operable to connect to 3^{rd}-party databases (not shown) and configured to automatically retrieve project-related data therefrom. In some embodiments, this may include statistical data or similar.

In some embodiments, system 100 may be operable to automatically monitor changes in some project-related information (or portfolio or program related information), for example in data files comprised on computing system 300 itself, external database 310 or 3^{rd}-party database (not shown).

In some embodiments, system 100 may be configured so as to provide different levels of authorization. For example, different user accounts may be provided, with different levels of access to different features of system 100, such as viewing project-related data or similar. In some embodiments, user accounts may require authentication before being accessed.

As mentioned above, system 100 comprises a Risk Compounding Engine 104 operable to implement, according to different embodiments, a risk compounding Process. As will be discussed in more details below, this risk-compounding processes are operable, in accordance with different embodiments, to automatically assess the cost impacts of endogenous and exogenous risk factors on each project activity's Normal and/or Uniform cost probability distributions (for example), with cost statistics based on experientially and non-experientially based project information, and ultimately, on the project's respective endogenous and exogenous cost probability distributions. This risk compounding process requires, as a prerequisite condition, the identification and assessment of every project activity's endogenous and exogenous risk factor most likely expected cost impacts through the project Activity Risk Breakdown and Impact Assessment matrix, hereinafter referred to as the project ARBIA matrix. The project ARBIA matrix must be used in a recursive and dynamic fashion so that active risk response strategies may be devised and eventually implemented in order to lower to an acceptable level the project activities' expected cost overruns. As will be detailed further below, the ‘final tableau’ of the project ARBIA matrix is used in the risk compounding process to assess the project endogenous and exogenous cost probability distributions.

Secondly, the Expected Time/Cost Overrun risk measures (ECO 110 and ETO 112), defined herein as the tail expectation of any project time or cost probability distribution, respectively, may be used as a coherent risk measure possessing a unique and exact closed-form solution under a normal or uniform probability distribution, for example. Hence, having obtained from the risk compounding process the project endogenous and exogenous time and cost probability distributions, one is in a position to assess from the ETO 112 and ECO 110 risk measures the project time and cost overrun contingency reserves and the management time and cost overrun contingency reserves at their respective significance level. Moreover, as will be discussed below, the ECO risk measure 110 may be carried out and extended from a single-project setting to a program/portfolio setting.

In accordance with different embodiments, system 100 is designed to assist:

a) Professional cost engineers and project managers in assessing the endogenous and exogenous risk factors' time and cost impacts on project and management time and cost overrun contingency reserves;
b) The Project Management Office and upper management in deciding risk acceptance policies and tendering project and program/portfolio price bids in risky environments.

In addition, in some embodiments, system 100 may be used not only in a single-project setting, but also in a program/portfolio setting for which the funded program contingency reserve may be used to cover the project cost overrun contingency reserves and the management cost overrun contingency reserves of all the portfolio projects. Hence, all cost overrun contingency reserves must be viewed under the ECO risk measure 110 as intangible insurance coverage claimable when pre-identified and agreed-upon contingent events do materialize. Furthermore, portfolio risk diversification will ensure within a program/portfolio setting that the funded program cost overrun contingency reserve will generally be smaller than the sum of the project and the management cost overrun contingency reserves. Such results imply a paradigm shift away from the standard cost percentile method for which project contingency reserves are tangible fully funded reserves from the very inception of every project, thereby preventing any project portfolio risk diversification from ever occurring and benefiting the organization.

As mentioned above, since risk compounding engine 104 is operable to model risk using different designated probability distributions, this may allow a user to compare results obtained with, for example, the PERT-Beta probability distribution risk compounding process and the Uniform probability distribution risk compounding process (among others), and thus enable decision makers to carry out sensitivity analysis pertaining to the impact on project and management cost overrun contingency reserves and budgets when decision is constrained by limited experiential information on project cost probability distributions. Such sensitivity analysis requires some embodiments to carry out extensive and quasi-intractable computations.

Thus, system 100 may be equally used in project-driven private and public organizations and business firms. Examples include, without limitation:

a) Organizations: One might think of government departments or agencies, or large private organizations and their branches and subsidiaries running important projects and/or program/portfolios. Various government levels, such as those at the municipal, regional, state and federal level, may be involved in time/cost budgeting activities either as project contractors themselves, or as project providers.
b) Construction companies: One might think of large firms executing complex and large construction works such as: high-rise buildings, hospitals, highways, bridges, hydro-electric dams, nuclear power plants, public transit projects, and transportation capital projects.
c) Providers of IT hardware and software products, and IT consulting services: One might think of the considerable costs and risks that large firms must sustain when developing innovative hardware and software IT products, or the financial risks that must face IT consulting firms having to assess the deployment costs in IT transformation and systems integration projects.
d) Consultancy firms in project cost engineering and risk analysis: One might think of medium and large consultancy firms in cost engineering projects providing expertise in project infrastructure design and project management for which cost estimation and risk assessment become critical issues.
e) University programs & professional training schools: One might think of learning milieus providing training to students and practitioners in project management, project cost assessment, and cost budgeting.

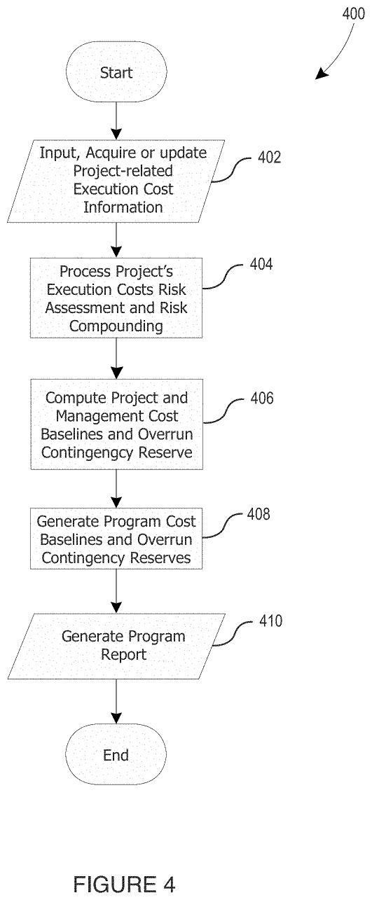

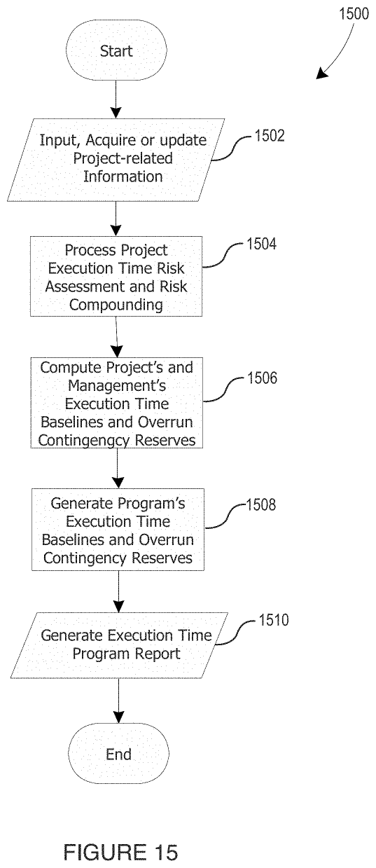

With reference to FIG. 4, and in accordance with one exemplary embodiment, a project budgeting method for assessing execution costs of a single project, herein referred to using the numeral 400, executed by system 100, will now be described. In this exemplary embodiment, method 400, as implemented by system 100 via the Risk Compounding Engine 104 and ECO/ETO Risk Measure Engine 106, is directed towards a single project. As will be described in more detail below, method 400 as described herein, in accordance with one exemplary embodiment, uses execution costs as the designated assessment metric to evaluate a project. A similar method for assessing execution time of a project, using in most parts the same risk compounding process and risk measure, will be discussed further below (i.e. method 1500 of FIG. 15).

Notably, in accordance with the exemplary embodiment of method 400 discussed below, Risk Compounding Engine 104 uses a PERT-Beta probability distribution as an example only. As noted above, other types of probability distributions may be used as well, and these will be discussed further below.

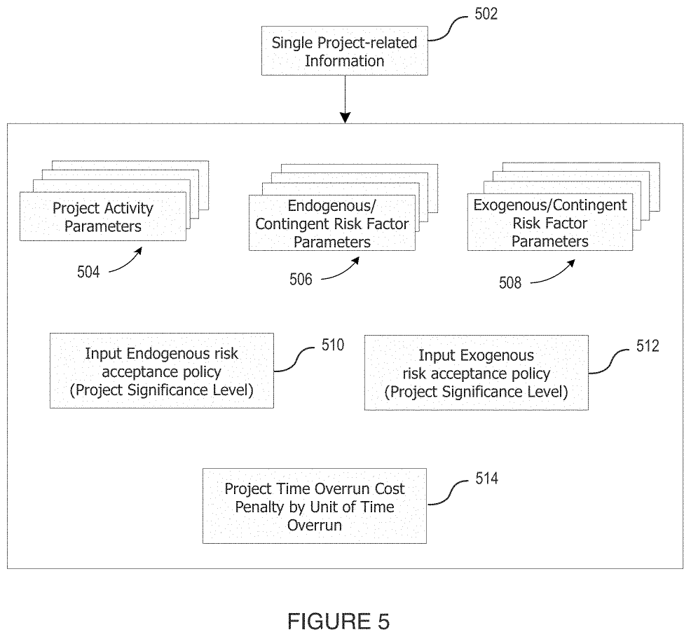

With additional reference to FIG. 4, method 400 starts with step 402, where single project-related information 502 is acquired by system 100 and/or entered by the user. As shown in FIG. 5, the set of single project-related information 502 may include: a set or plurality of project-related activity parameters 504 (one for each activity), at least one set of risk factors, for example a set or plurality of endogenous/contingent risk factor parameters 506 and a set or plurality of exogenous/contingent risk factor parameters 508. Each set of risk factors may have its own risk acceptance policy, for example an input Endogenous risk acceptance policy 510 and input exogenous risk acceptance policy 512. These will be discussed in more detail below. Notably, when discussing execution time instead of execution costs, single project-related information 502 may further include a Project Time Overrun Cost Penalty by Unit of Time Overrun 514.

In some embodiments, information 502 may be entered manually by a user via input/output interface 308, or retrieved, at least in part, from internal memory 304 and/or remote database 310. For example, in some embodiments, data related to previously processed projects or similar projects may be stored in Internal Memory 304 or on Remote Database 310. In some embodiments, a user may be able to retrieve this data and, if required, manually edit or update it to better describe the project being assessed.

In some embodiments, not all of project-related information 502 may be entered or acquired at the beginning of method 400. For example, in some embodiments, the missing information may be requested at a later stage as required.

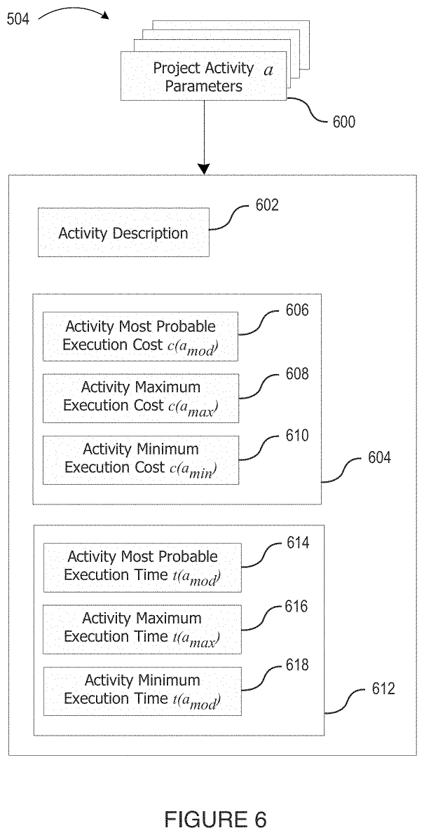

As illustrated schematically in FIG. 6, for each activity in said plurality project-related activity parameters 504, there may be a corresponding set of activity-related parameters 600 which may include: an activity description 602 and one or more sets of input values corresponding to a designated assessment metric (i.e. cost or time, for example). For example, when this designated assessment metric is cost, as is the case in method 400, this may include a set of cost input values 604 may be used, which itself may include, for example, the activity's estimated most probable or most likely cost 606, the activity's estimated maximum cost 608 and/or the activity's estimated minimum cost 610. Similarly, as will be discussed further below in the context of assessing another assessment metric, such as execution time (i.e. as discussed below) an set of execution time input values 612 may be used instead, which similarly may comprise the activity's most probable or most likely execution time 614, maximum execution time 616 and/or minimum execution time 618.

In some embodiments, the value in each of these sets of input values may be entered manually by a user. In some embodiments, at least some values of may be automatically estimated by system 100 based on data acquired from previously processed projects.

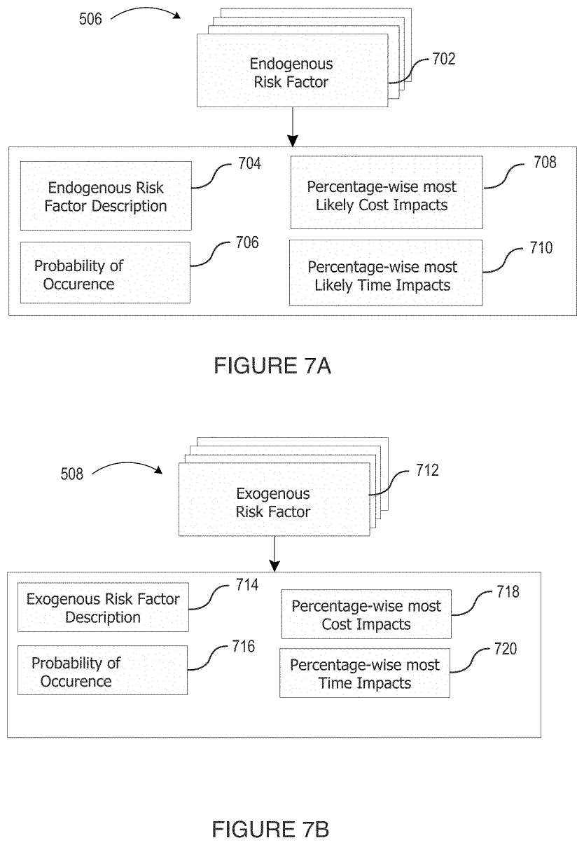

As schematically illustrated in FIGS. 7A and 7B, each risk factor in a set of risk factors, namely an endogenous/contingent risk factor (7A) or an exogenous/contingent risk factor (7B) may itself comprise more information. For example, each of said set of Endogenous/contingent 702 (or said set of Exogenous/contingent 712) Risk Factor parameters may include: a description 704 (714) of said risk factor, a probability of occurrence 706 (716), a list of percentage-wise most likely cost impacts for each activity 708 (718) defined, and, for processes related to execution time instead of execution costs, a list of percentage-wise most likely execution time impacts for each activity 710 (720). These will be discussed further below. In some embodiments, one may readily envision risk factors which may affect execution costs without affecting execution time, or vice-versa. Thus, as will be clear to the skilled technician, in some embodiments, the impact of a given risk factor may be null for a given metric (cost or time) while being non-null for the other. In addition, any data related to execution costs may readily use any monetary units as required.

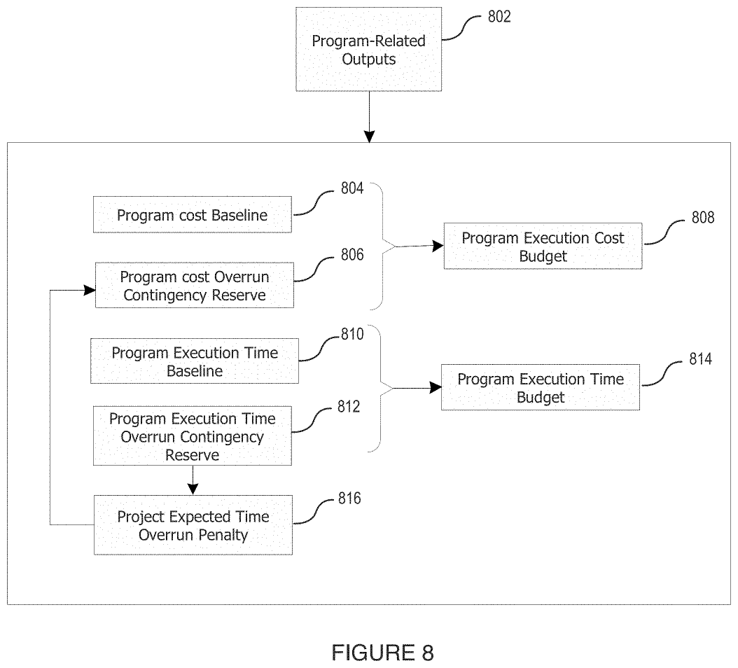

In addition, a multiplicity of program-related outputs will be computed via method 400 and other methods discussed below, in accordance with different embodiments. An exemplary non-limiting list of program-related outputs 802 is shown schematically in FIG. 8. Herein, a program is defined herein as encompassing both the project's execution cost/time (influenced by the endogenous risk factors) and the management of said project (influenced by the exogenous risk factors), thus including therein costs or time associated with both. Thus, examples of program-related outputs for method 400 include a program's execution cost baseline 804 and a program's cost overrun contingency reserve 806, which together make the program's execution cost budget 808. Similarly, when execution time will be discussed further (i.e. method 1500 of FIG. 15), outputs will include similarly a program's execution time baseline 810 and overrun contingency reserve 812, which together will make the program's execution time budget 814. In addition, method 1500 (as illustrated in FIG. 15) discussed below will also be operable to produce a project's expected time overrun penalty (in monetary units) corresponding to the contingency reserve 812, which may be added to the Cost overrun contingency reserve 806, as will be discussed further below.

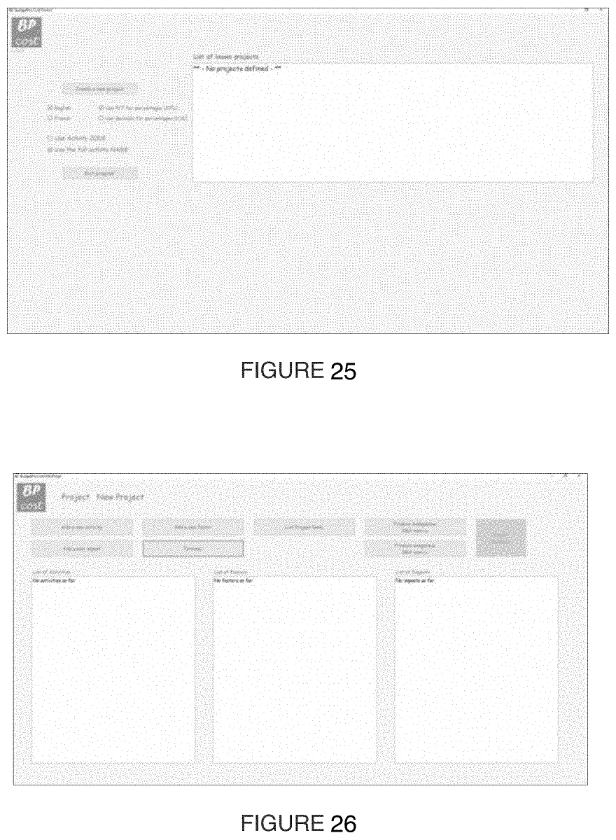

Examples of a GUI for inputting data into system 100 are shown in FIGS. 25 to 30. These images show exemplary GUI windows used by the BUDGET PRO software, which implements, in accordance with different embodiments, the method 400 discussed herein, as well as the different methods discussed further below. In the current implementation, BUDGET PRO is divided into two different products, BUDGET PRO Cost (for assessing execution costs) and BUDGET PRO Time (for assessing execution times). However, these functionalities may be merged into a single product without limitation.

For example, FIG. 25 illustrates an exemplary GUI window for creating a new project for processing the cost budget of a project (or portfolio).

Similarly, FIG. 26 is an exemplary GUI window for entering single project-related information 502, for example the project activity parameters 504, the Endogenous/Contingent Risk Factors 506 and Exogenous/Contingent Risk Factors 508, for example.

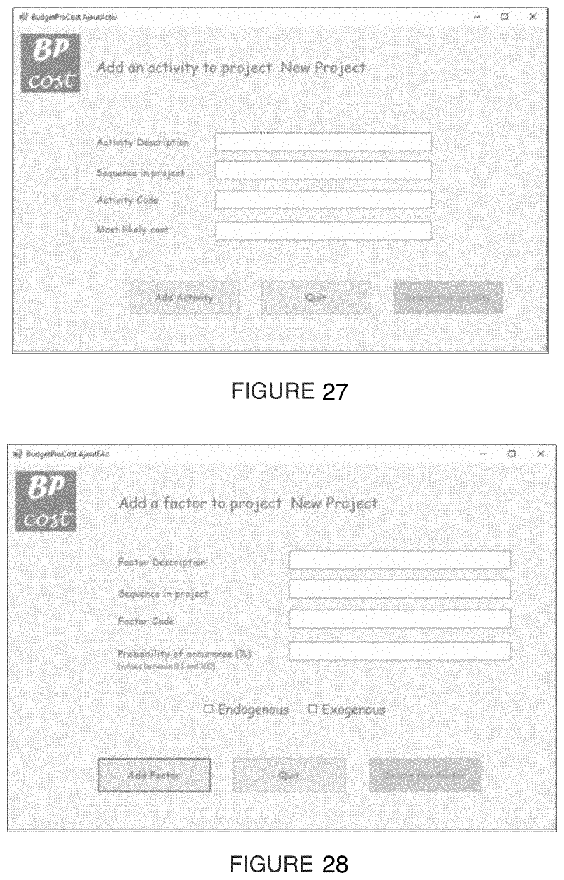

FIG. 27 shows an exemplary GUI window used to enter the list of project activity parameters 500 with the BUDGET PRO software.

FIG. 28 shows an exemplary GUI window used for entering the Endogenous Risk Factor Parameters 702 or 712 with the BUDGET PRO software.

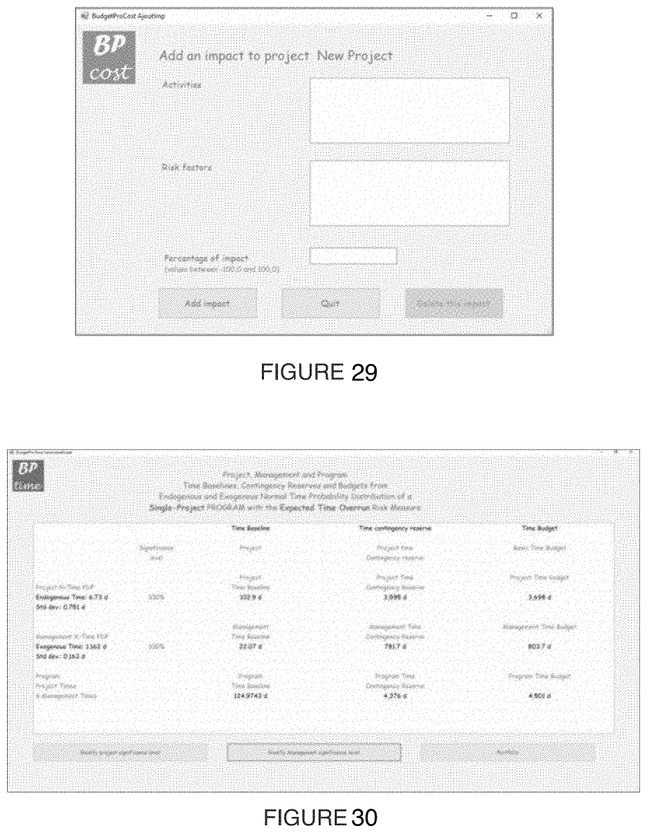

FIG. 29 shows an exemplary GUI window used to enter the list of endogenous (or exogenous) cost impacts 708 (718) for each activity entered via the GUI window of FIG. 27, including for example the description 704 (714) and the probability of occurrence 706 (716).

Importantly, internal and external risk factors cannot be defined without explicitly referring to the hierarchical level to which they tie into within an organization, such as a project, a program, or the organization. In the art project internal risks may be defined as those risks found within the project itself that might impact the cost of project activities. Internal risks are therefore controllable from within the project environment by the project manager (PM). Hence, project external risks must refer to risks found outside the project itself that might still impact the cost of project activities. External risks are therefore controllable from outside the project by the program director (PD). However, we shall substitute the qualifiers ‘endogenous’ and ‘exogenous’ to those of ‘internal’ and ‘external’ to emphasize the fact that endogenous risk factors 208 are random events that are not only found within the project inner environment but that are actually generated from within the project inner environment. In a similar fashion, exogenous risk factors 210 are random events that are generated by factors lying outside the project inner environment and the PM's oversight and control and that might still impact the cost of project activities.

Hence, exogenous risk factors 210 may originate from within the program environment, the organization, and even outside the organization. Endogenous and exogenous risk factors therefore establish a causal relationship between a risk factor, its locus of origin, and the manager responsible for its oversight, assessment and control. Endogenous risk factors become relevant project risk factors falling under the control and authority of the PM; while exogenous risk factors become relevant program risk factors falling under the control and authority of the PD. Hence, a risk factor generated from within the project inner environment should always be controllable from within the project to the extent that the PM is in a position to devise and implement an active risk response strategy and, in particular, a risk mitigation strategy aiming at reducing the probability of occurrence and/or the severity of cost overruns attributable to such risk factors. On the other hand, project exogenous risk factors are those random events generated outside the project inner environment that are uncontrollable by the PM but that might nevertheless impact the cost of project activities. Such exogenous risk factors must therefore fall under the oversight and control of the PD. Controllability of risk factors within a decision unit becomes the distinctive characteristic from which endogenous and exogenous risk factors should be distinguished one from another.

Finally, the concept of risk factor controllability applies equally well to the program and to the organization to the extent that they are controllable by the PD and/or by upper management; therefore falling under their respective oversight, control and responsibility. From within their own decision unit the endogenous/exogenous dichotomy is most important from a management standpoint for it enables PMs and PDs to establish within the organization's hierarchical ranking and decision structure their respective responsibility over the project, the management, and the program contingency reserves.

In compliance with the organization's cost budgeting policies the PD and the PMO will eventually make a determination on the project and the management cost baselines and cost overrun contingency reserves. This cost budgeting exercise will determine the various budgets under the respective responsibility of the PD and the PMs. When the cost budgeting analysis is carried out with the ECO risk measure, all project and management cost overrun contingency reserves must be viewed as claimable insurance coverage for specifically pre-identified and agreed-upon project endogenous and project exogenous contingent events.

At the most basic level of a project one must define and identify the project intrinsic risk factor(s). An intrinsic risk factor is a factor tied to the project per se, that is a risk factor that is tied to the ‘run-of-the-project’ activities as defined by the project work break-down structure (WBS). The expression ‘run-of-the-project’ is used herein to describe in a project management setting the set of uniquely defined necessary and sufficient activities required to carry out a project to its completion in contrast to the expression ‘run-of-the-mill’ to describe in the setting of a mill the set of repetitive operations carried out to produce goods. Such an intrinsic risk factor may be attributable, for example, to project novelty, technology and/or complexity for it is precisely those factors that explain the lack of precise information on the time/cost of ‘run-of-the-project’ activities. It is precisely the lack of precise information on the project activities' durations and/or costs that will inevitably translate into errors of assessment in project activities' durations and costs. One might also add project design errors and contract misspecifications and misinterpretations as causes of project cost estimation errors. All risk factors not considered to be intrinsic in nature will therefore be considered as extrinsic risk factors, among which we shall be distinguishing between project endogenous/contingent and exogenous/contingent risk factors, and finally, between project-specific risk factors and project-systemic or program-specific risk factors.

Project extrinsic risk factors refer to random events that are not tied per se to the ‘run-of-the project’ WBS activities, hence to events that may be identified as occurring fortuitously from within or from without the project inner environment. Hence, extrinsic events are to be labeled contingent events, in fact endogenous or exogenous contingent events depending on whether such risk factors are attributable to project or to program mismanagement, or to events occurring outside the organization without being attributable to project or to program mismanagement. On the one hand, endogenous/contingent risk factors may include potential cost impacts resulting from errors originating in the management of the project as well as from endogenous/contingent risk factors. On the other hand, exogenous/contingent risk factors may include potential cost impacts resulting from errors originating in the management of the program as well as from exogenous/contingent risk factors, including risk factors originating from the external competitive landscape and impacting the program and even the whole organization.

In a program/portfolio setting one needs to make an additional distinction between project-specific risk factors and project-systemic or program-specific risk factors. Project-specific risks obviously refer to risk factors that originate from within the project environment and that are limited to the project itself without being shared by other projects of the program or by the organization. Such project-specific risks will potentially impact only the project's own costs while leaving unaffected the costs of other projects of a program/portfolio. Project-specific risks correspond to project endogenous/contingent risk factors and, therefore, are controllable by the PM from within the project inner environment. The PM should be responsible for identifying and assessing project-specific risk factors and for devising appropriate project active risk response and risk mitigation strategies.

On the other hand, project-systemic risks are those risks that are inherent and prevalent in all projects within a program/portfolio. They may also be referred to as program-specific risks to the extent that they are not prevalent and systemic in other programs or within the whole organization. From a project standpoint, project-systemic risks are equivalent to project exogenous/contingent risks affecting all projects within a program and, therefore, not being controllable by the PM from within its own project but by the PD within the program itself. Such project-systemic risks will impact all of the portfolio projects' costs for they are the product of the project/system, culture, politics, business strategy, process/system complexity, technology, etc. Such project-systemic and program-specific risk factors, prevalent within a program, fall under the authority of the PD as it becomes his responsibility to elaborate program risk management strategies in order to bring program-related systemic risks under his control.

Systemic issues affecting the whole organization should be the concern of upper management. The resolution of an organization's systemic issues should fall under the responsibility of upper management while that of a program-specific issue should obviously fall under the PD's responsibility. Hence, contingent risk factors may be endogenous or exogenous to the program itself. It therefore becomes the PD's responsibility to identify and devise appropriate program risk management and risk mitigation strategies for all program endogenous risk factors.

Table 1 below gives in a nutshell an overview of an exemplary program and project endogenous 208 and exogenous 210 risk factors classification. In summary, the PMs' oversight, control, and responsibility covers all and only endogenous project-specific risks; while the PD's oversight, control, and responsibility should cover all exogenous project-systemic and endogenous program-specific risks as well as all exogenous program-specific risk factors to the extent that the PD sits with upper management.

TABLE 1
Project and Program
Endogenous & Exogenous Risk Factors

| Risk | Project & Program | Project & Program |
|---|---|---|
| Factors | Endogenous Risk Factors | Exogenous Risk Factors |
| Project- | Project Endogenous Risk Factors | Project Exogenous Risk Factors & |
| specific | Issues pertaining to: | Program Endogenous Risk Factors |
| Risks | Project faulty design and misconception | Issues pertaining to: |
| | Project activity planning, scheduling & | Project contract management; |
| | control; | Project-specific commodity price increases; |
| | Project HR planning & control; | Tariffs on imported project-specific |
| | Project time assessment, planning, & | commodities; |
| | control; | Local government regulations impacting |
| | Project cost assessment, planning, & | project; |
| | control; | Labor strike by local workers; |
| | Project quality assessment, planning, & | Trade barriers & tariffs on project-specific |
| | control; | imported goods; |
| | Project communication, leadership & | Natural disaster impacting project. |
| | team management; | Program risk management strategies. Under |
| | Project execution & control; | the re responsibility of the PD. |
| | Project cost contingency reserve | |
| | assessment, planning, & control. | |
| | Project risk management strategies. | |
| | Under the re responsibility of the PM. | |
| Project- | Project Exogenous Risk Factors & | Project Exogenous Risk Factors & |
| systemic | Program Endogenous Risk Factors | Program Exogenous Risk Factors |
| Risks & | Issues pertaining to: | Issues pertaining to: |
| Program- | Contract negotiation & management; | Exchange rate fluctuations; |
| specific | Contract misspecifications & | General price increases of commodities; |
| Risks | misinterpretations; | Bankrupt suppliers; |
| | Program management & coordination; | Industry labor shortages; |
| | PM practices within program; | Price increases in industry materials; |
| | Program communication & leadership; | Labor & minimum wage rate legislation; |
| | HR hiring, planning & control policies; | Political constraints; |
| | Supply management policies; | Government environmental legislation; |
| | Program financial planning & control; | Natural disaster impacting organization. |
| | Program & project cost contingency | Program risk management strategies. Under |
| | reserve assessment, planning, & control. | the responsibility of upper management. |
| | Natural disaster impacting program. | |
| | Program risk management strategies. | |
| | Under the re responsibility of the PD. | |

Hence, the PMs' oversight, control, and responsibility should cover what we shall refer to as project endogenous risk factors. As for the PD, his oversight, control, and responsibility should extend to all project-systemic risks or program-specific risks. These are the project exogenous risk factors falling under the PD's responsibility. Table 1 also serves in illustrating various risk factors falling under the responsibility of either PMs or the PD. However, whatever might be the PD's responsibility, the Project Management Office or PMO must exert a pivotal role in (a) identifying project-specific endogenous risk factors and assessing their cost impact and probability of occurrence as well as in devising strategies to avoid or mitigate them; (b) identifying project exogenous risk factors and program-systemic endogenous risk factors and assessing their cost impact and probability of occurrence. Such a risk identification, assessment and management process must be carried out under the assumption that the PD holds authority over the whole program and its portfolio of projects while the PMO holds the relevant information and technical expertise for carrying out risk and cost budgeting analyses. Tested and approved cost and risk assessment methods should be employed and promoted by the PMO and PMs so as to use proper, tested, uniform and comparable risk assessment methods.

In compliance with the organization's cost budgeting policies the PD and the PMO will eventually make a determination on the project and the management cost baselines and contingency reserves. This cost budgeting exercise will determine the various budgets under the respective responsibility of the PD and of the PMs. When the cost budgeting analysis is carried out with the ECO risk measure, all project and management contingency reserves must be viewed as claimable insurance coverage for specifically pre-identified and agreed-upon project endogenous and project exogenous contingencies.

Time and money are limited but indispensable resources for carrying out the successful execution and delivery of a project's end-products. The accrued cost of a project is a measure of the total sum of money spent for carrying out from project inception to project completion the ‘run-of-the-project’ activities in order to deliver within project scope its end-products on time, on budget, and on quality. However, project success may be jeopardized by risk factors. Risk factors comprise all those probabilistic events potentially impacting project activities' costs and thereby putting at risk and exposing the successful execution and delivery of a project. The cost impacts of risk factors on project activities shall therefore be depicted by the project activities' probability distributions. Our approach to project risk assessment will therefore rest on the premise that any project cost probability distribution will result from the compounding of all and only the relevant risk factors potentially impacting the cost of project activities. Project activities are therefore recognized as defining the elementary level of project risk analysis. Hence, the necessity of: (a) identifying all relevant risk factors potentially impacting the project activities' cost probability distributions, and (b) assessing the probability of occurrence and the severity of impact of all relevant risk factors on the cost axis of project activities' cost probability distributions.

As mentioned above, after having identified and defined the set of the ‘run-of-the-project’ activities 202 A={aᵢ; i=1, 2, 3, . . . , n}, one would thereafter need to assess the cost of each of the project's activities: C(A)={Cᵢ=C(aᵢ); i=1, 2, 3, . . . , n}. The expression ‘run-of-the-project’ is introduced by reference to that of ‘run-of-the-mill’ for which there is a pre-determined set of activities and operations required for carrying out production within a mill or within a project. Any experienced PM knows that the assessment of each WBS ‘run-of-the-project’ activity cost will inevitably be subjected to estimation errors, which by themselves will entail some project risks. We define such estimation errors as intrinsic risk factors for these exist independently of any project management-related event or of any program management-related event. Given that ‘run-of-the-project’ activity costs are inherently uncertain quantities they shall therefore be defined as intrinsic random variables such that the cost of each activity will be subjected to a probability distribution. Many sources of errors in activity cost assessment are known in the art, all representing either intrinsic/endogenous and/or intrinsic/exogenous risk factors to the extent that they are related to ‘run-of-the-project’ activities falling either under the PM's or the PD's oversight, control and responsibility. For instance, intrinsic/endogenous activity cost estimation errors may comprise project faulty design, and misconceptions, while exogenous/intrinsic risk factors may comprise contract misspecifications and misinterpretations.

As an initial ‘run-of-the-project’ cost estimate, it is good practice to assess each activity's cost point estimate by its most likely value, i.e. by its cost mode when sufficient “experiential” information is available. However, when “experiential” information is lacking or unavailable then one will be assessing each activity's cost by an interval from which the point estimate will be assessed by the cost mean. These two situations will lead respectively to the PERT-Beta probability distribution risk compounding process and the Uniform probability distribution risk compounding process, for example. Moreover, any experienced PM will recognize the fact that, aside the intrinsic/endogenous risk factors, there are many other risk factors that will be impacting the project cost activities throughout project execution. Among the many risk factors the PM should be concerned by those endogenous/contingent risk factors occurring within the project inner environment under his oversight and control. Thus, in addition to the inevitable cost estimation errors or intrinsic risk factors, we shall include endogenous/contingent risk factors in order to obtain a complete set of relevant project endogenous risk factors. In our view, all contingent risk factors, whether endogenous or exogenous to the project inner environment, are generated by fortuitous and accidental events, random events that are unrelated to the project's ‘run-of-the-project’ WBS activities per se, but that are related to project or program mismanagement or to a lack of oversight and control over the project or program management processes, including human, socio-economic, and natural phenomena. The project management office (PMO) should also be involved in helping PMs and PDs in assessing the potential cost impacts that each relevant endogenous/contingent (208) or exogenous/contingent (210) risk factor can exert on the project n activity cost estimates.

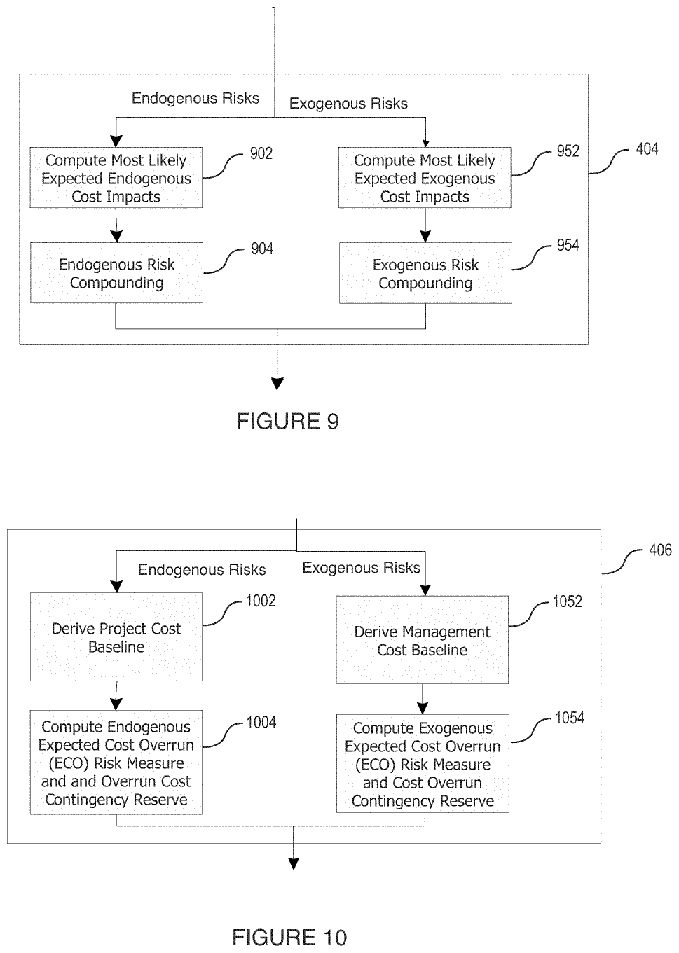

Going back to FIG. 4, once the project-related information 502 is acquired, the project's execution costs risk assessment and risk compounding is computed in step 404. This step is illustrated schematically in FIG. 9. It divides into two branches, which may be executed either in parallel or sequentially, but are at this stage independent from one another. One branch (steps 902 and 904) is directed towards assessing the endogenous risk factors while the other branch (steps 952 and 954) apply similar computations for the exogenous risk factors.

Importantly, step 404 may be done using different probability distributions, as mentioned above for example. However, below, the PERT-Beta risk compounding process will be used as an example only. The use of different probability distributions will be discussed further below.

Thus, in steps 902 and 952, the project's most likely expected cost impacts will be computed. In both cases, this may be done via the project Activity Risk Breakdown and Impact Assessment matrix (ARBIA matrix 106) will be assessed respectively from endogenous and exogenous risk factors. Table 2 below illustrates an exemplary ARBIA matrix 106 for the Endogenous/Contingent Risk Factors 208, but also provides the general structure of any project ARBIA matrix 106, whether pertaining to endogenous or exogenous risk factors. Table 2 puts in relation the percentagewise most likely expected cost impacts 708 of the endogenous/contingent risk factors with the project activity most likely costs 606 and their probability of occurrence 706. Hence, the project ARBIA matrix 106 combines, on the one hand, the joint information about the relevant endogenous/contingent risk factor 208 that might be impacting the cost of project activities alongside their probability of occurrence and, on the other hand, the project activity most probable cost impact. Hence, the project ARBIA matrix 106 is much more than just a risk breakdown structure.

TABLE 2
Project Activity Risk Breakdown and Impact Assessment Matrix of Endogenous/Contingent Risk
Factors and their Percentagewise Most Likely Expected Cost Impact on Project Activities

| Project | a₁ | a₂ | . . . | aᵢ | . . . | aₙ |
|---|---|---|---|---|---|---|
| Activities | | | | | | |
| Most Likely Cost | c(a₁) | c(a₂) | . . . | c(aᵢ) | . . . | c(aₙ) |
| of Project | | | | | | |
| Activities | | | | | | |
| Endogenous/ | Project Endogenous/Contingent Risk Factors and their | | | | | |
| Contingent | Percentagewise Most Likely Expected Cost Impact on | | | | | |
| Risk Factors | Project Activities | | | | | |
| (Probability of | | | | | | |
| Occurrence) | | | | | | |
| F_{NC;1} | f_{N;1, 1}^{E} = | f_{NC;2 1}^{E} = | . . . | x | . . . | f_{NC;n, 1}^{E} = |
| (p_{NC;1}) | (f_{NC;1,1} × p_{NC;1}) | (f_{NC;2, 1} × p_{NC;1}) | | | | (f_{NC;n, 1} × p_{NC;1}) |
| F_{NC;2} | x | f_{NC;2,2}^{E} = | . . . | f_{NC;i, 2}^{E} = | . . . | x |
| (p_{NC;2}) | | (f_{NC;2,2} × p_{NC;2}) | . . . | (f_{NC;i, 2} × p_{NC;2}) | | |
| F_{NC;3} | f_{N;1, 3}^{E} = | f_{NC;2, 3}^{E} = | | f_{NC;i, 3}^{E} = | | f_{NC;n, 3}^{E} = |
| (p_{NC;3}) | (f_{NC;1, 3} × p_{NC;3}) | (f_{NC;2, 3} × p_{NC;3}) | | (f_{NC;i, 3} × p_{NC;3}) | | (f_{NC;n, 3} × p_{NC;3}) |
| . | . | . | . . . | . | . . . | . |
| . | x | x | | x | | x |
| . | . | . | | . | | . |
| F_{NC;r} | f_{NC;1, r}^{E} = | x | . . . | f_{NC;i, r}^{E} = | . . . | f_{NC;n, r}^{E} = |
| (p_{NC;r}) | (f_{NC;1, r} × p_{NC;r}) | | | (f_{NC;i, r} × p_{NC;r}) | | (f_{NC;n, r} × p_{NC;r}) |
| . | . | . | | . | | . |
| . | x | x | | x | | x |
| . | . | . | | . | | . |
| F_{NC;R}_{_{NC}} | x | f_{NC;2, R}_{_{NC}}^{E} = | . . . | x | . . . | f_{NC;n, R}_{_{NC}}^{E} = |
| (p_{NC;R}_{_{NC}}) | | (f_{NC;2, R}_{_{NC}} × p_{NC;R}_{_{NC}}) | | | | (f_{NC;n, R}_{_{NC}} × p_{NC;R}_{_{NC}}) |
| Activities' | f_{NC;1}^{E} = = | f_{NC;2}^{E} = = | . . . | f_{NC;i}^{E} = = | . . . | f_{NC;n}^{E} = = |
| Percentagewise Most Likely Expected Cost Increase by Endogenous/ | ${\sum }_{r = 1}^{{R}_{NC , 1}} {f}_{NC ; 1 , r}^{E}$ | ${\sum }_{r = 1}^{{R}_{NC , 2}} {f}_{NC ; 2 , r}^{E}$ | . . . | ${\sum }_{r = 1}^{{R}_{NC , i}} {f}_{NC ; i , r}^{E}$ | . . . | ${\sum }_{r = 1}^{{R}_{NC , 1}} {f}_{NC ; n , r}^{E}$ |
| Contingent | | | | | | |
| Risk Factors | | | | | | |
| Activities' | E[c_{NC}(a₁)] = | E[c_{NC}(a₂)] = | . . . | E[c_{NC}(aᵢ)] = | . . . | E[c_{NC}(aₙ)] = |
| Expected Cost | c(a₁) × f_{NC;1}^{E} | c(a₂) × f_{NC;2}^{E} | | c(aᵢ) × f_{NC;i}^{E} | | c(aₙ) × f_{NC;n}^{E} |
| Increase by | | | | | | |
| Endogenous/ | | | | | | |
| Contingent | | | | | | |
| Risk Factors | | | | | | |

Referring again to Table 2 above, the project ARBIA matrix 106 will use the information pertaining to the expected cost impact of each project's activities relevant endogenous/contingent risk factor, discussed in relation to FIGS. 7A and 7B. As discussed above, such a task shall be carried out by assessing for every endogenous/contingent risk factor 208, noted {F_{NC; r}; r=1, 2, . . . , R_{NC}}, their corresponding endogenous risk factor parameters comprising their probability of occurrence 706, noted by {p_{NC;r}; r=1, 2, . . . , R_{NC}}, and their percentagewise most likely cost impact 708 on project activity aᵢ, noted c_{NC}(aᵢ), and defined by {ƒ_{NC;i, r}; i=1, 2, . . . , n; r=1, 2, . . . , R_{NC, i}}. To be realistic, the project ARBIA matrix 106 will require information not only about the most likely cost impact of each relevant endogenous/contingent risk factor on each of the project's activities but also an assessment of its expected most likely cost impact.

Hence, in step 902, system 100 shall compound the most likely percentagewise cost impact 708 of every project activity with its probability of occurrence 706 in order to obtain the percentagewise most likely expected cost impact of every project activity. Considering the set of percentagewise most likely endogenous risk factor cost impacts 708 on every activity {ƒ_{NC;i, r}; i=1, 2, . . . , n; r=1, 2, . . . , R_{NC}} and the probability of occurrence of every risk factor 706 {p_{NC;r}; r=1, 2, . . . , R_{NC}}, one can obtain the percentagewise most likely expected cost impact of every relevant endogenous/contingent risk factor on the project activities' cost, simply by computing their inner product i.e. {ƒ_{NC;i, r}^{E}=ƒ_{NC;i, r}×_{PNC;r}; i=1, 2, . . . , n; r=1, 2, . . . , R_{NC}}.

Referring to Table 2, the project ARBIA matrix 106 will require information pertaining to endogenous/contingent risk factors potentially impacting the project cost through its many ‘run-f-the-project’ WBS activities. All endogenous/contingent risk factors should be falling under the oversight and control of the PM and should therefore be controlled through active project risk response strategies and ultimately through a project risk mitigation strategy assessing and implementing the appropriate project cost overrun contingency reserve.

Hence, the project endogenous ARBIA matrix 106 will serve in (a) identifying the relevant endogenous/contingent risk factors that might be impacting the ‘run-of-the-project’ WBS activities, (b) assessing the probability of occurrence of the relevant endogenous/contingent risk factors, (c) assessing the percentagewise cost impact of the relevant endogenous/contingent risk factors on the cost of the project activities, and finally (d) determining the most likely expected cost impact of the relevant endogenous/contingent risk factors on every project activities.

In the row above the last row of Table 2, one finds the sum of the percentagewise most likely expected cost impacts {ƒ_{NC;i}^{E}=Σᵣ₌₁^{R}^{_{NC,i}}ƒ_{NC;i,r}^{E}; i=1, 2, . . . , n} of all R_{NC,i} relevant endogenous/contingent risk factors for every one of the n project activities. For instance, the percentagewise most likely expected cost impacts of endogenous/contingent risk factor 1, risk factor 2, risk factor 3, and risk factor RNC on the cost of activity 2 (noted c(a₂)) would be obtained by adding all these individual endogenous/contingent risk factor cost impacts together to obtain the percentagewise most likely endogenous/contingent expected cost impact on activity 2, hence by adding the following impact rates of activity 2: ƒ_{NC;2}^{E}=ƒ^{NC;2}, 1^{E}+ƒ_{NC;2, 2}^{E}+ƒ_{NC;2, 3}^{E}+ƒ_{NC;2, R}_{_{NC}}^{E}. In a similar fashion, the percentagewise combined most likely expected cost increase of endogenous/contingent risk factor 2, risk factor 3, and risk factor r on the cost of project activity i (noted c(aᵢ)) would be obtained by adding all these individual percentagewise endogenous/contingent risk factor cost impacts together, hence by carrying out the following addition: ƒ_{NC;i}^{E}=ƒ_{NCi, 2}^{E}+ƒ_{NC;i, 3}^{E}+ƒ_{NC;i, r}^{E}.

Moving to the last row of Table 2, one obtains {E[c_{NC}(aᵢ)]=c(aᵢ)×ƒ_{NC;i}^{E}; i=1, 2, . . . , n}, i.e. the expected cost impact of all R_{NC,i} relevant endogenous/contingent risk factors on every project activity i.

By comparing the risk factor impacts on the cost of project activity 2 and project activity i it becomes clear that both activity costs will show a positive correlational effect due to the fact that they are subjected to some potential common endogenous risk factors, namely endogenous risk factor 2 and endogenous risk factor 3 out of respectively three and four endogenous risk factors. In short, correlative effects between various project activity costs will show due to the fact that some project activities will be sharing some common risk factors. On the other hand, one could also account for factor interactions. For instance, one could account for a statistically proven dependency between endogenous risk factors 2 and 3 with a correlation coefficient of 0≤ρ_{NC, 2, 3}≤1. Such a factor interaction between endogenous risk factors on project activity aᵢ, as well as for any other project activity subjected to endogenous risk factors 2 and 3, could be accounted for by explicitly adding a correlational effect between endogenous risk factor 2 and endogenous risk factor 3 so that their percentagewise most likely expected total contingent1/endogenous cost impact on activity i would be given by: ƒ_{NC;i}^{e}=ƒ_{NC,i, 2}^{e}+ƒ_{NC;i, 3}^{e}+ƒ_{NC;i, r}^{e}+(ρ_{NC,2,3}×ƒ_{NC, i, 2}^{e}×ƒ_{NC, i, 3}^{e}), thereby accounting simultaneously for additive-non-interactive and multiplicative-interactive risk factors. However, given that multiplicative-interactive risk factors are relatively infrequent and non-systemic, in this exemplary embodiment, as an example only, we shall keep the mathematical expression simplified by accounting only for the systemic additive-non-interactive risk factors so that percentagewise endogenous/contingent risk factor impacts on activity i shall be defined by: ƒ_{NC;i}^{E}=Σᵣ₌₁^{R}^{_{NC, i}}ƒ_{NC;i,r}^{E}. It follows that the proposed risk factor compounding process can account explicitly not only for statistical dependencies between project activity costs but also for interactions between risk factors. Consequently, risk factor interactions and statistical dependencies between project costs will explicitly be captured by the project activities' cost probability distribution, thereby avoiding any underestimation of the project activity and project cost variances.

Finally, in step 902, one may also calculate the most likely expected cost impact of all relevant endogenous/contingent risk factors on the project simply by adding the project activities' expected endogenous/contingent expected cost impacts, i.e.: E(c_{NC})=Σᵢ₌₁ⁿE[c_{NC}(aᵢ)]. In some embodiments, it would be inappropriate to use the sum of the most likely expected cost impact of all relevant endogenous/contingent risk factors, i.e. E(c_{NC})=Σᵢ₌₁ⁿE[c_{NC}(aᵢ)], to assess the project endogenous/contingent contingency reserve as suggested by the EV method. It would be inappropriate for the simple reason that the resulting contingency reserves would be carried out independently of the project cost probability distribution, thereby losing sight of its significance level, i.e. the probability of the project N-cost baseline of being overrun. An endogenous N-cost contingency reserve must be derived from the project endogenous N-cost probability distribution in order not to lose sight of its significance level. All endogenous risk factors should fall under the oversight and control of the PM and should therefore be controlled through project risk management strategies and, in particular, through project risk mitigation strategies implementing appropriate project cost overrun contingency reserves.

With reference to step 952 and Table 3 below, the project ARBIA matrix 106 may also require information pertaining to exogenous/contingent risk factors potentially impacting the project cost through its many ‘run-of-the-project’ WBS activities. It is obvious that the assessment of cost impacts of exogenous/contingent risk factors on the project's activities would be carried out and interpreted in a similar fashion to that of endogenous/contingent risk factors. All exogenous/contingent risk factors 210 should be falling under the oversight and control of the PD and should therefore be controlled through active program risk response strategies and ultimately through a program risk mitigation strategy assessing and implementing the appropriate management cost overrun contingency reserve.

TABLE 3
Project Activity Risk Breakdown and Impact Assessment Matrix of Exogenous/Contingent Risk
Factors and their Percentagewise Most Likely Expected Cost Impact on Project Activities

| Project | a₁ | a₂ | . . . | aᵢ | . . . | aₙ |
|---|---|---|---|---|---|---|
| Activities | | | | | | |
| Most Likely Cost of | c(a₁) | c(a₂) | . . . | c(aᵢ) | . . . | c(aₙ) |
| Project Activities | | | | | | |
| Endogenous/ | Project Exogenous/Contingent Risk Factors and their | | | | | |
| Contingent | Percentagewise Most Likely Expected Cost Impact on | | | | | |
| Risk Factors | Project Activities | | | | | |
| (Probability of | | | | | | |
| Occurrence) | | | | | | |
| F_{XC;1} | f_{XC;1, 1}^{E} = | f_{XC;2, 1}^{E} = | . . . | x | . . . | f_{XC;n, 1}^{E} = |
| (p_{XC;1}) | (f_{XC;1,1} × p_{XC;1}) | (f_{XC;2, 1} × p_{XC;1}) | | | | (f_{XC;n, 1} × p_{XC;1}) |
| F_{XC;2} | x | f_{XC;2,2}^{E} = | . . . | f_{XC;i, 2}^{E} = | . . . | x |
| (p_{XC;2}) | | (f_{XC;2,2} × p_{XC;2}) | | (f_{XC;i, 2} × p_{XC;2}) | | |
| F_{X;C3} | f_{XC;1, 3}^{E} = | f_{XC;2, 3}^{E} = | . . . | f_{XC;i, 3}^{E} = | . . . | f_{XC;n, 3}^{E} = |
| (p_{XC;3}) | (f_{XC;1, 3} × p_{XC;3}) | (f_{XC;2, 3} × p_{XC;3}) | | (f_{XC;i, 3} × p_{XC;3}) | | (f_{XC;n, 3} × p_{XC;3}) |
| . | . | . | . . . | . | . . . | . |
| . | x | x | | x | | x |
| . | . | . | | . | | . |
| F_{XC;r} | f_{XC;1, r}^{E} = | x | . . . | f_{XC;i, r}^{E} = | . . . | f_{XC;n, r}^{E} = |
| (p_{XC;r}) | (f_{XC;1, r} × p_{XC;r}) | | | (f_{XC;i, r} × p_{XC;r}) | | (f_{XC;n, r} × p_{XC;r}) |
| . | . | . | | . | | . |
| . | x | x | | x | | x |
| . | . | . | | . | | . |
| F_{XC;R}_{_{XC}} | x | f_{XC;2, R}_{_{N}}^{E} = | . . . | x | . . . | f_{XC;n, R}_{_{XC}}^{E} = |
| (p_{XC;R}_{_{XC}}) | | (f_{XC;2, R}_{_{N}} × p_{XC;R}_{_{XC}}) | | | | (f_{XC;n, R}_{_{XC}} × p_{XC;R}_{_{XC}}) |
| Activities' | f_{XC;1}^{E} = = | f_{XC;2}^{E} = = | . . . | f_{XC;i}^{E} = = | . . . | f_{XC;n}^{E} = = |
| Percentagewise Most Likely Expected Cost Increase by Exogenous/ Contingent Rise Factors | ${\sum }_{r = 1}^{{R}_{XC , 1}} {f}_{XC ; 1 , r}^{E}$ | ${\sum }_{r = 1}^{{R}_{XC , 2}} {f}_{XC ; 2 , r}^{E}$ | | ${\sum }_{r = 1}^{{R}_{XC , i}} {f}_{XC ; i}^{E} \text{?}$ | | ${\sum }_{r = 1}^{{R}_{XC , 1}} {f}_{XC ; n , r}^{E}$ |
| Activities' Expected | E[c_{XC}(a₁)] = | E[c_{XC}(a₂)] = | . . . | E[c_{XC}(aᵢ)] = | . . . | E[c_{XC}(aₙ)] = |
| Cost Increase by | c(a₁) × f_{XC;1}^{E} | c(a₂) × f_{XC;2}^{E} | | c(aᵢ) × f_{XC;i}^{E} | | c(aₙ) × f_{XC;n}^{E} |
| Exogenous/ | | | | | | |
| Contingent | | | | | | |
| Rise Factors | | | | | | |

$\text{?} \text{indicates text missing or illegible when filed}$

In the row above the last row of Table 3, one finds the sum of the percentagewise most likely expected cost impacts {ƒ_{XC;i}^{E}=Σᵣ₌₁^{R}^{_{XC,i}}ƒ_{XC;i,r}^{E}; i=1, 2, . . . , n} of all R_{XC,i} relevant exogenous/contingent risk factors 210 for every one of the n project activities 202. For instance, the percentagewise most likely expected cost impacts 718 of exogenous/contingent risk factor 1, risk factor 2, risk factor 3, and risk factor R_{XC} on the cost of activity 2 (noted c(a₂)) would be obtained by adding all these individual endogenous/contingent risk factor cost impacts together to obtain the percentagewise most likely endogenous/contingent expected cost impact on activity 2, hence by adding the following impact rates of activity 2: ƒ_{XC;2}^{E}=ƒ_{XC;2, 1}^{E}+ƒ_{XC;2, 2}^{E}+ƒ_{XC;2, 3}^{E}+ƒ_{XC;2, R}_{_{XC}}^{E}. In a similar fashion, the percentagewise combined most likely expected cost increase of endogenous/contingent risk factor 2, risk factor 3, and risk factor r on the cost of project activity i (noted c(aᵢ)) would be obtained by adding all these individual percentagewise exogenous/contingent risk factor cost impacts together, hence by carrying out the following addition: ƒ_{XC;i}^{E}=ƒ_{XCi, 2}^{E}+ƒ_{XC;i, 3}^{E}+ƒ_{XC;i, r}^{E}.

Moving to the bottom row of Table 3 one can also assess for instance, the expected cost impact produced by exogenous/contingent risk factors 2, 3, and r on project activity i simply by calculating E[c_{XC}(aᵢ)]=c(aᵢ)×ƒ_{XC;i}^{E}=c(aᵢ)×(Σᵣ₌₁^{R}^{_{XC, i}}ƒ_{XC;i,r}^{E}), an expected project cost increase. Also, in some embodiments, one could calculate the most likely expected cost impact of all relevant exogenous/contingent risk factors on the project simply by adding the project activities' expected exogenous/contingent expected cost impacts, i.e.: E(c_{XC})=Σᵢ₌₁ⁿE[c_{XC}(aᵢ)]. However, such calculations may be inappropriate for assessing the project exogenous/contingent contingency reserve, as suggested by the EV method, for this would be carried out independently of the project X-cost probability distribution, thereby losing sight of its significance level, i.e. the probability of the project X-cost baseline of being overrun. An exogenous management cost overrun contingency reserve must be derived from the project exogenous X-cost probability distribution in order to capture the cost impact of all relevant exogenous/contingent risk factors on the project X-cost probability distribution without losing sight of its significance level. All exogenous risk factors 210 should fall under the oversight and control of the PD and should therefore be controlled through program risk management strategy and ultimately through a program risk mitigation strategy implementing an appropriate management cost overrun contingency reserve.

It must however be understood that endogenous and exogenous project ARBIA matrices 106 must not be used in a once-and-for-all static fashion, but rather within a dynamic re-assessment process whereby active risk response strategies will be developed in a recursive fashion in order to progressively reduce the project's endogenous and exogenous expected cost impacts to an acceptable level. For example, given the interdependency, the complexity and the coordination required between the project ARBIA matrix 106 two-level risk assessment process, such a recursive re-assessment process should be carried out with the participation of risk management and risk assessment experts from the PMO. Eventually, the project risk re-assessment process should produce ‘final’ endogenous and exogenous project ARBIA matrices from which project endogenous and exogenous cost probability distributions will be assessed and project and management cost overrun contingency reserves determined.

### Project Endogenous and Exogenous Cost Probability Distributions

Unlike the ad hoc theory-free and numerically-driven Monte Carlo Simulation method, the PERT-Beta probability distribution risk compounding process used herein as an example only is an analytical method devised for assessing the cost impacts of all relevant endogenous and exogenous risk factors on their respective project activities' cost probability distributions. The impact of any relevant risk factor on a project activity cost probability distribution will be assessed by its percentagewise most probable expected cost impact.

Thus, going back to FIG. 9, in steps 904 and 954, the assessment process will therefore rely on the compounding of all the relevant project activities' percentagewise expected most likely endogenous (in step 904) and exogenous (in step 954) cost impacts with the project activities' basic three-point most likely execution cost estimate 606, pessimistic execution cost estimate 608 and optimistic execution cost estimate 610. The risk factor compounding process of steps 904 and 954, described herein in accordance with one embodiment, generalizes and improves upon the Method of Moments (Yeo, 1990), a method that assesses from the minimum, most likely and maximum value of each cost item the project cost expected value and variance under a triangular or a PERT-Beta probability distribution. Project and management contingency reserves under a Normal project costs probability distribution are then calculated from their respective endogenous risk acceptance policy 510 and the exogenous risk acceptance policy 512, herein also referred to as z(α) and z(α′) respectively.

However, unlike the Method of Moments and the EV method, the risk compounding process of steps 904 and 954, herein discussed in the context of the PERT-Beta probability distribution as an example only, will not lose sight of the project's significance level for project cost overrun contingency reserves shall respectively be derived from the project's endogenous and exogenous cost probability distributions at their respective z(α) (510) and z(α) (512) risk acceptance policies. The risk compounding process of steps 904 and 954 rests on the principle that the percentagewise expected cost impact of project relevant endogenous and exogenous risk factors impact the value of every potential cost lying on the project's cost probability distribution axis. However, the risk compounding process may be simplified by compounding the percentagewise expected cost impact with the probability distribution probability distribution estimate of every project endogenous and exogenous risk factor. Once, in the current example, these activity PERT-Beta three-point probability distribution estimates are assessed, one will have determined the cost impacts of endogenous and exogenous risk factors on the expected value and variance of every project activity cost and, ultimately, of the project. One shall then be in a position to consecutively assess the project endogenous N-cost and the project exogenous X-cost probability distribution as well as the project endogenous cost overrun contingency reserve CR_{N}^{z(α)}, i.e. the project contingency reserve, at the (1−α) significance level, and the project exogenous cost overrun contingency reserve CR_{X}^{z(α′)}, i.e. the management contingency reserve at the (1−α) significance level.

### A Probability Distribution Risk Compounding Process

In the absence of perfect information on activity costs one may postulate that project activity costs will inevitably be subjected to assessment errors. Such activity cost estimation errors shall be assimilated to an intrinsic risk factor, not to be confused with extrinsic or contingent risk factors. On the one hand, intrinsic risk factors may be explained essentially by the lack of information and experience concerning the ‘run-of-the-mill’ project activities' costs; the more so the greater will be the novelty, the technology, and/or the complexity of a project. Hence, while novel projects may generate cost estimation errors that may be attributed to the ignorance of the exact cost of project activities for which no previous experience exists, a technologically complex project may generate cost estimation errors due to project misconceptions and design errors and/or contract misspecifications and misinterpretations. On the other hand, extrinsic or contingent risk factors may be explained by fortuitous events traceable to program or to project mismanagement issues such as those engendered by shoddy project planning and forecasting, incompetent project execution, or lack of project control.

Intrinsic cost estimation errors will enable us to define the starting point for assessing the cost impacts of endogenous/contingent and exogenous/contingent risk factors on project activities. However, one way to make sure that such diverse and heteroclite cost impact measurements on project activities remain comparable is to assess them on a percentage basis with respect to a common reference point. Thus, in the presently discussed embodiment, the reference point shall be the project's PERT-Beta probability distribution activity three-point basic intrinsic cost estimates (examples using other types of probability distributions will be discussed below). Hence, before assessing the cost impact of endogenous/contingent risk factors or exogenous/contingent risk factors on a project activities' cost probability distribution one will need to determine intrinsic cost estimation errors from their basic cost point estimates. This will imply determining for all project activities an inter-percentile interval above and under their most likely cost estimates so as to indicate the range of the estimation errors. Such a cost range will therefore be bounded by a cost under-run minimum value and a cost overrun maximum value complying with a common maximum probability of occurrence. In some embodiments, such cost under-run minimum values and a cost overrun maximum values may be set at 5% or 1%, for example.

The activity cost assessment process that has been expounded actually extends by replication the well-known PERT-Beta probability distribution error assessment process used in Monte Carlo simulation methods. In this case, such an estimate will be defined by the three-point PERT-Beta probability distribution three-point basic intrinsic cost estimate of every one of the n project activities:

{C_{0;i min};C_{0;i mod};C_{0;i max}}; i=1,2, . . . ,n (1)

while C_{0;i mod} is assessed as the most likely cost estimate of any activity 606, C_{0;i min}, the minimum cost of any activity 608, will be determined so as to ensure that the probability for the cost of activity i to under-run its minimum value will be no greater than 5% (or 1%), while C_{0;i max}, the maximum cost of any activity 610, will be determined so as to ensure that the probability of the cost of activity i to overrun its maximum value will be no greater than 5% (or 1%).

In this exemplary embodiment, given that the PERT-Beta probability distribution assessment process is considered an appropriate method for capturing the cost impact of intrinsic estimation error on every activity's cost point estimate, we consider that the PERT-Beta probability distribution assessment process may be replicated and used as an appropriate method for capturing the cost impact of endogenous/contingent (step 904) and exogenous/contingent (step 954) risk factors on every project activity's intrinsic three-point cost estimate. In fact, the basic three-point cost assessment process applicable to all n project activities may be sequentially replicated to capture the cost impact of endogenous/contingent and exogenous/contingent risk factors by compounding their respective percentagewise expected cost impacts with the basic intrinsic cost three-point PERT-Beta cost estimates.

### The Project Endogenous Cost Probability Distribution

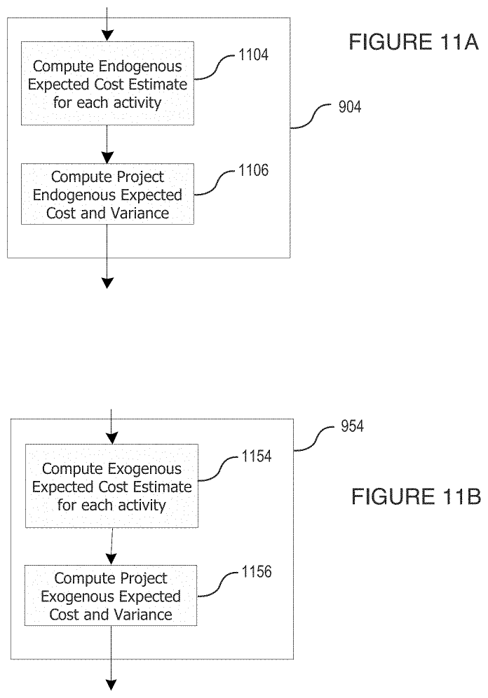

Step 902 is further illustrated schematically in FIG. 11A. In order to extend the probability distribution risk compounding process to account for endogenous/contingent risk factors one can initiate the process by compounding their value with the n project activities' most likely intrinsic costs C_{0, i mod}. The information pertaining to the cost impact of endogenous/contingent risk factors on all project activities is obtained from the project endogenous ARBIA matrix of Table 1. Hence, one will assess the most likely endogenous cost C_{N, i mod} of all n project activities by compounding their basic intrinsic most likely cost estimate C_{0, i mod} with all the relevant endogenous/contingent risk factor expected cost impacts: {ƒ_{N;i}^{E}=Σᵣ₌₁^{R}^{_{N;i}}ƒ_{N;i,r}^{E}; i=1, 2, . . . , n}.

When all the relevant most likely expected cost impacts of endogenous/contingent risk factors will have been factored in, then the most likely endogenous expected cost of activity i will then be given by:

C_{N, i mod}=C_{0,i mod}(1+ƒ_{NC,i}^{E})=C_{0,i mod}(1+Σᵣ₌₁^{R}^{_{N;i}}ƒ_{I; i,r}^{E}); i=1,2,3, . . . ,n (2).

If all endogenous/contingent risk factors {R_{NC,i}; i=1, 2 . . . n} had systematic interactive effects between each one of them, then, just as in the case of compounded interest, compounding the risk factors' cost impacts between each risk factor would have yielded the following estimate for every activity mode cost: C_{N, i mod}=C_{0,i mod}(1+ƒ_{NC,i}^{E})=C_{0,i mod}Πᵣ₌₁^{R}^{_{NC}}(1+ƒ_{NC;i,r}^{E}); i=1, 2, 3, . . . , n.

Moreover, the optimistic and pessimistic intrinsic cost estimates of every activity (e.g. cost estimates 610 and 606, respectively) should, as any potential cost on any activity's cost probability distribution axis, be subjected to the same percentagewise endogenous/contingent risk factor expected cost impacts as did the most likely expected intrinsic cost estimate. After all, endogenous risk factors should impact an activity's cost in an equally proportional fashion whatever might be the value taken by the cost of an activity. This also follows from the principle that endogenous risk factors should not only increase the value of every activity's endogenous expected cost but also their variance and, ultimately, the project's endogenous expected cost and standard deviation.

Hence, in compliance with the PERT-Beta probability distribution risk compounding process as an example only, in step 1104, one obtains the following project activity endogenous three-point expected cost estimate: This result indicates that these endogenous cost estimates are independent of the order in which the cost impacts of endogenous/contingent risk factors have been compounded. Hence, in this example, the PERT-Beta probability distribution risk compounding process is a generalization of the basic PERT-Beta error assessment process whereby intrinsic cost estimation errors are compounded in an additive fashion with endogenous/contingent risk factor cost impacts, thus resulting in the corresponding compounded values (e.g. a compounded minimum cost, a compounded most likely cost and a compounded maximum cost):

$$\{ \begin{matrix}{C}_{N , i , min} = {C}_{0 , i , min} ( 1 + {f}_{NC , i}^{E} ) = {C}_{0 , i , min} ( 1 + {\sum }_{r = 1}^{{R}_{NC}} {f}_{NC , i , r}^{E} ) \\ {C}_{N , i , mod} = {C}_{0 , i , mod} ( 1 + {f}_{NC , i}^{E} ) = {C}_{0 , i , mod} ( 1 + {\sum }_{r = 1}^{{R}_{NC}} {f}_{NC , i , r}^{E} ) \\ {C}_{N , i , max} = {C}_{0 , i , max} ( 1 + {f}_{NC , i}^{E} ) = {C}_{0 , i , max} ( 1 + {\sum }_{r = 1}^{{R}_{NC}} {f}_{NC , i , r}^{E} )\end{matrix} ; i = 1 , 2 , … , n \qquad ( 3 )$$

Under the PERT-Beta probability distribution used in this example, the project n activities' endogenous expected cost estimates shall be given by:

E(C_{N; i})=(C_{N; i, min}+4C_{N; i mod}+C_{N; i max})/6; i=1,2, . . . ,n. (4)

while their variances and standard deviations shall respectively be given by:

V(C_{N; i})=(C_{N;i max}−C_{N; i min})²/36; i=1,2, . . . ,n (5)

σ(C_{N,i})=(C_{N; i max}−C_{N; i min})/6; i=1,2, . . . ,n (6)

Then, in step 1106, from the project activities' expected cost estimates one assesses the project ‘s expected endogenous N-cost:

E(C_{N})=Σᵢ₌₁ⁿE(C_{N; i})=μ_{C}_{_{N}} (7)

and from the project activities' variance and standard deviation cost estimates one assesses the project's endogenous N-cost variance and standard deviation:

V(C_{N})=Σᵢ₌₁ⁿV(C_{N,i})=σ_{C}_{_{N}}² (8)

σ(C_{N})=\sqrt{Σᵢ₌₁ⁿV(C_{N; i})}=σ_{C}_{_{N}} (9)

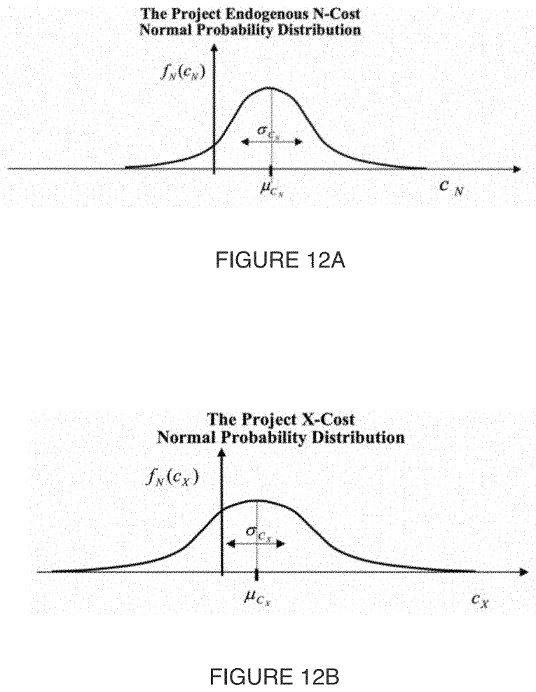

Above, equations (8) and (9) were carried out as though the project activities' endogenous costs were assumed to be uncorrelated with one another. However, given that the risk factor compounding process used in assessing Equation (3) implicitly accounted for statistical dependencies between project activity costs while also being explicitly capable of accounting for interactions between endogenous risk factors, it therefore follows that Equations (8) and (9) will implicitly have accounted for factor interactions and statistical dependencies between the project activities' endogenous costs. Having already assumed that the number of project activities is sufficiently high (n≥15), one may invoke the Central-Limit Theorem and assume that the project endogenous N-cost probability distribution is Normal, i.e. as shown in FIG. 12A.

### The Project Exogenous Cost Probability Distribution

Similarly, in step 952 which uses the probability distribution risk compounding process to account for exogenous/contingent risk factors, one can compound their expected value with the project activities' most likely intrinsic costs C_{0, i mod}. The information pertaining to the expected cost impact of exogenous/contingent risk factors on project activities is contained in the project exogenous ARBIA matrix of Table 2. Hence, the most likely exogenous cost C_{X, i mod} of activity i may be assessed by compounding the intrinsic most likely cost estimate C_{0, i mod} with all the relevant exogenous/contingent risk factor expected cost impacts given by: {ƒ_{X;i}^{E}=Σᵣ₌₁^{R}^{_{X;i}}ƒ_{X;i,r}^{E}; i=1, 2, . . . , n}. If all exogenous/contingent risk factors {R_{XC,i}; i=1, 2, . . . , n} had systematic interactive effects between each one of them, then, just as in the case of compounded interest, compounding the risk factors' cost impacts between each risk factor would have yielded the following estimate for every activity mode cost:

C_{X,i mod}=C_{0,i mod}(1=ƒ_{XC,i}^{E})=C_{0,i mod}Πᵣ₌₁^{R}^{_{XC}}(1+ƒ_{XC;i,r}^{E}); i=1,2,3 . . . ,n.

When all the relevant most likely expected cost impacts of exogenous/contingent risk factors will have been factored in, then the most likely exogenous expected cost of activity i will be given by:

C_{X,i mod}=C_{0,i mod}ƒ_{XC,i}^{E}=C_{0,i mod}(Σᵣ₌₁^{R}^{_{X;i}}ƒ_{XC;i,r}^{E} (10).

Again, the optimistic and pessimistic intrinsic cost estimates of every activity will, as did the most likely expected intrinsic cost estimate of every activity as should any potential cost on any activity cost probability distribution axis, be subjected to the same percentagewise exogenous/contingent risk factor expected cost impacts. After all, exogenous risk factors should impact an activity's cost in an equally proportional fashion whatever their value. This follows from the principle that exogenous risk factors should not only increase the value of every activity's exogenous expected cost but also their variance, and ultimately the project's exogenous expected cost and standard deviation.

Step 952 is further illustrated schematically in FIG. 11B. Hence, in step 1154 and in compliance with the PERT-Beta probability distribution risk compounding process, one may write the following project activity exogenous three-point cost estimate (e.g. compounded values):

$$\{ \begin{matrix}{C}_{X i min} = {C}_{0 , i min} ( 1 + {f}_{XC , i}^{E} ) = {C}_{0 , i min} ( {\sum }_{r = 1}^{{R}_{NC}} {f}_{XC , i , r}^{E} ) \\ {C}_{X , i mod} = {C}_{0 , i mod} ( 1 + {f}_{XC , i}^{E} ) = {C}_{0 , i mod} ( {\sum }_{r = 1}^{{R}_{NC}} {f}_{XC , i , r}^{E} ) \\ {C}_{X , i max} = {C}_{0 , i max} ( 1 + {f}_{XC , i}^{E} ) = {C}_{0 , i max} ( 1 + {\sum }_{r = 1}^{{R}_{NC}} {f}_{XC , i , r}^{E} )\end{matrix} ; i = 1 , 2 , 3 , … , n . \qquad ( 11 )$$

This result indicates that exogenous cost estimates are also obtained independently from the order in which the cost impacts of exogenous/contingent risk factors have been compounded. Moreover, the exogenous cost estimate of activity i, i.e. C_{X; i mod}, expresses only the expected cost increases engendered by exogenous risk factors relevant to every project activity. This explains why the basic intrinsic cost C_{0, i mod} of activity i has not been added to the exogenous cost estimate. Hence, in compliance with the exogenous/contingent risk factor risk compounding process, one may write the project activity PERT-Beta exogenous three-point cost estimate:

E(C_{X;i})=(C_{X; i, min}+4C_{X; i mod}+C_{X; i max})/6; i=1,2,3, . . . ,n (12)

while their variances and standard deviations shall respectively be given by:

V(C_{X;i})=(C_{X;i max}−C_{X; i min})²/36; i=1,2,3, . . . ,n (13)

σ(C_{X; i}=(C_{X; i max}−C_{X; i min})/6; i=1,2,3, . . . ,n (14).

In step 1156, the project exogenous expected cost is therefore given by:

E(C_{X})=Σᵢ₌₁ⁿE(C_{X; i})=μ_{C}_{_{X}} (15)

while its exogenous cost variance and standard deviation are respectively given by:

V(C_{X})=Σᵢ₌₁ⁿV(C_{X; i})=σ_{C}_{_{X}}² (16)

σ(C_{X})=\sqrt{Σᵢ₌₁ⁿV(C_{X; i})}=σ_{C}_{_{X}} (17).

Again, Equations (16) and (17) were carried out as though the project activities' exogenous costs were assumed to be uncorrelated with one another. Again, given that the risk factor compounding process used in assessing Equation (12) implicitly accounted for statistical dependencies between project activity costs as well as for potential interaction effects between exogenous risk factors, it follows that Equation (17) will implicitly have accounted for factor interactions and statistical dependencies between the project activities' exogenous costs.

Having already assumed that the number of project activities or work packages is sufficiently high (n≥15), one may still invoke the Central-Limit Theorem and assume that the project exogenous X-cost probability distribution is Normal. The project exogenous X-cost probability distribution will be given by C_{X}˜N(μ_{C}_{_{X}}; σ_{C}_{_{X}}) as depicted in FIG. 12B.

### Project, Management, and Program Cost Baselines Cost Overruns Contingency Reserves and Budgets in a Single-Project Setting

Going back to FIG. 4, once step 404 has been executed, in step 406 the Project and Management cost baselines and overrun contingency reserves are computed. Step 406 is further detailed schematically in FIG. 10, where two branches are shown: steps 1002 and 1004 for the endogenous risk factors and steps 1052 and 1054 for the exogenous risk factors. These two branches may be executed in parallel or serially, as required.

In step 1002 and 1052, a Project or Management cost baseline will be derived, respectively. Similarly steps 1004 and 1054 will compute the novel ECO risk measure 110 to derive therefrom a corresponding project or management Overrun Cost Contingency Reserve, respectively.

As previously mentioned, if one aims at deriving the cost overrun contingency reserve from a project cost probability distribution in order to cope with a specific family of risk factors, then the project cost probability distribution should capture the cost impact of all and only the relevant risk factors belonging to such a family of risk factors. Hence, on the one hand, the project contingency reserve should consequently be covering cost overruns generated by endogenous risk factors i.e. those risk factors originating from within the project inner environment and falling under the oversight and control of the PM. Such a project cost overrun contingency reserve should be derived from the project endogenous N-cost probability distribution. On the other hand, the management contingency reserve should, in a similar fashion, be covering cost overruns resulting from exogenous risk factors, i.e. risk factors originating from outside the project inner environment but inside the program environment, and therefore falling under the oversight and control of the PD. Such a management contingency reserve should be derived from the project exogenous X-cost probability distribution.

In addition to having at one's disposal the proper project endogenous N-cost probability distribution and the proper project exogenous X-cost probability distribution, one must also assess the project contingency reserve and the management contingency reserve, respectively, from a proper risk measure. In this case, one needs a coherent risk measure capable of assessing the project cost tail expectation, i.e. the expected cost overrun. The formal definition of the project expected cost overrun or ECO risk measure 110, as implemented via ECO/ETO Risk Measure Engine 108, and in accordance with one embodiment, is the following:

ECO^{z(α)}=E{C|C≥C_{B}^{z(α)}} (18)

and measures the project cost tail expectation above the project cost baseline at the (1−α) significance level. To obtain an analytical closed-form solution one must introduce a conditional loss function with its threshold value set at the cost baseline C_{B}^{z(α)} (1−α) significance level. One then defines the project cost overrun loss function L(c) by, in some embodiments, the following equation:

$$\{ \begin{matrix}L ( c ) = c - {C}_{B}^{z ( α )} & if & c > {C}_{B}^{z ( α )} \\ L ( c ) = 0 & if & c \leq {C}_{B}^{z ( α )}\end{matrix} . \qquad ( 19 )$$

One may therefore assess the project Expected Cost Overrun (ECO^{z(α)}) 110 for any probability density function ƒ(c) by solving the following definite integral:

ECO^{z(α)}=∫_{C}_{_{B}}_{^{z(α)}}^{+∞}L(c)ƒ(c)dc (20)

which may be written as:

ECO^{z(α)}=∫_{C}_{_{B}}_{^{z(α)}}^{+∞}(c−C_{B}^{z(α)})ƒ(c)dc (21).

A project expected cost overrun will always be yielding a non-negative solution. In the exemplary case where a PERT-Beta risk compounding process was used, as discussed above, then one can assume that in compliance with the Central Limit Theorem, that the cost probability distribution is governed by a Normal probability distribution with an expected value of E(C)=μ_{C} and a standard deviation of σ(C)=∝_{C}, such that one may write: C˜N(μ_{C}; σ_{C}).

Even when capital project costs are discounted over many years the CLT still applies under regular economic conditions.

Recalling that the project cost Normal probability density function is defined by:

$${f}_{N} ( c ) = \frac{1}{{σ}_{C} \sqrt{2 π}} exp [ - \frac{1}{2} {( \frac{c - {μ}_{C}}{{σ}_{C}} )}^{2} ] \qquad ( 22 )$$

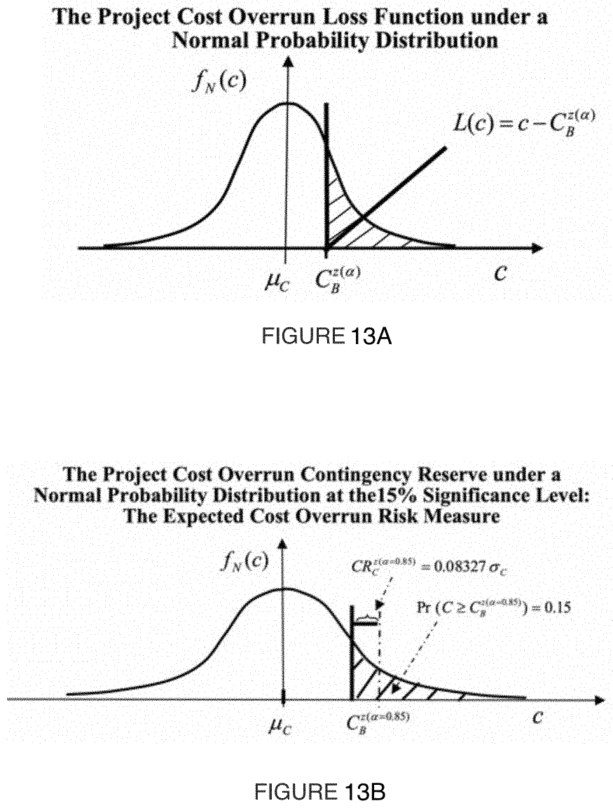

by superimposing the conditional loss function L(c) over the Normal cost pdf ƒ_{N}(c), one obtains FIG. 13A.

Solving the definite integral of Equation (21) under a Normal cost probability distribution, for this example using the PERT-Beta risk compounding process, one obtains the following unique and exact closed-form solution:

$${ECO}^{z ( α )} = {σ}_{C} \{ \frac{1}{\sqrt{2 π}} exp [ - \frac{{z}^{2} ( α )}{2} ] - z ( α ) {F}_{N} ( - z ( α ) ) \} \qquad ( 23 )$$

with F_{N}(⋅) standing for the cumulative of a standardized Normal N(0,1) probability distribution such that F_{N}(−z(α)=1−F_{N}(z(α)=Pr(C≥C_{B}^{z(α)})=1−α with the cost baseline set at C_{B}^{z(α)}=μ_{C}+z(α)σ_{C} in steps 1002 or 1052.

As an example, only, FIG. 13B illustrates the addition of the project cost overrun contingency reserve CR_{C}^{z(α=0.85)} to the project cost baseline C_{B}^{z(α=0.85)} at the 15% significance level in order to determine the project cost budget.

Having at one's disposal the project endogenous N-cost Normal probability distribution, i.e. C_{N}˜N(μ_{C}_{_{N}}; σ_{C}_{_{N}}), one will be in a position to assess above the project N-cost baseline C_{B;N}^{z(α)} at the (1−α) significance level the project cost overrun contingency reserve CR_{C}_{_{N}}^{z(α)}.

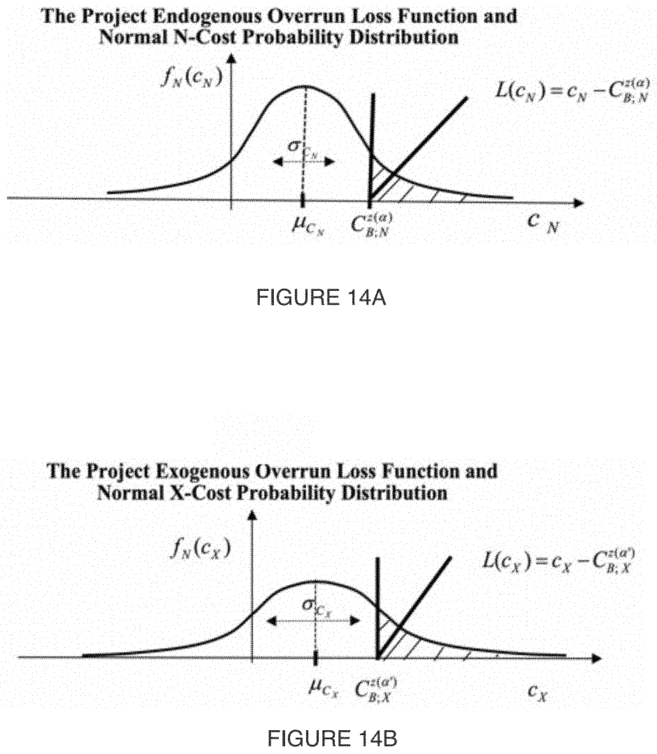

FIG. 14A replicates FIG. 13 by introducing the endogenous project cost overrun loss function L(c_{N}) at the z(α)N-cost baseline C_{B; N}^{z(α)}. Thus, in step 1004, the unique and exact closed-form solution of the project expected N-cost overrun will be given by Equation (24) when assessed at the project N-cost baseline C_{B;N}^{z(α)} (1−α) (computed in step 1002) significance level under a Normal probability distribution:

$${ECO}_{N}^{z ( α )} = {σ}_{{C}_{N}} \{ \frac{1}{\sqrt{2 π}} exp [ - \frac{{z}^{2} ( α )}{2} ] - z ( α ) {F}_{N} ( - z ( α ) ) \} . \qquad ( 24 )$$

In order to ensure that the project cost overrun contingency reserve CR_{C}_{_{N}}^{z(α)} will be covering on average cost overruns we shall be setting the project contingency reserve equal to the project N-cost overrun expected value, i.e. CR_{C}_{_{N}}^{z(α)}=ECO_{N}^{(α)}.

In a similar fashion, having at one's disposal the project exogenous X-cost probability distribution, i.e. C_{X}—N(μ_{C}_{_{X}}; σ_{C}_{_{X}}), in steps 1052 and 1054, one will be in a position to assess at the project X-cost baseline C_{B;X}^{z(α′)} (computed in step 1052) (1−α′) significance level the management contingency reserve CR_{C}_{_{X}}^{z(α′)}. Depending on strategic imperatives, the management contingency reserve could be set at a different significance level than that of the project contingency reserve.

FIG. 14B replicates FIG. 13 by introducing the exogenous project cost overrun loss function at its cost baseline C_{B; X}^{z(α′)} (1−α′) significance level. Thus, in step 1054, the unique and exact closed-form solution of the project expected X-cost overrun will be given by Equation (25) when assessed at the project X-cost baseline C_{B;X}^{z(α′)} (1−α′) significance level under a Normal probability distribution:

$${ECO}_{X}^{z ( {α}^{′} )} = {σ}_{{C}_{X}} \{ \frac{1}{\sqrt{2 π}} exp [ - \frac{{z}^{2} ( α )}{2} ] - z ( {α}^{′} ) {F}_{N} ( - z ( {α}^{′} ) ) \} . \qquad ( 25 )$$

In order to ensure that the management cost overrun contingency reserve CR_{C}_{_{X}}^{z(α′)} will on average be covering cost overruns we shall be setting the management contingency reserve equal to the project X-cost overrun expected value, i.e. CR_{C}_{_{X}}^{z(α′)}=ECO_{X}^{z(α′)}.

When using the ECO risk measure 110, one must always interpret project and the management cost overrun contingency reserves as insurance contracts meant to cover cost impacts resulting from the actual realization of specifically pre-identified and agreed-upon endogenous and/or exogenous contingencies. In the case of the project contingency reserve, it is the PM that will be forwarding his insurance claims to the PD for approval. In the case of the management contingency reserve, it is the PD that should be forwarding his insurance claims to a higher echelon officer for approval, such as the CFO. One clearly understands the importance of establishing, not only from a conceptual point of view but also from a management standpoint, a clear distinction between project and management contingency reserves. In fact, both perspectives tie together for both perspectives rest on the principle of causality and responsibility. On the one hand, given that endogenous risk factors originate from within the project inner environment under the oversight and control of the PM, it therefore falls under the PM's responsibility for initiating and implementing active project risk response strategies in order to cope with endogenous risk factors. On the other hand, given that exogenous risk factors originate from outside the project inner environment and within the program environment under the oversight and control of the PD, it therefore falls under the PD's responsibility for initiating and implementing active program risk response strategies in order to cope with exogenous risk factors.

Going back to FIG. 4, in step 408, the program cost budget 808, including the program cost baseline 804 and overrun contingency reserve 806 is computed. Having established a clear distinction between the project contingency reserves and management contingency reserves, it follows that holding to strategic imperatives within an organization that the project N-cost budget B_{C}_{_{N}}^{z(α)} and the management X-cost budget B_{C}_{_{X}}^{z(α′)} could be defined at different significance levels. Given that the program addresses both project and management costs and risks, we shall define, for accounting purposes, the program NX-cost budget 808 as the sum of the project N-cost budget and the management X-cost budget, i.e. B_{C}_{_{NX}}≡B_{C}_{_{N}}^{z(α)}+B_{C}_{_{X}}^{z(α′)}, so that the program cost baseline and contingency reserve shall also be set equal to those of the project N-cost and the management X-cost, i.e. C_{B; NX}≡C_{B;N}^{z(α)}+C_{B;X}^{z(α)}, and CR_{C}_{_{NX}}≡CR_{C}_{_{N}}^{z(α)}+CR_{C}_{_{X}}^{z(α′)}). Hence, the program cost budget will be equal to the program cost baseline 804 and the program cost contingency reserve 806, i.e. B_{C}_{_{NX}}≡C_{B; NX}+CR_{C}_{_{NX}}. It follows that the program budget 808, cost baseline 804, and cost contingency reserve 806 are not defined at any significance level due to the fact that they are not derived per se from a NX-cost probability distribution, but at the (1−α) and (1−α′) significance levels of the project N-cost and the project X-cost probability distributions.

Table 4 below summarizes within a single project setting the relationship between the project, the management and the program cost baselines, contingency reserves and budgets. The program budget does not include the management reserve given that it is not derived from a cost probability distribution. The PM will be managing at his sole discretion the project budget up till the N-cost baseline C_{B;N}^{z(α)}. However, any insurance claim by the PM for covering specifically pre-identified and agreed-upon endogenous contingencies out of the project N-cost contingency reserve CR_{C}_{_{N}}^{(α)} should be approved by the PD. In a similar fashion the PD will be managing at his sole discretion the management budget up till the X-cost baseline C_{B;X}^{z(α′)}. However, any insurance claim by the PD for covering specifically pre-identified and agreed-upon exogenous contingencies out of the program X-cost contingency reserve CR_{C}_{_{X}}^{z(α′)} should, in theory, be approved by the CFO. In practice, one can imagine the PD having full authority and total liberty over the management budget although still being accountable to the CFO.

TABLE 4
Project, Management & Program
Cost Baselines, Cost Overrun Contingency Reserves & Budgets from
Endogenous & Exogenous Normal Cost Probability Distributions of a
Single-Project Program with the Expected Cost Overrun Risk Measure

| | Cost | Cost Overrun | Cost |
|---|---|---|---|
| | Baseline | Contingency Reserve | Budget |
| Project | Project Cost | Project Cost Overrun | Project Cost |
| N-Cost PDF | Baseline | Contingency Reserve | Budget |
| C_{N}~N(μ_{C}_{_{N}}; σ_{C}_{_{N}}) | C_{B;N}^{z(α)} = μ_{C}_{_{N}} + z(α)σ_{C}_{_{N}} | CR_{C}_{_{N}}^{z(α)} = ECO_{N}^{z(α)} = | B_{C}_{_{N}}^{z(α)} = |
| | | σ_{C}_{_{N}}ψ(z(α)) | C_{B,;N}^{z(α)} + CR_{C}_{_{N}}^{z(α)} |
| Management | Management Cost | Mngt Cost Overrun | Management Cost |
| X-Cost PDF | Baseline | Contingency Reserve | Budget |
| C_{X}~N(μ_{C}_{_{X}}; σ_{C}_{_{X}}) | C_{B;X}^{z(α′)} = μ_{C}_{_{X}} + z(α′)σ_{C}_{_{X}} | CRC_{X}^{z(α′)} = ECO_{X}^{z(α′)} = | BC_{X}^{z(α′)} = |
| | | σ_{C}_{_{X}}ψ(z(α′)) | C_{B; X}^{z(α′)} + CR_{C}_{_{X}}^{z(α′)} |
| Program | Program Cost | Program Cost Overrun | Program Cost |
| Project Costs | Baseline | Contingency Reserve | Budget |
| & | C_{B; NX} = C_{B;N}^{z(α)} + C_{B;X}^{z(α′)} | CR_{C}_{_{NX}} = CR_{C}_{_{N}}^{z(α)} + CR_{C}_{_{X}}^{z(α′)} | B_{C}_{_{NX}} = B_{C}_{_{N}}^{z(α)} + B_{C}_{_{X}}^{z(α′)} |
| Management Costs | | | B_{C}_{_{NX}} = C_{B;NX} + CR_{C}_{_{NX}} |

$ψ ( z ( α ) ) = \{ \frac{1}{\sqrt{2 π}} exp [ - \frac{{z}^{2} ( α )}{2} ] - z ( α ) {F}_{N} ( - z ( α ) ) \}$

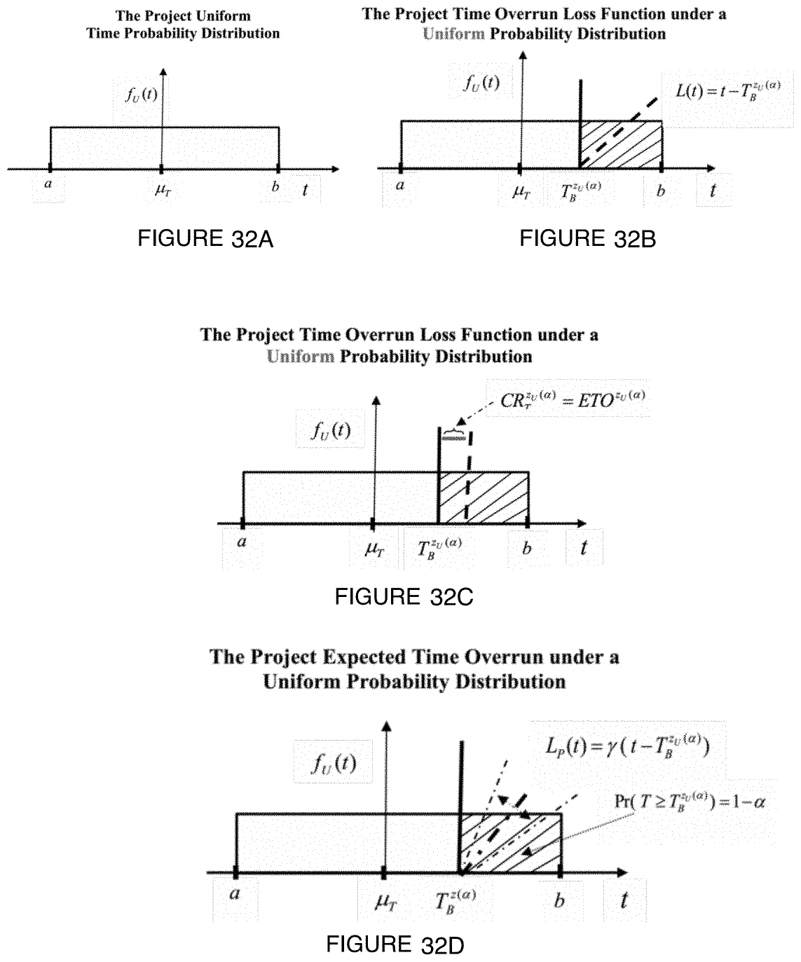

Going back to FIG. 4, finally, in step 410, system 100 may output a report detailing the quantities listed in FIG. 8 (or any other sub-quantities discussed above). In some embodiments, the report detailing these outputs may be generated or displayed by system 100 via computing device 300. In some embodiments, this may be done via the GUI (for example as illustrated in FIG. 32 for the BUDGET PRO software), and/or these results may be stored on computing device 300 via internal memory 304, or on remote database 310, for example.

With reference to FIG. 15, and in accordance with one exemplary embodiment, a project budgeting method for assessing execution time of a single project, herein referred to using the numeral 1500, and executed by system 100, will now be described.

In addition to the project cost overrun contingency reserve, as computed in method 400, one must recognize the fact that any negotiated project contract price will also need to account for the project potential time overrun and any resulting time overrun penalty. Thus, method 1500 applies the same Risk Compounding and Overrun computation described above for method 400 but where the designated assessment metric is the execution time instead of execution costs.

In addition, as for the discussed of method 400 above, below method 1500 will use the PERT-Beta probability distribution for risk assessment as an example only. Other probability distributions that may be used instead will be discussed further below.

In accordance, in step 1502, as in step 402, the project-related information 502 is acquired by system 100 and/or entered by the user. Herein, in contrast with step 402 of method 400, the input values 612 will be used. Likewise, the endogenous and exogenous percentage-wise most likely time impacts (710 and 720, respectively) will also be used in the risk compounding process.

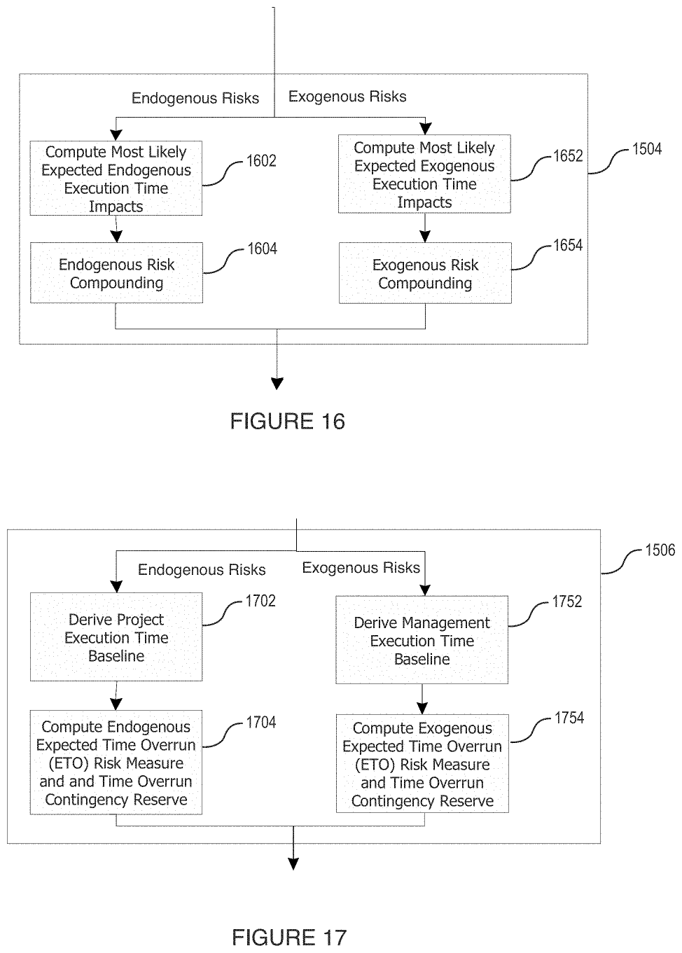

Method 1500 proceeds similarly to method 400. Thus, in step 1504 the Project Risk compounding process is applied as described above for step 404. Step 1504 is further detailed in FIG. 16, where steps 1602, 1604, 1652 and 1654 mirror steps 502, 504, 552 and 554 described above, but are directed to process the set of input values 612 (instead of the set of input values 604), and the endogenous and exogenous percentage-wise most likely time impacts 710 and 720, respectively (instead of the cost impacts 708 and 718).

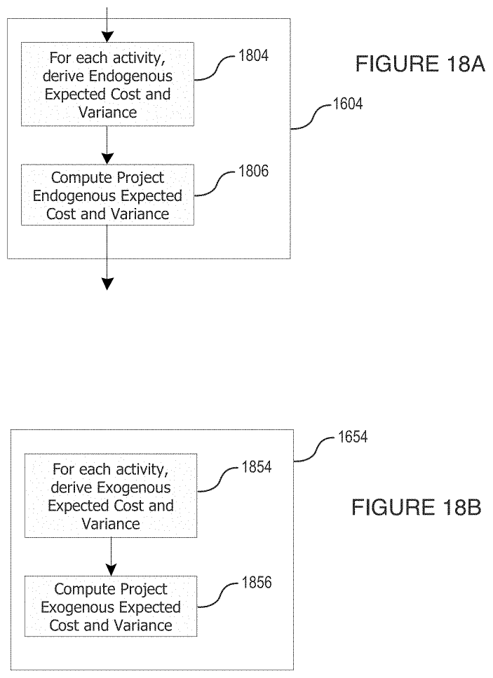

This means that, as illustrated in FIGS. 18A and 18B, step 1604 proceeds through steps 1804 and 1806, which mirror steps 1104 and 1106, and step 1654 proceeds through steps 1854 and 1856, which similarly mirror steps 1154 and 1156. Thus, an execution time ARBIA matrix 110 (for the endogenous and exogenous risk factors) may be computed to determine the most likely execution time impacts for each activity.

Step 1506 also mirrors step 406. As illustrated schematically in FIG. 17, steps 1702 and 1752 proceed as for step 1002 and 1052, but are directed to deriving the project execution time baseline and management execution time baseline, respectively. Similarly, steps 1704 and 1754 are used to derive the ETO 112 risk measure for the endogenous and exogenous risk factors, respectively.

Indeed, regarding the ETO 112 risk measure as computed in steps 1704 and 1754, it is useful to know that standard statistical cost percentile methods have proposed some methods for integrating cost and schedule contingency reserves. However, such methods suffer from the same fundamental inability to measure project time/cost tail expectations, and therefore to qualify as a coherent risk measure. Having at one's disposal the project time probability distribution, it is shown in the following section how, inter alia, method 1500 may be used to determine the project time baseline (T_{B}^{z(α)}) as well as its project expected time overrun 112 (ETO^{z(α)}) and project expected time overrun penalty 114 (ETOP^{z(α)}).

Indeed, considering that many project activity costs are time-dependent, it follows that the project cost assessment relies on the assumption of an optimized project time schedule. Hence, the project ECO^{z(α)} 110 should be relying on such an assumption. Obviously, the project time probability distribution will need to have captured all the relevant risk factors that might impact the completion times of the project activities, and mainly those determining the project's critical path. However, whatever might be the optimized project time schedule one should also take into consideration the potential project time overrun and time overrun penalty to which the contractor might be subjected. However, activity times are not always additive like activity costs. The principle of cost compensation will always apply to a project to the extent that any increase or decrease in the cost savings or cost under-runs of any activity lying on the critical path will always impact the project cost. Hence, a project time overrun will occur when time savings or time under-runs between project activities lying on the critical path activities cannot be uncovered and relied upon to prevent project total duration from exceeding the project time baseline T_{B}^{z(α)}. The principle of project time compensation will apply only when a project activity time overrun lying on the project's critical path may be compensated by other critical path activities' time under-runs or time savings. When time compensation cannot be carried out anymore through the uncovering of other critical path activity time under-runs or time savings, then the PM will need to rely on a project time overrun contingency reserve to cover any project critical path time overruns.

One way of avoiding time overrun penalties is to properly assess the project expected time overrun (ETO^{z(α)}) 112 above the project time baseline T_{B}^{z(α)}. Thus, as computed in steps 1704 and 1754, the ETO^{z(α)} risk measure 112 has as the following formal definition:

ETO^{z(α)}=E{T|T≥_{B}^{z(α)}} (26)

Just as in the case of the ECO^{z(α)} 110 risk measure (computed in step 1004 and 1054 for the endogenous and exogenous risk factors, respectively), the project ETO^{z(α)} 112 will be dependent on the time baseline significance level. The project time probability distribution shall therefore be derived from the project's critical path. Again, as discussed above, in the exemplary case where the PERT-Beta probability distribution was used, we may consider that the project duration or time T is a random variable complying with the Central Limit Theorem, and therefore governed by a Normal probability distribution with an expected value of E(T)=μ_{T}, a standard deviation σ(T)=σ_{T} such that one may write: T˜N(μ_{T}; σ_{T}). Hence, the project time probability density function is given by:

$${f}_{N} ( t ) = \frac{1}{{σ}_{T} \sqrt{2 π}} exp [ - \frac{1}{2} {( \frac{t - {μ}_{T}}{{σ}_{T}} )}^{2} ] . \qquad ( 27 )$$

Let the project time baseline T_{B}^{z(α)} define the time threshold value in compliance with the organization's z(α) risk acceptance policy. Then, the project time overrun function will be defined by the following conditional loss function:

$$\{ \begin{matrix}L ( t ) = t - {T}_{B}^{z ( α )} > 0 & if t > {T}_{B}^{z ( α )} \\ L ( t ) = 0 & if t \leq {T}_{B}^{z ( α )}\end{matrix} . \qquad ( 28 )$$

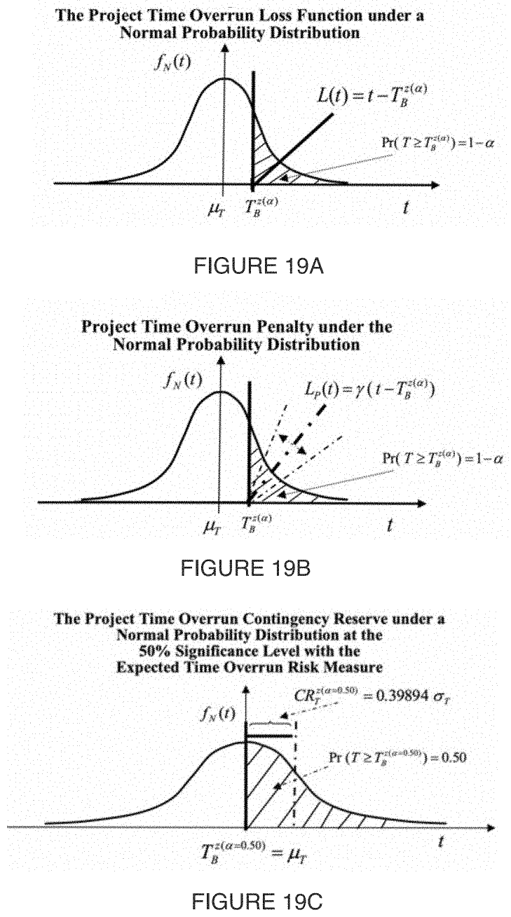

Hence, superimposing the conditional time overrun loss function over the Normal time PDF ƒ_{N}(t) one obtains FIG. 19A.

By compounding both functions L(t) and ƒ_{N}(t) within the following definite integral one may define the project Expected Time Overrun (ETO) 112 at the (1−α) significance level, in accordance with one embodiment, as:

ETO^{z(α)}=∫_{C}_{_{B}}^{+∞}(t−T_{B}^{z(α)})ƒ_{N}(t)dt (29)

and its unique and exact closed-form solution is given by:

$${ETO}^{z ( α )} = {σ}_{T} \{ \frac{1}{\sqrt{2 π}} exp [ - \frac{{z}^{2} ( α )}{2} ] - z ( α ) {F}_{N} ( - z ( α ) ) \} . \qquad ( 30 )$$

Equation (30) above may simply be written as ETO^{z(α)}=σ_{T}ψ(z(α)) with the standardized random variable z(α)=(T_{B}^{z(α)}−μ_{T})/σ_{T} and F_{N}(⋅) standing for the cumulative probability distribution of a standardized Normal N(0,1) probability distribution such that F_{N}(−z(α))=1−F_{N}(z(α))=Pr(T≥T_{B}^{z(α)})=1−α.

Notably, equation 30 will have a different form if other probability distributions are considered, as will be discussed further below.

In order to ensure that the project time overrun contingency reserve covers on average the project time overruns at the (1−α) significance level, the project time overrun contingency reserve CR_{T}^{z(α)} 812 is set to be equal to its corresponding ETO^{z(α)} 112 value:

CR_{T}^{z(α)}=ETO^{z(α)} (31).

Thus, in steps 1704 and 1754, the endogenous and exogenous ETO/Time Overrun Contingency Reserves are computed, respectively as discussed above. Notably, the endogenous execution time baseline and ETO are computed using the Endogenous Risk Acceptance Policy 510 z(α) while the exogenous baseline and ETO are computed using the Exogenous Risk Acceptance Policy 512 z(α′), respectively.

In step 1508 These are used to derive, as described above for the cost metric, the program's execution time baseline 810 and the program's execution time overrun contingency reserve 812.

Going back to FIG. 15, in step 1508 the Program's Execution Time Budget 814 is computed as being the sum of the project and management execution time baselines, while the Program's Execution Time Overrun Contingency Reserve 814 is set as the sum of the project and management execution time overrun contingency reserves.

Table 5 below summarizes within a single project setting the relationship between the project, the management and the program execution time baselines, contingency reserves and budgets.

TABLE 5
Project, Management & Program
Time Contingency Reserves at the z(α) Time Baseline OF A Single Project
Project, Management & Program
Time Baselines, Contingency Reserves & Budgets from Endogenous & Exogenous Normal Time
Probability Distributions of a Single-Project Program with the Expected Time Overrun Risk Measure

| Project | | | |
|---|---|---|---|
| Portfolio Size | Time | Time Overrun | Time |
| K = 1 | Baseline | Contingency Reserve | Budget |
| Project | Project Time | Project Time Overrun | Project Time |
| N-Time PDF | Baseline | Contingency Reserve | Budget |
| T_{N}~N(μ_{T}_{_{N}}; σ_{T} [symbol] | T_{B;N}^{z(α)} = | CR_{T}_{_{N}}^{z(α)} = ETO_{N}^{z(α)} = | B_{T}_{_{N}}^{z(α)} = T_{B,;N}^{z(α)} + CR_{T}_{_{N}}^{z(α)} |
| | μ_{T}_{_{N}} + z(α)σ_{T}_{_{N}} | σ_{T}_{_{N}}ψ(z(α)) | |
| Management | Management Time | Management Time Overrun | Management Time Budget |
| X-Time PDF | Baseline | Contingency Reserve | B_{T}_{_{X}}^{z(α′)} = T_{B; X}^{z(α′)} + CR_{T}_{_{X}}^{z(α′)} |
| T_{X}~N(μ_{T}_{_{X}}; σ_{T} [symbol] | T_{B;X}^{z(α′)} = | CR_{T}_{_{X}}^{z(α′)} = ETO_{X}^{z(α′)} = | |
| | μ_{T}_{_{X}} + z(α′)σ_{T}_{_{X}} | σ_{T}_{_{X}}ψ(z(α′)) | |
| Program | Program Time | Program Time Overrun | Program Time |
| Project Times | Baseline | Contingency Reserve | Budget |
| & | T_{B; NX} = | CR_{T}_{_{NX}} = CR_{T}_{_{N}}^{z(α)} + CR_{T}_{_{X}}^{z(α′)} | B_{T}_{_{NX}} = B_{T}_{_{N}}^{z(α)} + B_{T}_{_{X}}^{z(α′)} |
| Management | T_{B;N}^{z(α)} + T_{B;X}^{z(α′)} | | B_{T}_{_{NX}} = T_{B;NX} + CR_{T}_{_{NX}} |
| Times | | | |

$ψ ( z ( α ) ) = \{ \frac{1}{\sqrt{2 π}} exp [ - \frac{{z ( α )}^{2}}{2} ] - z ( α ) {F}_{N} ( - z ( α ) ) \} ψ ( z ( {α}^{′} ) ) = \{ \frac{1}{\sqrt{2 π}} exp [ - \frac{{z ( {α}^{′} )}^{2}}{2} ] - z ( {α}^{′} ) {F}_{N} ( - z ( {α}^{′} ) ) \}$ [symbol]
indicates data missing or illegible when filed

In step 1510, an execution time report, comprising for example the program execution time budget 814, may be generated for the user, and/or recorded on internal memory 304 or remote database 310.

### The Project Expected Time Overrun Penalty

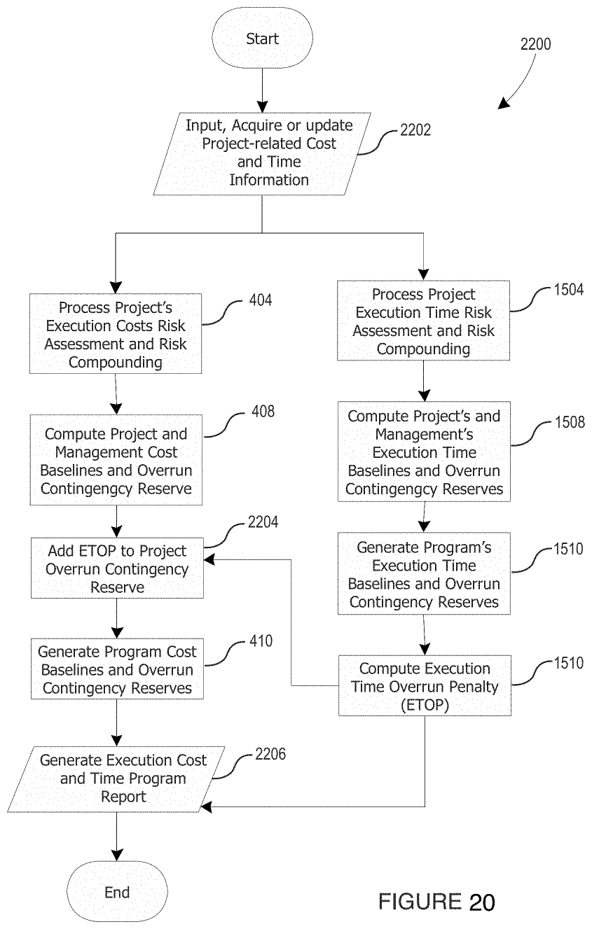

In some embodiments, the ETO risk measure 112 may also be used to derive the cost-related corresponding Expected Time Overrun Penalty (ETOP) 114. For example, in some embodiments, methods 400 and 1500 may be combined as illustrated schematically in FIG. 20. Method 2200 of FIG. 20 thus illustrates an example where both metrics are used (execution cost and execution time). This means that in step 2202 all the parameters illustrated in FIGS. 5 to 7B are acquired. Then, steps 404 to 410 (for the cost metric) and steps 1504 to 1510 (for the execution time metric) proceed as discussed above. However, in addition, at step 2204, the project expected time overrun penalty 816 computed at step 1510 may be added to the project expected cost overrun contingency reserve, as described below.

Let us now assume that the project is subjected to a time overrun penalty that is proportional to the project time overrun with respect to the contractor's project time baseline T_{B}^{z(α)} 810. Hence its conditional loss function becomes:

$$\{ \begin{matrix}{L}_{P} ( t ) = γ ( t - {T}_{B}^{z ( α )} ) & if t > {T}_{B}^{z ( α )} ; \\ {L}_{P} ( t ) = 0 & if t \leq {T}_{B}^{z ( α )}\end{matrix} \qquad ( 32 )$$

With the positive scalar γ>0 being the project time overrun cost penalty by unit of time overrun parameter 514. Superimposing the project time overrun penalty over the probability distribution yields FIG. 12B.

We define the project Expected Time Overrun Penalty (ETOP) 114 at the (1−α) significance level, by the following definite integral:

ETOP^{z(α)}=∫_{T}_{_{B}}_{^{z(α)}}^{+∞}γ(t−T_{B}^{z(α)})ƒ_{N}(t)dt (33)

and the ETOP^{z(α)} equation becomes:

$${ETOP}^{z ( α )} = γ {σ}_{T} \{ \frac{1}{\sqrt{2 π}} exp [ - \frac{{z}^{2} ( α )}{2} ] - z ( α ) {F}_{N} ( - z ( α ) ) \} \qquad ( 34 )$$

$$i . e . {ETOP}^{z ( α )} = γ {ETO}^{z ( α )} \qquad ( 35 )$$

This result needs to be given a proper interpretation. Let us consider the case of a project lump sum contract for which all costs exceeding the project budget will be at the expense of the contractor. In addition, any project time overrun will be subjected to a penalty as described by Equation (32). This implies that if the contractor does not succeed in negotiating into the contract the addition of a project time overrun contingency reserve over what he considers to be his own project time baseline T_{B}^{z(α)}, then he will need to increase his minimum cost bid in order to cover for the time overrun penalty. Obviously, such a project time overrun contingency reserve will be assessed by the contractor's own project expected time overrun ETO^{z(α)} 112.

Hence, in some embodiments, the project expected cost overrun contingency reserve will need to account for the expected time overrun penalty and be set equal to CR_{C}^{z(α)}=[σ_{C}+γσ_{T}]ψ(z(α)). This follows from the fact that the project expected time overrun penalty will be imposed upon the project contractor for exceeding the project time baseline. For instance, let us assume that the owner of the project adamantly opposes any project completion time exceeding what the contractor considers to be the project expected time E(T)=μ_{T} according to his own time assessment. Hence, any completion time exceeding the project mean time would be subjected to a penalty of $γper unit of time overrun (e.g. input Project Time Overrun Cost Penalty by Unit of Time Overrun 514). The contractor therefore needs to assess at the (1−α)=0.50 significance level the project's expected time overrun, i.e. CR_{T}^{z(α=0.50)}=ψ(z(α=0.50) σ_{T}=0.39894σ_{T}.

This time constraint would imply an expected time overrun of ETO^{z(α=0.50)}=0.3989σ_{T} and therefore an expected time overrun penalty equal to ETOP^{z(α=0.50)}=0.3989 γσ_{T}. Hence, under such contractual conditions the project minimum cost bid (PC), in compliance with the contractor's own z(α) cost budgeting policy, should be set at P_{C}=C_{B}^{z(α)}+CR_{C}^{z(α)}+0.3989 γσ_{T}. Note that the minimum price bid does not include the management reserve and the contractor's profit margin.

By equating the project cost overrun contingency reserve to the project cost tail expectation the ECO risk measure 110 has enabled the proper assessment of the project cost overrun contingency reserve viewed as an intangible insurance coverage contract instead of a tangible fully funded and totally expendable reserve. The expected cost overrun or ECO^{z(α)} risk measure must therefore be viewed in project cost budgeting as a paradigm shift from the standard statistical cost percentile method. An identical paradigm shift occurred decades ago in the banking and investment industries as the Expected Shortfall or ES_{α} risk measure created a paradigm shift from the statistical loss quantile method. The Expected Shortfall or ES_{α} risk measure is statistically assessed from the security portfolio Profit & Loss probability distribution by the loss tail expectation of the security portfolio. Its value is assessed by the following:

$${ES}_{α} = \frac{1}{( 1 - α )} {\int }_{α}^{1} {q}_{u} ( {F}_{L} ) du = \frac{1}{( 1 - α )} {\int }_{α}^{1} {VaR}_{u} ( L ) du .$$

Going back to FIG. 20, at step 2206, a combined or aggregate report is generated to the user illustrating both cost-related and time-related outputs to the user, and/or stored on internal memory 304 or remote database 310.

### The Program/Portfolio Expected Cost Overrun

Above, in methods 400, 1500 and 2200, the ECO and ETO risk measures 110 and 112 were used in the context of a single project setting. In the methods discussed below by system 100, those risk measures will be extended to that of the project portfolio, wherein a program/portfolio cost overrun contingency reserve will be assessed under various correlation coefficients between the costs of the portfolio projects. The derivation of the properties of project portfolios under various correlation coefficients will be carried out with a replicated-project portfolio. From the replicated-project portfolio, we shall derive the relationship between the single project and the program/portfolio cost contingency reserve with project cost overrun contingency reserves viewed as insurance coverage funded by a program/portfolio cost overrun contingency reserve under the control of a program director (PD). The PD will be acting as an insurer to whom project managers (PM) will be submitting their claims when pre-identified and agreed-upon contingencies have actually materialized. Although portfolio risk diversification will ensure that the program/portfolio cost overrun contingency reserve will generally be smaller than the sum of the projects' contingency reserves, program/portfolio contingency reserve will nevertheless prove to be sufficient to cover on average the PM's potential contingency claims.

Generally, to analyze the impact of portfolio risk diversification on the project portfolio expected cost overrun contingency reserve, we shall determine the statistical parameters of an organization's program/portfolio costs containing, for example, K risky projects. We shall therefore be assuming that the project cost probability distribution of every one of the K projects is known, which implies that all the probability distributions capture the potential cost impact of their relevant risk factors.

The program/portfolio random cost C_{K} resulting from the aggregation of K projects is defined by the sum of their K random project costs:

C_{K}=Σⱼ₌₁^{K}Cⱼ (36).

The project portfolio expected cost and variance are respectively given by:

μ_{C, K}=E(C_{K})=Σⱼ₌₁^{K}E(Cⱼ)=Σⱼ₌₁^{K}μⱼ (37)

and: σ_{C; K,ρ}²=V(C_{K,ρ})=Σⱼ₌₁^{K}σ²(Cⱼ)+2Σᵢ₌₁^{K-1}Σj=i+1^{K}ρi,jσ(Cᵢ)σ(Cⱼ) (38)

with 0≤ρ_{i,j}≤1 measuring the correlation coefficients 1604 between project costs.

In some embodiments, the project portfolio cost variance may be assessed, on the basis of common project cost correlation coefficients 1604, i.e. ρ_{i,j}=ρ; ∀i≠j, by the following equation:

σ_{C; K,ρ}²=V(C_{K})=Σⱼ₌₁σ²(Cⱼ)+2ρΣᵢ₌₁^{K-1}Σⱼ₌ᵢ₊₁σ(Cᵢ)σ(Cⱼ) (39).

For example, one might expect projects carried out within an organization to be subjected to a common correlation coefficient on the basis that, on the one hand, such projects are generally carried out in a common industry or sector of economic activity and, on the other hand, that these projects are generally subjected to common program-specific risk factors and common project and program management rules and practices.

One might also assume that a strong correlation coefficient within a portfolio could result from a very mature and highly integrated project management culture and from projects carried out in a common industry, while a weak correlation coefficient might result from projects executed in different sectors of economic activity and/or carried out by less mature, less integrated and/or by more decentralized project management policies so as to be less subjected to common program-specific risk factors. For example, the values of 0.15, 0.45 and 0.80 have been successfully used to characterize weak, moderate, and strong project cost correlation coefficients in a construction project.

Furthermore, assuming that each project possesses a minimum number of activities (n≥15) then, by virtue of the Central Limit Theorem, their cost probability distributions will comply with a Normal probability distribution. Consequently, the program cost probability distribution of a portfolio containing K projects will also obey a Normal probability distribution and:

C_{K}˜N(μ_{C; K};σ_{C;K, ρ}) (40).

Considering that the program/portfolio cost baseline is subjected to the organization's risk acceptance policy, its cost baseline will therefore be set at:

C_{B; K,ρ}^{z(α)}=μC; K;σ_{C;K, ρ)} (41).

Hence, the project portfolio standardized z(α) value will always be yielding a constant value thereby ensuring the compliance of program/portfolio cost budgeting rules with the organization's risk acceptance policy. The program/portfolio random cost C_{K} should not exceed its cost baseline with a probability exceeding that of its significance level, so that:

Pr(C_{K}≥C_{B;K,ρ}^{z(α)})=Pr(Z_{N}≥z(α))=1−α (42)

The magnitude of the program/portfolio cost overrun or conditional loss function L(c_{K}) shall be defined with respect to its cost baseline by the following asymmetrical conditional loss function:

$$\{ \begin{matrix}L ( {c}_{K} ) = {c}_{K} - {C}_{B ; K , ρ}^{z ( α )} & if {c}_{K} > {C}_{B ; K , ρ}^{z ( α )} \\ L ( {c}_{K} ) = 0 & if {c}_{K} \leq {C}_{B ; K , ρ}^{z ( α )}\end{matrix} . \qquad ( 43 )$$

Equation (43) above indicates that a PD will need to devise active program risk response strategies for contingent events for which the program/portfolio costs might actually exceed the program/portfolio cost baseline. Such a cost baseline therefore becomes the program/portfolio cost overrun threshold value. Hence, we explicitly define the program/portfolio Expected Cost Overrun (ECO_{K,ρ}^{z(α)}) for any probability density function ƒ(c_{K}) by the following definite integral:

ECO_{K,ρ}^{z(α)}=∫_{C}_{_{B;K,ρ}}_{^{z(α)}}^{+∞}(c_{K}−C_{B;K,ρ}^{z(α)})ƒ(c_{K})dc_{K} (44).

Let us consider the case of a risky program/portfolio whose expected value is given by E(C_{K})=μ_{C; K}, and its standard deviation by σ(C_{K})=σ_{C; K,ρ}. In the exemplary case where the PERT-Beta probability distribution was used (and generalized to a Normal probability distribution), assuming moreover that the K portfolio projects' cost probability distributions comply with the Central Limit Theorem and are therefore governed by a Normal probability distribution, then so will the program/portfolio cost probability distribution so that one may write: C_{K}˜N(μ_{C; K};σ_{C; K,ρ}). Its probability density function is therefore given by:

$${f}_{N} ( {c}_{K} ) = \frac{1}{{σ}_{C ; K , ρ} \sqrt{2 π}} exp [ - \frac{1}{2} {( \frac{{c}_{K} - {μ}_{C ; K}}{{σ}_{C ; K , ρ}} )}^{2} ] . \qquad ( 45 )$$

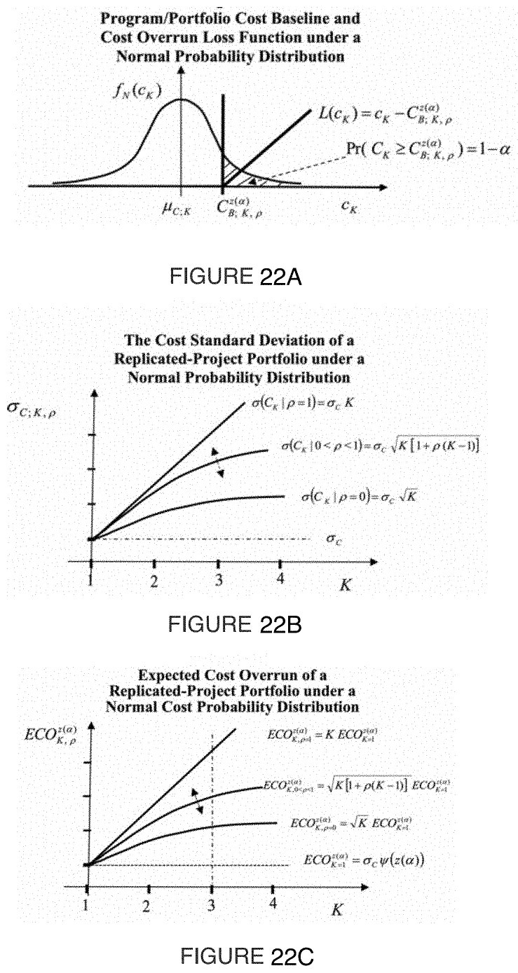

Superimposing the program/portfolio conditional loss function over its probability distribution yields FIG. 22A with its cost baseline C_{B; K,ρ}^{z(α)} set at the (1−α) significance level.

The program/portfolio cost overrun contingency reserve will be assessed by the Expected Cost Overrun or ECO risk measure, a coherent risk measure to the extent that it measures the tail expectation of the program/portfolio cost probability distribution and therefore complies with the sub-additivity axiom.

Its unique and exact closed-form solution is given by:

$${ECO}_{K , ρ}^{z ( α )} = {σ}_{C ; K , ρ} \{ \frac{1}{\sqrt{2 π}} exp [ - \frac{{z}^{2} ( α )}{2} ] - z ( α ) {F}_{N} ( - z ( α ) ) \} \qquad ( 46 )$$

with F_{N}(⋅) standing for the cumulative probability distribution of a standardized N(0,1) Normal probability distribution such that F_{N}(−z(α))=1−F_{N}(z(α))=Pr(C_{K}≥C_{B; K,ρ}^{z(α)})=1−α.

Table 6, below, summarizes the results of the project portfolio cost overrun contingency reserve and budget for decreasing project significance levels and increasing z(α) cost budgeting policies:

TABLE 6
The Project Cost Contingency Reserve & Budget Under a Normal Cost Probability
Distribution For Various z(α) Cost Budgeting Policies with The Expected Cost
Overrun Risk Measure

| Project | | | | |
|---|---|---|---|---|
| Portfolio Cost | | | | |
| Overrun | | | Project Portfolio | |
| Probability: | Project | | Cost Overrun | |
| Significance | Portfolio | | Contingency | |
| level | Cost | Project Portfolio | Reserve | Project Portfolio Cost |
| Pr(C_{K} ≥ | Budgeting | Cost Baseline | CR_{C; K,ρ}^{z(α)} = | Budget |
| C_{B; K,ρ}^{z(α)}) = | Policy | C_{B; K,ρ}^{z(α)} = | ECO_{K,ρ}^{z(α)} = | B_{C;K}^{z(α)} = |
| 1 − α | z(α) | μ_{C; K} + z(α)σ_{C; K,ρ} | σ_{C; K,ρ} ψ(z(α)) | C_{B; K,ρ}^{z(α)} + CR_{C; K,ρ}^{z(α)} |
| 0.50 | 0 | μ_{C; K} | 0.39894σ_{C; K,ρ} | μ_{C; K} + 0.3989σ_{C; K,ρ} |
| 0.40 | 0.25 | μ_{C; K} + 0.25 σ_{C; K,ρ} | 0.28666 σ_{C; K,ρ} | μ_{C; K} + 0.5366σ_{C; K,ρ} |
| 0.30 | 0.525 | μ_{C; K} + 0.525 σ_{C; K,ρ} | 0.19008 σ_{C; K,ρ} | μ_{C; K} + 0.7151 σ_{C; K,ρ} |
| 0.20 | 0.84 | μ_{C; K} + 0.84 σ_{C; K,ρ} | 0.11234 σ_{C; K,ρ} | μ_{C; K} + 0.95234 σ_{C; K,ρ} |
| 0.15 | 1 | μ_{C; K} + 1σ_{C; K,ρ} | 0.08327σ_{C; K,ρ} | μ_{C; K} + 1.08327σ_{C} |
| 0.10 | 1.28 | μ_{C; K} + 1.28σ_{C; K,ρ} | 0.04785 σ_{C; K,ρ} | μ_{C; K} + 1.32785σ_{C} |
| 0.05 | 1.65 | μ_{C; K} + 1.65σ_{C; K,ρ} | 0.01976σ_{C; K,ρ} | μ_{C; K} + 1.66976 σ_{C} |
| 0.0228 | 2 | μ_{C; K} + 2σ_{C; K,ρ} | 0.00839σ_{C; K,ρ} | μ_{C; K} + 2.00839 σ_{C; K,ρ} |
| 0.01 | 2.33 | μ_{C; K} + 2.33σ_{C; K,ρ} | 0.00312σ_{C; K,ρ} | μ_{C; K} + 2.33312 σ_{C; K,ρ} |

$ψ ( z ( α ) ) = \frac{1}{\sqrt{2 π}} exp [ - \frac{{z}^{2} ( α )}{2} ] - z ( α ) {F}_{N} ( - z ( α ) )$
PROJECT PORTFOLIO COST PDF C_{K}~N(μ_{C; K}; σ_{C; K,ρ})

Increasing the program/portfolio confidence level will inevitably translate into a decreasing program/portfolio expected cost overrun. Hence, in order for the program/portfolio contingency reserve CR_{C; K,ρ}^{z(α)} to cover on average all program/portfolio cost overruns one must therefore set it equal to the program/portfolio expected cost overrun:

CR_{C; K,ρ}^{z(α)}=ECO_{K,ρ}^{z(α)} (47).

Equations (36) to (47) may be used when dealing with heterogeneous projects within a portfolio characterized essentially by different cost probability distributions and therefore by different cost parameters. Given that ECO_{K,ρ}^{z(α)} is a coherent risk measure complying with the sub-additivity axiom, it follows that risk diversification will ensure that the project portfolio expected cost overrun will not exceed the sum of the individual projects' expected cost overruns when taken on their own, i.e. ECO_{K,ρ}^{z(α)}≤Σⱼ₌₁^{K}ECOⱼ^{z(α)}. Portfolio risk diversification will always be effective even when project costs are perfectly correlated, and even when project costs are subjected to first-order serial correlation.

The sub-additivity property of the ECO_{K,ρ}^{z(α)} risk measure is a quite remarkable property enabling organizations to benefit from portfolio risk diversification. Hence, the program/portfolio's funded contingency reserve will be considerably smaller than the sum of the portfolio projects' contingency insurance contracts (as the more so the smaller will be the correlation coefficient between the project costs). Portfolio risk diversification is feasible because each project contingency reserve is not defined as a fully funded reserve but as insurance coverage. Such contingency insurance contracts must be opposed to standard project cost percentile contingency reserves viewed from project inception as fully funded tangible reserves expected to have been, as a matter of fact, totally expended by project completion. Obviously, when contingency reserves are fully funded reserves from the very inception of projects then no benefits from portfolio risk diversification can ever be expected.

### The Replicated-Project Portfolio Expected Cost Overrun

Elucidating the general properties of heterogeneous program/portfolios, i.e. portfolios with projects exhibiting different cost probability distributions, is analytically unfeasible, except for the well-established sub-additive risk diversification property of a coherent risk measure. However, elucidating the general properties of a homogenous program/portfolio, e.g. of a replicated-project portfolio with identical cost probability distributions, is feasible to the extent that one should be capable of determining the mathematical properties of their unique and exact closed-form solution. Moreover, such a replicated-project portfolio offers some real advantages, namely when it comes to: (a) depicting frequent real-life situations; (b) determining the relationship between the replicated-project portfolio ECO_{K,ρ}^{z(α)} and those of its portfolio projects ECOⱼ^{z(α)}; (c) analytically measuring the benefits from portfolio risk diversification; and (d) extending the basic risk-diversification properties of replicated-project portfolios to those of heterogeneous program/portfolios.

Setting forth the proposition that the K projects of a program/portfolio replicate a representative project and therefore possess identical cost parameters is not unrealistic; on the contrary, it is quite realistic for there are many cases mainly in the construction industry, where projects within replicated-project portfolios possess common cost parameters. For instance, each story of a 30-story building represents a replicable project and the 30-story building represents a program/portfolio of 30 replicated building story projects. One would realistically assume that the cost probability distribution of each story would be identical to one another. In a similar fashion, each 10-mile stretch of a 150-mile long highway represents a replicable project and the 150-mile long highway represents a program/portfolio of 15 replicated 10-mile stretch highway projects. One would realistically assume that the cost probability distribution of each 10-mile stretch of highway would be identical to one another. All the replicated projects within a portfolio can be assumed to share common cost probability distributions under normal construction conditions (e.g. homogenous construction conditions) and therefore identical cost parameters.

Let all K projects of a program/portfolio be the identical replication of a representative project so as to possess common cost probability distributions, i.e. Cⱼ˜N(μ_{C};σ_{C}); ∀j∈K. The program/portfolio random cost C_{K}=Σⱼ₌₁^{K}Cⱼ is the sum of the K project random costs. Given that the K projects' expected values take on identical values, i.e. E(Cᵢ)=E(Cⱼ)=μ_{C};∀i,j, as well as their variances, i.e. σ²(Cᵢ)=σ²(Cⱼ)=σ_{C}²; ∀i,j, it therefore follows that the program/portfolio cost expected value E(C_{K}) and variance V(C_{K,ρ}) will respectively be given by:

μ_{C; K}=E(C_{K})=Σⱼ₌₁^{K}μ_{C}_{ⱼ}=Kμ_{C} (48)

σ_{C; K,ρ}²=V(C_{K,0≤ρ≤1})=Σⱼ₌₁^{K}σ²(Cⱼ)+2ρΣᵢ₌₁^{K-1}Σⱼ₌ᵢ₊₁^{K}σ(Cᵢ)σ(Cⱼ) (49)

Equation (49), above, rests on the assumption that project costs correlate to one another with a common project cost correlation coefficient, i.e. ρ_{i,j}=ρ; ∀i, j. Hence, the replicated-project portfolio's cost variance may be written as:

$${σ}_{C ; K , ρ}^{2} = V ( {C}_{N , K , ρ} ) = K {σ}_{C}^{2} + 2 \cdot ρ ( \frac{K ( K - 1 )}{2} ) {σ}_{C}^{2} \qquad ( 50 )$$

and its standard deviation as:

σ_{C; K,ρ}=σ(C_{K, 0≤ρ≤1})=σ_{C}\sqrt{K[1+ρ(K−1)]}=σ_{C}ω (51)

with ω=\sqrt{K[1+ρ(K−1)]}.

The program/portfolio cost standard deviation should therefore be bounded by an upper limit when ρ=1 and by a lower limit when ρ=0. On the one hand, when the replicated project costs are uncorrelated (ρ=0), the portfolio's cost standard deviation becomes:

σ_{C; K,ρ=0}=σ(C_{K,ρ}|ρ=0)=α_{C}\sqrt{K} (52)

and will be increasing monotonically in a non-proportional fashion with the square rooted number of the replicated projects' standard deviation.

On the other hand, when the replicated project costs are perfectly correlated (ρ=1) the portfolio cost standard deviation becomes:

σ_{C; K,ρ=1}=σ(C_{K,ρ}|ρ=1)=σ_{C}K (53)

and will also be monotonically increasing but proportionately with the number of replicated projects' standard deviation without ever being bounded by any upper limit.

Finally, when the replicated project costs are partially correlated (0<ρ<1) the portfolio cost standard deviation becomes:

σ_{C;K,0<ρ<1}=σ(C_{K,ρ}|0<ρ<1)=σ_{C}\sqrt{K[1+ρ(K−1)]} (54)

and will also be monotonically increasing but in a non-proportional fashion with the square rooted value of a weighted number of the replicated projects' standard deviation.

Hence, one may conclude that the program/portfolio cost standard deviation with partially correlated project costs will be bounded by those of perfectly correlated and uncorrelated project costs. Hence, the following inequalities will hold:

σ_{C}≤σ_{C}\sqrt{K}≤σ_{C}\sqrt{K[1+ρ(K−1)]}≤σ_{C}K (55)

for 0≤ρ≤1 and K≥1. This is illustrated in FIG. 22B, which depicts the monotonically increasing program/portfolio cost standard deviation for a project portfolio increasing in size and subjected to different correlation coefficients.

In compliance with the organization's risk acceptance policy, the program/portfolio cost baseline C_{B; K,ρ}^{z(α)} will be set at:

C_{B; K,ρ}^{z(α)}μ_{C;K}+z(α)σ_{C;K,ρ}=Kμ_{C}+z(α)σ_{C}\sqrt{K[1+ρ(K−1)]} (56)

Hence, assuming that the representative project contains a sufficiently high number of activities (n≥15), one may correctly assume, by virtue of the Central Limit Theorem, that every project's cost probability distribution will be governed by a Normal distribution, and so will that of a replicated-project portfolio:

C_{K}˜N(μ_{C; K}=Kμ_{C};σ_{C;K,ρ}=σ_{C}{square root over (K[1+ρ(K−1)]))} (57)

Complying with the organization's risk acceptance policy, the program/portfolio cost baseline C_{B; K,ρ}^{z(α)} will set such that:

Pr(C_{K}≥C_{B;K,ρ}^{z(α)})=Pr(Z_{N}≥z(α))=1−α (58)

The expected cost overrun ECO_{K, ρ}^{z(α)} of a replicated-project portfolio assessed at its cost baseline will be given (assuming a normal probability distribution, as discussed above for example) by:

$${ECO}_{K , ρ}^{z ( α )} = {σ}_{C} ω \{ \frac{1}{\sqrt{2 π}} exp [ - \frac{{z ( α )}^{2}}{2} ] - z ( α ) {F}_{N} ( - z ( α ) ) \} \qquad ( 59 )$$

with ω=\sqrt{K[1+ρ(K−1)]}; 0≤ρ≤1; and z(α)=(C_{B;K}^{z(α)}−Kμ_{C})/σ_{C}ω.

In order for the replicated-project program/portfolio contingency reserve to cover on average the program/portfolio cost overruns, one must therefore set it equal to its expected cost overrun:

CR_{C; K,ρ}^{z(α)}=ECO_{K,ρ}^{z(α)} (60).

Considering the case of a single project portfolio with K=1, then ω=1 and its ECO_{K=1}^{z(α)} will be given by:

$${ECO}_{K = 1}^{z ( α )} = {σ}_{C} \{ \frac{1}{\sqrt{2 π}} exp [ - \frac{{z ( α )}^{2}}{2} ] - z ( α ) {F}_{N} ( - z ( α ) ) \} \qquad ( 61 )$$

with the project cost baseline set at the z(α) cost budgeting policy.

On the one hand, if project costs are uncorrelated between one another, i.e. ρ=0, then ω=\sqrt{K} and its ECO_{K, ρ=0}^{z(α)} will be given by:

ECO_{K, ρ=0}^{z(α)}=\sqrt{K}ECO_{K=1}^{z(α)} (62).

Equation (62) implies that the expected cost overrun ECO_{K, ρ=0}^{z(α)} of K replicated projects with uncorrelated project costs will increase non-proportionately with the square-rooted value of the number of replicated projects' ECO_{K=1}^{z(α)}.

On the other hand, when project costs are perfectly correlated with one another, i.e. ρ=1, then ω=K and its ECO_{K, ρ=1}^{z(α)} will be given by:

ECO_{K, ρ=1}^{z(α)}=K ECO_{K=1}^{z(α)} (63).

Equation (63) implies that the expected cost overrun of K replicated projects ECO_{K, ρ=1}^{z(α)} with perfectly correlated project costs will increase proportionately with the number of replicated projects' ECO_{K=1}^{z(α)}. Although the addition of projects to the portfolio with perfectly correlated costs will not translate into any gain in risk reduction, it will nevertheless not increase the portfolio ECO_{K, ρ=1}^{z(α)} more than proportionately to the number of individual ECO_{K=1}^{z(α)} of the K replicated projects.

In fact, the portfolio ECO_{K, ρ=1}^{z(α)} will nevertheless and still comply with the sub-additivity property although no risk reduction will actually have taken place. Finally, when project costs are partially correlated with one another, i.e. 0<ρ<1, then ECO_{K, 0<ρ<1}^{z(α)} will be given by:

ECO_{K, 0<ρ<1}^{z(α)}=\sqrt{K[1+ρ(K−1)]}ECO_{K=1}^{z(α)}=ωECO_{K=1}^{z(α)} (64).

Equation (64) implies that the expected cost overrun of K replicated projects with partially correlated project costs will increase non-proportionately along a weighted number of the replicated representative project's ECO_{K=1}^{z(α)}.

FIG. 22C depicts the monotonically increasing replicated-project portfolio ECO_{K,0≤ρ≤1}^{z(α)} fora program/portfolio increasing in size with increasing cost correlation coefficients. Equations (62), (63), and (64) enable one to conclude that any increase in a project correlation coefficient ρ will increase the program/portfolio expected cost overrun and, therefore, its cost overrun contingency reserve for whatever z(α) cost budgeting policy.

In this latter case, portfolio risk diversification will have been effective for any given size of the project portfolio although decreasing in effectiveness with an increasing cost correlation coefficient given that:

CR_{C;K=1}^{z(α)}<CR_{C;K ρ=0}^{z(α)}<CR_{C;K; 0<ρ<1}^{z(α)}<CR_{C;K, ρ=1}^{z(α)} (65).

Hence, for a common confidence level the CR_{C;K; ρ}^{z(α)} of replicated project costs with partially correlated costs will stand strictly between that of a replicated project with uncorrelated costs and that of a replicated project with perfectly correlated costs.

Table 7, below, provides an overview of a replicated project portfolio with cost baselines, contingency reserves and budgets (which as an example does not include the management reserve) assessed by the ECO risk measure under a Normal probability distribution at the 15% significance level when the project cost correlation coefficient along the portfolio size are increased:

TABLE 7
Replicated-Project Portfolio Cost Baselines, Contingency Reserves & Budgets at the 15% significance levels
under the Normal Probability Distribution with The Expected Cost Overrun Risk Measure

| | Number | | | |
|---|---|---|---|---|
| | of | Project & Program | Project & Program | Project & Program |
| | Projects | Cost Baseline | Contingency Reserves | Budgets |
| Cost | K | C_{B; K,ρ}^{z(α)} = Kμ_{C} + z(α) σ_{C} ω | CR_{C;K, ρ}^{z(α)} = ω ECO_{K=1}^{z(α)} = | B_{B; K,ρ}^{z(α)} = C_{B; K,ρ}^{z(α)} + |
| Budgeting | | | σ_{C} ω ψ(z(α) | CR_{C;K,ρ}^{z(α)} |
| Policy | | Project | Project | Project |
| z(α = | | Cost Baselines | Contingency Reserves | Basic Budget |
| 0.85) = 1 | K = 1 | C_{B;K=1}^{z(α=0.85)=1} = μ_{C} + σ_{C} | CR_{C,K=1}^{z(α=0.85)=1} = 0.09197 σ_{C} | B_{B; K=1}^{z(α)=1} = μ_{C} + 1.09197σ_{C} |
| Correlation | | Program/Portfolio | Program/Portfolio | Program/Portfolio |
| Coefficient | | Cost Baselines | Contingency Reserves | Basic Budget |
| ρ = 0 | K = 4 | C_{B;K=4}^{z(α=0.85)=1} = 4μ_{C} + 2σ_{C} | CR_{C,K=4;ρ=0}^{z(α=0.85)=1} = 0.18394 σ_{C} | B_{B; K=4,ρ=0}^{z(α)=1} = |
| | | | | 4μ_{C} + 2.1839σ_{C} |
| | K = 9 | C_{B;K=9}^{z(α=0.85)=1} = 9 μ_{C} + 3σ_{C} | CR_{C,K=9;ρ=0}^{z(α=0.85)=1} = 0.27591σ_{C} | B_{B; K=9,ρ=0}^{z(α)=1} = |
| | | | | 9μ_{C} + 3.27591σ_{C} |
| | K = 16 | C_{B;K=16}^{z(α=0.85)=1} = 16μ_{C} + 4 σ_{C} | CR_{C,K=16;ρ=0}^{z(α=0.85)=1} = 0.36788 σ_{C} | B_{B; K=16,ρ=0}^{z(α)=1} = |
| | | | | 16μ_{C} + 4.36788σ_{C} |
| ρ = 0.50 | K = 4 | C_{B;K=4}^{z(α=0.85)=1} = 4 μ_{C} + 3.1622σ_{C} | CR_{K=4;ρ=0.50}^{z(α=0.85)=1} = 0.29083σ_{C} | B_{B; K=4,ρ=0.5}^{z(α)=1} = |
| | | | | 4μ_{C} + 3.45303σ_{C} |
| | K = 9 | C_{B;K=9}^{z(α=0.85)=1} = 9 μ_{C} + 6.7082σ_{C} | CR_{C,K=9;ρ=0.50}^{z(α=0.85)=1} = 0.61696σ_{C} | B_{B; K=9,ρ=0.5}^{z(α)=1} = |
| | | | | 9μ_{C} + 7.32516σ_{C} |
| | K = 16 | C_{B;K=16}^{z(α=0.85)=1} = 16μ_{C} + 11.6119 σ_{C} | CR_{C,K=16;ρ=0.50}^{z(α=0.85)=1} = 1.07255 σ_{C} | B_{B; K=16,ρ=0.5}^{z(α)=1} = |
| | | | | 16μ_{C} + 12.6844σ_{C} |
| ρ = 1 | K = 4 | C_{B;K=4}^{z(α=0.85)=1} = 4 μ_{C} + 4σ_{C} | CR_{C,K=4;ρ=1}^{z(α=0.85)=1} = 0.36788 σ_{C} | B_{B; K=4,ρ=1}^{z(α)=1} = |
| | | | | 4μ_{C} + 4.36788σ_{C} |
| | K = 9 | C_{B;K=9}^{z(α=0.85)=1} = 9 μ_{C} + 9σ_{C} | CR_{C,K=9;ρ=1}^{z(α=0.85)=1} = 0.82773 σ_{C} | B_{B; K=9,ρ=1}^{z(α)=1} = |
| | | | | 9μ_{C} + 9.82773σ_{C} |
| | K = 16 | C_{B;K=16}^{z(α=0.85)=1} = 16μ_{C} + 16σ_{C} | CR_{C,K=16;ρ=1}^{z(α=0.85)=1} = 1.47153 σ_{C} | B_{B; K=16,ρ=1}^{z(α)=1} = |
| | | | | 16μ_{C} + 17.4715σ_{C} |

$ψ ( z ( α ) ) = \frac{1}{\sqrt{2 π}} exp [ - \frac{{z ( α )}^{2}}{2} ] - z ( α ) {F}_{N} ( - z ( α ) ) ω = \sqrt{K [ 1 + ρ ( K - 1 ) ]}$

Results contained in Table 7, above, are the quantitative equivalents of those given by the graph in FIG. 22C as the program/portfolio ECO_{P=K,0≤ρ≤1}^{z(α)} will be monotonically increasing with the portfolio size along with an increasing correlation coefficient. In all cases, portfolio risk diversification will be effective as the program/portfolio cost overrun contingency reserve will be sub-additive and, therefore, no greater than the sum of the individual projects' cost overrun contingency reserves. One might infer that such results should also hold for heterogeneous program/portfolios.

### Program/Portfolio Cost Overrun Contingency Reserves for Endogenous and Exogenous Risk Factors

Program/portfolio contingency reserves can be extended to cover endogenous and exogenous risk factors impacting the cost probability distributions of the program/portfolio K projects. On the one hand, endogenous risk factors comprise all risk factors originating from within the project inner environment and falling under the authority, oversight, and control of the project manager (PM). Endogenous risk factors define the project endogenous N-cost probability distribution of the K projects which requires them to capture all the relevant endogenous risk factors impacting their cost probability distribution on an individual project basis before being rolled-up into the program/portfolio in order to enable the portfolio project contingency reserve to cover the potential insurance claims coming out of the totality of the project contingency reserve insurance contracts. On the other hand, exogenous risk factors comprise all risk factors originating from outside the project inner environment but inside the program environment and falling under the authority, oversight, and control of the program director (PD). Exogenous risk factors define the project exogenous X-cost probability distribution of the K projects and their portfolio which requires them to capture all the relevant exogenous risk factors in order for the portfolio management reserve to cover the potential insurance claims coming out of the totality of the management contingency reserve insurance contracts.

To study the impact of endogenous and exogenous risk factors on the program/portfolio cost overrun contingency reserves, let us consider the properties of the project portfolio when projects are described by their respective endogenous N-cost and exogenous X-cost probability distributions. In this exemplary embodiment, using the PERT-Beta probability distribution discussed above, we may further assume that the portfolio projects contain a sufficiently high number of activities (n≥15) in order to be able to invoke the Central Limit Theorem and consequently assume that the probability distributions of every project's endogenous N-cost and exogenous X-cost probability distributions will both be complying with a Normal probability distribution, i.e. C_{N,j}˜N(μ_{C}_{_{N}}_{,j}; σ_{C}_{_{N}}_{,j}) and C_{X,j}˜N(μ_{C}_{_{X}}_{,j}; σ_{C}_{_{X}}_{,j}) for j=1, 2, 3, . . . , K. Acknowledging differences between endogenous and exogenous cost probability distributions for every one of the K projects of a program/portfolio might also imply a project z(α) risk acceptance policy different from the management z(α′) risk acceptance policy. Just as in the case of the management reserve, overriding strategic concerns should guide upper management in deciding for an identical or different risk acceptance policies concerning project endogenous cost baselines C_{B; N,K,ρ}_{_{N}}^{z(α)} and exogenous cost baselines C_{B; X,K,ρ}_{_{X}}^{z(α)}, as well as for assessing project contingency reserves CR_{C}_{_{N}}_{,K,ρ}_{_{N}}^{z(α)} and management contingency reserves CR_{C}_{_{X}}_{,K,ρ}_{_{X}}^{z(α′)}. The ECO risk measure can therefore comply with any of an organization's strategic cost budgeting policy for it enables upper management to implement decisions promoting risk mitigation strategy trade-offs between project cost overrun contingency reserves and management cost overrun contingency reserves. The answer to identical or differentiated cost budgeting policies should ultimately be provided by a strategic analysis of the organization's goals and landscape competitive position as well as its tactics and operations.

### The Program/Portfolio Endogenous N-Cost Project Contingency Reserve

Considering the program/portfolio's K projects with their respective endogenous N-cost probability distributions, i.e. C_{N,j}˜N(μ_{C}_{_{N}}_{,j}; σ_{C}_{_{N}}_{,j}); j=1, 2, 3, . . . , K, we define C_{N,K} the program/portfolio random endogenous N-cost by the sum of its K project random endogenous N-costs

C_{N,K}=Σⱼ₌₁^{K}C_{N,j} (66).

Hence, under the assumption of replicated projects within a project portfolio with their common expected N-cost expected value E(C_{N,j})=E(C_{N})=μ_{C}_{_{N}}; ∀j and common N-cost variance V(C_{N,j})=V(C_{N})=σ_{C}_{_{N}}²; ∀j, the program/portfolio N-cost expected value and variance will respectively be given by:

μ_{C}_{_{N}}_{,K}=E(C_{N, K})=Σⱼ₌^{K}E(C_{N,j})=Σⱼ₌₁^{K}μ_{C}_{_{N}}_{,j} (67)

and:

σ_{C}_{_{N;}}_{K,ρ}_{_{N}}²=V(C_{N,K,ρ}_{_{N}})=Σⱼ₌₁^{K}σ²(C_{N,j})=2Σᵢ₌₁^{K-1}Σⱼ₌ᵢ₊₁^{K}ρ_{N,i,j}σ(C_{N,i})σ(C_{N,j}) (68)

with the endogenous correlation coefficients ρ_{N,i,j} measuring the correlational effects between project costs produced by endogenous risk factors.

On the one hand, such intra-project correlational effects would have been introduced into each project activity's endogenous cost probability distribution while carrying out the risk compounding process. Hence, the endogenous cost variance of every project, i.e. V(C_{N,j}); j=1, 2, . . . , K, should contain all the correlational effects generated by common project-specific endogenous risk factors and statistical dependencies between the activities of a project. On the other hand, one must account for inter-project program-specific endogenous correlational effects from common project management rules and practices. Hence, one may realistically assume that projects within a portfolio will share on average a common inter-project endogenous correlation coefficient, i.e. ρ_{N}=ρ_{N,i,j} (∀ [symbol] i,j).

One may surmise that a very mature and highly integrated project management culture within an organization might lead to a strong common correlation coefficient between project endogenous N-costs, while a less mature, less integrated, and/or more decentralized project management culture within an organization might lead to a weaker common correlation coefficient between project endogenous N-costs. Hence, assuming a common correlational effect ρ_{N} between the endogenous N-costs of projects within a portfolio the project portfolio variance may be written as:

σ_{C}_{_{N}}_{; K,ρ}_{_{N}}²=V(C_{N,K,ρ}_{_{N}})=Σⱼ₌₁^{K}σ²(C_{N,j})+2ρ_{N}Σᵢ₌₁^{K-1}Σⱼ₌ᵢ₊₁^{K}σ(C_{N,i})σ(C_{N,j}) (69).

When dealing with program/portfolio replicated projects one may consider that all K projects within a portfolio replicate a representative project so that under the additional assumption that all portfolio projects contain a sufficiently high number of activities (n≥15) in order to be able to invoke the Central Limit Theorem, then all endogenous project costs will comply with Normal cost probability distributions such that C_{N,j}˜N(μ_{C}_{_{N}}; σ_{C}_{_{N}}); ∀j∈K.

Hence, under the assumption of a replicated project within a project portfolio with their common N-cost expected value E(C_{N,j})=E(C_{N})=μ_{C}_{_{N}}; ∀j and common N-cost variance V(C_{N,j})=V(C_{N})=σ_{C}_{_{N}}²; ∀j, the program/portfolio will yield an expected value of:

μ_{C}_{_{N}}_{, K}=E(C_{N, K})=Σⱼ₌₁^{K}E(\tilde{C}_{N})=Kμ_{C}_{_{N}} (70).

Assuming a common portfolio project endogenous cost correlation coefficient ρ_{N}, then its standard deviation will be given by:

σ_{C}_{_{N}}_{; K,ρ}_{_{N}}=σ(C_{N,K,ρ}_{_{N}})=σ_{C}_{_{N}}ω_{N} (71)

with ω_{N}=\sqrt{K[1+ρ(K−1)]}.

The program/portfolio N-cost probability distribution will therefore be governed by a Normal probability distribution such that:

C_{N,K}˜N(μ_{C}_{_{N}}_{, K}=Kμ_{C}_{_{N}};σ_{C}_{_{N}}_{; K,ρ}_{_{N}}=σ_{C}_{_{N}}ω_{N}) (72).

The program/portfolio endogenous N-cost cost baseline will be set at:

C_{B;N;K}^{z(α)}=Kμ_{C}_{_{N}}+z(α)σ_{C}_{_{N}}ω_{N} (73)

thereby complying with the organization's z(α) risk acceptance policy defined by:

Pr(C_{N,K}≥C_{B;N,K,ρ}_{_{N}}^{z(α)})=Pr(Z_{N}≥z(α))=1−α (74).

Hence, program/portfolio endogenous costs exceeding the program/portfolio cost baseline should be covered on average by the program/portfolio N-cost contingency reserve CR_{C}_{_{N}}_{;K; ρ}_{_{N}}^{z(α)}. The program/portfolio N-cost probability distribution Expected Cost Overrun ECO_{N,K,ρ}_{_{N}}^{z(α)} may be defined by the following:

$${ECO}_{N , K , {ρ}_{N}}^{z ( α )} = {σ}_{{C}_{N}} {ω}_{N} \{ \frac{1}{\sqrt{2 π}} exp [ - \frac{{z ( α )}^{2}}{2} ] - z ( α ) {F}_{N} ( - z ( α ) ) \} . \qquad ( 75 )$$

Hence, one will define the program/portfolio project cost overrun contingency reserve CR_{C}_{_{N}}_{;K; ρ}_{_{N}}^{z(α)} by the program/portfolio N-cost probability distribution Expected Cost Overrun ECO_{N,K,ρ}_{_{N}}^{z(α)} and:

CR_{C}_{_{N}}_{;K; ρ}_{_{N}}^{z(α)}=σ_{C}_{_{N}}ω_{N}ψ(z(α))=ω_{N}ECO_{N,K=1}^{z(α)} (76).

Given that ECO_{N,K,ρ}_{_{N}}^{z(α)} is a coherent risk measure complying with the sub-additivity axiom, it follows that portfolio risk diversification will ensure that the project portfolio expected cost overrun will not exceed the sum of the individual projects' expected cost overruns when taken on their own, i.e. ECO_{N,K,ρ}_{_{N}}^{z(α)}≥Σⱼ₌₁^{K}ECO_{N,j}^{z(α)}. Risk diversification will always prevail even when project costs are perfectly correlated with one another and when project costs are subjected to first-order serial correlation.

### The Program/Portfolio Exogenous X-Cost Management Contingency Reserve

Turning our attention to the program/portfolio's K projects with their respective exogenous X-cost probability distributions, i.e. C_{X,j}˜N(μ_{C}_{_{X}}_{,j}; σ_{C}_{_{X}}_{,j}); j=1, 2, 3, . . . , K, we define C_{X,K} the random program/portfolio exogenous X-cost of a program/portfolio by the sum of its K project random exogenous X-costs (The exogenous costs are those costs that increases the activity execution costs that are generated by exogenous risk factors):

C_{X,K}=Σⱼ₌₁^{K}C_{X,j} (77)

with an expected cost and cost variance respectively equal to:

μ_{C}_{_{X}}_{; K}=E(C_{X,K})=Σⱼ₌₁^{K}E(C_{X,j})=Σⱼ₌₁^{K}μ_{C}_{_{X}}_{,j} (78)

σ_{C}_{_{X}}_{; K,ρ}_{_{X}}²=V(C_{X,K,ρ}_{_{X}})=Σⱼ₌₁^{K}σ²(C_{X,j})+2Σᵢ₌₁^{K-1}Σⱼ₌ᵢ₋₁^{K}ρ_{X,i,j}σ(C_{X,i})σ(C_{X,j)} (79).

The exogenous correlation coefficient ρ_{X,i,j} measures the cross-correlational effects produced by exogenous risk factors between project costs. On the one hand, the exogenous cost variance of every project, V(C_{X,j}); j=1, 2, . . . , K, contains within every project the interactive effects between common relevant exogenous risk factors and their statistical dependencies. Such intra-project correlational effects would have been introduced into each project activity's exogenous cost probability distribution while carrying out the risk compounding process.

On the other hand, when all projects within a portfolio are carried out within a common industry or sector of economic activity one may assume that all project exogenous risk-generated costs should be subjected to the same exogenous risk factors and therefore share a common portfolio exogenous cross-correlation coefficient such that: ρ_{X}=β_{X,i}×ρ_{X,j}=ρ_{X,i,j}; ∀ [symbol] i, j. One might expect that the common cross-correlation coefficient might be strong, moderate or weak depending on the sector of economic activity in which portfolio projects are being carried out. The competitive landscape and the volatility of an expanding economic sector might explain low cross-correlation coefficients between project costs, while a less competitive and less volatile mature economic sector might explain high cross-correlation coefficients between project costs. Obviously, there should not be any relationship between the endogenous and exogenous correlation coefficients. When dealing with program/portfolio replicated projects one simply assumes that all K projects within a portfolio replicate a representative project so that under the additional assumption that the project portfolio complies with the Central Limit Theorem, then all exogenous projects should comply with Normal cost probability distributions such that C_{X,j}˜N(μ_{C}_{_{X}}; σ_{C}_{_{X}}); ∀j∈K.

Hence, assuming a common cross-correlation coefficient ρ_{X} between portfolio projects' exogenous X-costs, the project portfolio variance will therefore be given by:

σ_{C}_{_{X}}_{; K,ρ}_{_{X}}²=V(C_{X,K,ρ}_{_{X}})=Σⱼ₌₁^{K}σ²(C_{X,j})+2ρ_{X}Σᵢ₌₁^{K-1}Σⱼ₌ᵢ₊₁^{K}σ(C_{X,i})σ(C_{X,j}) (80).

Under the assumption of a replicated-project portfolio with common X-cost expected values E(C_{X,j})=E(C_{X})=μ_{C}_{_{X}}; ∀j and common X-cost variances V(C_{X,j})=V(C_{X})=σ_{C}_{_{X}}²; ∀j, the program/portfolio will yield an expected value of:

μ_{C}_{_{X}}_{; K}=E(C_{X,K})=Σⱼ₌₁^{K}E(C_{X})=Kμ_{C}_{_{X}} (81)

while assuming a common program/portfolio exogenous cost correlation coefficient ρ_{X} its standard deviation will be given by:

σ_{C}_{_{X}}_{; K,ρ}_{_{X}}=σ(C_{X,K,ρ}_{_{X}})=σ_{C}_{_{X}}ω_{X} (82)

with ω_{X}=\sqrt{K[1+ρ_{X}(K−1)]}.

When the program/portfolio X-cost probability distribution is governed by a Normal probability distribution, one may write:

C_{X,K}˜N(μ_{C}_{_{X}}_{, K}=Kμ_{C}_{_{X}};σ_{C}_{_{X}}; σ_{C}_{_{X}}_{; K,ρ}_{_{X}}=σ_{C}_{_{X}}_{; K,ρ}_{_{X}}=σ_{C}_{_{X}}ω_{X}) (83).

The program/portfolio exogenous X-cost baseline will then be set at:

C_{B;X;K}^{z(α′)}=Kμ_{C}_{_{X}}+z(α′)σ_{C}_{_{X}}ω_{X} (84)

thereby complying with the organization's management z(α′) risk acceptance policy defined by:

Pr(C_{X,K}≥C_{B;X,ρ}_{_{X}}^{z(α′)})=Pr(Z_{N}≥z(α′))=1−α′ (85).

Similarly, under a Normal X-cost probability distribution, the program/portfolio exogenous X-cost overrun contingency reserve CR_{C}_{_{X}}_{,K, ρ}_{_{X}}^{z(α′)} will be assessed by its expected exogenous X-cost overrun defined by the following:

$${ECO}_{X , K , {ρ}_{X , s}}^{z ( {α}^{′} )} = {σ}_{{C}_{X}} {ω}_{X} \{ \frac{1}{\sqrt{2 π}} exp [ - \frac{{z ( {α}^{′} )}^{2}}{2} ] - z ( {α}^{′} ) {F}_{N} ( - z ( {α}^{′} ) ) \} . \qquad ( 86 )$$

Hence, one will define the program/portfolio management cost overrun contingency reserve as follows:

CR_{C}_{_{X}}_{; K, ρ}_{_{X}}^{z(α)}=σ_{C}_{_{X}}ω_{X}ψ(z(α′))=ω_{X}ECO_{X,K=1}^{z(α′)} (87).

Table 8, below, gives a breakdown of all the endogenous and exogenous program/portfolio project and management cost probability distributions, cost baselines, cost overrun contingency reserves, and budgets. Differences in project z(α) and management z(α′) risk acceptance policies are taken into consideration when defining their respective cost baselines, cost overrun contingency reserves, and budgets (the budget does not include the management reserve as an example only):

TABLE 8
Project, Management & Program
Cost Baselines, Cost Overrun Contingency Reserves & Budgets from Endogenous & Exogenous Normal
Cost Probability Distributions with The Expected Cost Overrun Risk Measure of a
Replicated-Project Program/Portfolio

| Program/Portfolio | | Program/Portfolio | |
|---|---|---|---|
| Size | Program/Portfolio | Cost Overrun | Program/Portfolio |
| K | Cost Baseline | Contingency Reserve | CostnBudget |
| Project | Program/Portfolio | Program/Portfolio | Program/Portfolio |
| N-Cost PDF | Project Cost Baseline | Project Cost Overrun | Project Cost Budget |
| C_{N}~N(μ_{C}_{_{N}}; σ_{C}_{_{N}}) | C_{B; N,K,ρ}_{_{N}}^{z(α)} = | Contingency Reserve | B_{C}_{_{N}}_{,K}^{z(α)} = |
| | Kμ_{C}_{_{N}} + z(α) σ_{C}_{_{N}}ω_{N} | CR_{C}_{_{N}}_{;K; ρ}_{_{N}}^{z(α)} = ω_{N} ECO_{N,K=1}^{z(α)} = | C_{B;NK,ρ}_{_{N}}^{z(α)} + CR_{C}_{_{N}}_{,K;ρ}_{_{N}}^{z(α)} |
| | | σ_{C}_{_{N}}ω_{N} ψ(z(α)) | |
| Management | Program/Portfolio | Program/Portfolio | Program/Portfolio |
| N-Cost PDF | Mngt Cost Baseline | Management Cost Overrun | Management Cost Budget |
| C_{X}~N(μ_{C}_{_{X}}; σ_{C}_{_{X}}) | C_{B; X,K,ρ}_{_{X}}^{z(α′)} = | Contingency Reserve | B_{C}_{_{X}}_{,K}^{z(α′)} = |
| | Kμ_{C}_{_{X}} + z(α′) σ_{C}_{_{X}}ω_{X} | CR_{C}_{_{X}}_{;K; ρ}_{_{X}}^{z(α′)} = ω_{X} ECO_{X,K=1}^{z(α′)} = | C_{B;XK,ρ}_{_{X}}^{z(α′)} + CR_{C}_{_{X}}_{,K; ρ}_{_{X}}z^{(α′)} |
| | | σ_{C}_{_{X}}ω_{X} ψ(z(α′)) | |
| Program/Portfolio | Program/Portfolio | Program/Portfolio | Program/Portfolio |
| Program Costs | Program Cost | Program Cost Overrun | ProgramCost Budget |
| Project Costs & | Baseline | Contingency Reserve | B_{C}_{_{NX}}_{;K} ≡ B_{C}_{_{N}}_{, K}^{z(α)} + B_{C}_{_{X}}_{, K}^{z(α′)} |
| Management | C_{B; NX;K} ≡ | CR_{C}_{_{NX}}_{;K} ≡ | B_{C}_{_{NX}}_{;K} ≡ C_{B; NX;K} + CR_{C}_{_{NX}}_{;K} |
| Costs | C_{B; N,K,ρ}_{_{N}}^{z(α)} + C_{B; X,K,ρ}_{_{X}}^{z(α′)} | CR_{C}_{_{N}}_{;K, ρ}_{_{N}}^{z(α)} + CR_{C}_{_{X}}_{;K, ρ}_{_{X}}^{z(α′)} | |

$ψ ( z ( α ) ) = \{ \frac{1}{\sqrt{2 π}} exp [ - \frac{{z ( α )}^{2}}{2} ] - z ( α ) {F}_{N} ( - z ( α ) ) \} ; {ω}_{N} = \sqrt{K [ 1 + {ρ}_{N} ( K - 1 ) ]} ; 0 \leq {ρ}_{N} \leq 1$
$ψ ( z ( {α}^{′} ) ) = \{ \frac{1}{\sqrt{2 π}} exp [ - \frac{{z ( {α}^{′} )}^{2}}{2} ] - z ( {α}^{′} ) {F}_{N} ( - z ( {α}^{′} ) ) \} ; {ω}_{X} = \sqrt{K [ 1 + {ρ}_{X} ( K - 1 ) ]} ; 0 \leq {ρ}_{X} \leq 1$

### Managerial Considerations

We have shown that for whatever management z(α′) and project z(α) cost budgeting policies there exists a unique and exact closed-form solution to their respective ECO_{X}^{z(α′)} and ECO_{N}^{z(α)} risk measures when assessed at their respective C_{B;X}^{z(α′)} and C_{B;N}^{z(α)} cost baselines. These assessments on program/portfolios were carried out as extensions of the single project setting with projects subjected to endogenous and exogenous risk factors as well as to increasing correlation coefficients between project costs along with increasing portfolio sizes. These endogenous ECO_{X}^{z(α′)} and exogenous ECO_{N}^{z(α)} risk measures proved capable of providing proper exogenous program/portfolio management cost overrun contingency reserves (CR_{C}_{_{X}}_{;K,ρ}_{_{X}}) and proper endogenous program/portfolio project cost overrun contingency reserves (CR_{C}_{_{N}}_{;K,ρ}_{ₙ}) for whatever z(α′) and z(α) cost budgeting policies decided by upper management.

All these calculations can easily be carried out provided one is supplied with the organization's z(α′) and z(α) cost budgeting policies. Hence, the fundamental decision that upper management must arrive at concerns the z(α′) and z(α) cost budgeting policies, that is the management (1−α′) and the project (1−α) significance levels that should be implemented in any program/portfolio in order to determine their respective portfolio exogenous and endogenous cost baselines (C_{B;X,K,ρ}_{_{X}}^{z(α′)}; C_{B;N,K,ρ}_{_{N}}^{z(α)}) and cost overrun contingency reserves (CR_{C}_{_{X}}_{,K,ρ}_{_{X}}^{z(α′)}; CR_{C}_{_{N}}_{,K,ρ}_{_{N}}^{z(α)}).

In short, upper management needs to determine the cost budgeting policies in compliance with the organization's strategic positioning, orientations and goals. Moreover, one must keep in mind that project success will always within project scope be predicated on the time/cost/quality triptych. Trade-offs between these three dimensions frequently become inevitable. For instance, in certain industries where price competition is cut-throat, policies might favor low z(α) cost budgeting rules in order to lower project and management budgets. Project managers would then be hard-pressed into delivering projects within or under budget. Projects requiring financial support from contingency reserves might even be considered unsuccessful projects. Project managers might then ‘cut corners round’ and deliver end-products of lesser quality. Project end-product quality could still be exacerbated if in addition to tight budgets project managers were subjected to tight schedules. Hence, trade-offs within the cost/time/quality triptych might ensue from too tight budgets and schedules with project quality being further sacrificed. On the other hand, too generous budgets may generate lax and negligent behaviors leading to resource wastage, even to cost overruns.

Hence, implementing throughout the organization a common z(α) cost budgeting policy or a differentiated (z(α′); z(α)) cost budgeting policies acquires a strategic position and must require from upper management all the proper attention and dedication. Such a (z(α); z(α)) cost budgeting policy must not be viewed as the result of a purely subjective appraisal but should be sustained by a rational decision process reflecting economic and strategic issues as well as industry constraints and practices.

Another important management issue concerns the ownership of management and project contingency reserves. This topic has occupied much attention in the standard cost percentile literature as many argued in favor of a PM ownership of project contingency reserves. When such project contingency reserves are fully funded reserves to be totally expended by project completion, then there might be good reasons for arguing in favor of its ownership by the PM. However, when project or management cost overrun contingency reserves are defined as insurance contracts subjected to conditional claims, there is no more purpose in arguing over the ownership of a funded reserve that does not exist anymore at the project level. What the PMs and the PD have in their possession are insurance policies for covering specifically pre-identified and agreed-upon endogenous and exogenous contingent events. Indeed, under the ECO risk measure the project and the management cost overrun contingency reserves must be viewed and managed as an intangible insurance coverage contract, as conditional promise-to-pay contracts to cover costs associated with specifically pre-identified and agreed-upon endogenous and exogenous contingent events. Finally, with no more funded contingency reserve at the project level and, therefore, no ownership issue, there is simply no need to plan for an optimal allocation of funded reserves among projects within a portfolio. Funded program cost overrun contingency reserves benefiting from portfolio risk diversification suffice in covering financial obligations through insurance policy contracts defined by project cost overrun contingency reserves and management c cost overrun contingency reserves.

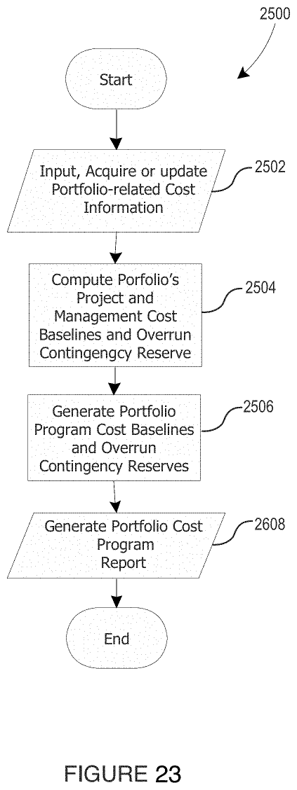

With reference to FIG. 23, and in accordance with one embodiment, another a project budgeting method for assessing execution costs of a portfolio of projects, herein referred to using the numeral 2500, will now be discussed.

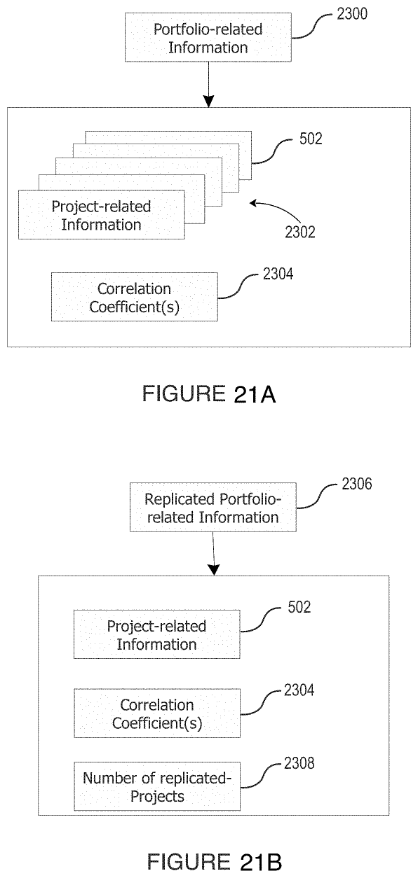

In step 2502 the portfolio-related cost information is acquired by system 100 or inputted into system 100 by a user. In some embodiments, as illustrated in FIG. 21A, the portfolio may comprise heterogeneous projects, as will be discussed below. In this case, portfolio-related information 2300 will comprise a multiplicity of project-related information 2302 (i.e. one for each project). Each project may thus be defined by its own single project-related information 502 as discussed above, for example. In addition, a set of correlation coefficient(s) 2304 may be used as well. Notably, in some embodiments, the set of correlation coefficient(s) 2304 may include distinct coefficients for endogenous or exogenous risk factors.

Again, as mentioned above, in some embodiments, a portfolio may be a replicated-project portfolio, as illustrated in FIG. 21B, and thus be defined via an input Replicated Portfolio-related Information 2306. In this case, the portfolio comprises a multiplicity of identical projects, as will be discussed below. Thus, in this case, only a single project-related information 502 is required, with the number of replicated-projects parameter 2308 contained in this replicated-portfolio.

In some embodiments, as will be discussed below, pre-computed quantities may be used. Indeed, the processes discussed below use known probability distributions of projects to derive therefrom a portfolio's endogenous or exogenous cost or time probability distribution. Thus, in some embodiments, pre-computed endogenous or exogenous probability distributions derived from method 400 may be used as input as well.

As mentioned above, computing portfolio-related outputs require the probability distributions of each project (if heterogeneous projects) or of the representative project for a replicated-project portfolio. Thus, these may have been computed at a previous time via method 400, for example. In some embodiments, these may be computed here via the multiplicity of project-related information 2302, again using method 400, for example. Thus, at the end of step 2502, the endogenous and exogenous execution cost expectation value and the variance (and standard deviation) for each project is known.

Then, in step 2504, the Portfolio's Project and Management Cost Baselines and Overrun Contingency Reserves are computed, and in step 2506, the Portfolio Program Cost Baselines and Overrun Contingency Reserves are derived, both as discussed above. Finally, in step 2508, these results are shown to the user and/or recorded.

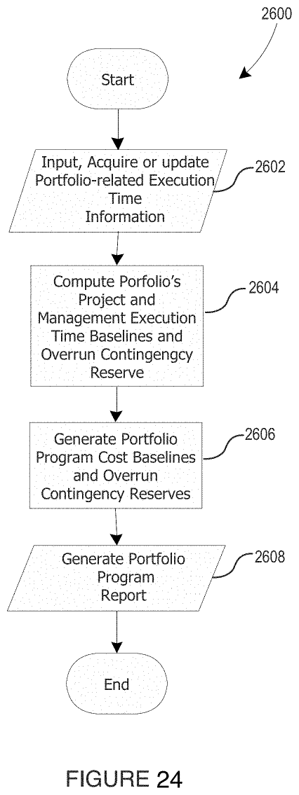

With reference to FIG. 24, and in accordance with one embodiment, another method for assessing risk in a portfolio of projects, herein referred to using the numeral 2600, will now be discussed. Method 2600 mirrors method 2500 described above in the context of execution costs, but is herein applied to assessing execution time for K risky projects, including replicated projects. This includes computing the program/portfolio Expected Execution Time Overrun (ETO_{K,ρ}^{z(α)}) risk measure. Similarly, we shall therefore be assuming that the project execution time probability distribution of every one of the K projects is known, which implies that all the probability distributions capture the potential cost impact of their relevant risk factors.

Thus, steps 2602 to 2608 generally mirror steps 2502 to 2508, but are instead directed to computing execution time related quantities. The general procedure outlined above for computing a Portfolio Program Cost baseline and overrun contingency reserves apply equally here for the execution time.

Notably, at step 2502, the same portfolio-related information 2300 or 2306 is entered, acquired or fetched, although herein the execution time related quantities are used. For example, method 1500 may be applied herein if the endogenous or exogenous time probability distributions are unknown. Or, in some embodiments, these may have been pre-computed previously (via method 1500 for example) and may be fetched.

In step 2604, the Portfolio's Project and Management Execution Time Baselines and Overrun Contingency Reserve are computed while in step 2606 the Portfolio Program Cost Baselines and Overrun Contingency Reserves are computed.

For both steps, the same reasoning discussed above with regard to execution costs similarly may be applied to execution time. Table 9 below summarizes the equations used for a general multi-project portfolio:

TABLE 9
Project, Management & Program
Time Contingency Reserves at the z(α) Time Baseline Of a Multi-Project Portfolio
Project, Management & Program
Time Baselines, Contingency Reserves & Budgets from Endogenous & Exogenous Normal Time Probability
Distributions with The Expected Time Overrun Risk Measure of a Multi-Project Program/Portfolio

| Program/ | | | |
|---|---|---|---|
| Portfolio | | | |
| Portfolio | | Program/Portfolio | |
| Size | Program/Portfolio | Time Overrun | Program/Portfolio |
| K | Time Baselines | Contingency Reserves | Time Budgets |
| Project | Program/Portfolio | Program/Portfolio | Program/Portfolio |
| (N-Time | Project Time Baseline | Project Time Overrun | Project Time Budget |
| PDF) | T_{B; N,K,ρ}_{_{N}}^{z(α)} = | Contingency Reserve | B_{T}_{_{N}}_{,K}^{z(α)} = T_{B;N,K,ρ}_{_{N}}^{z(α)} + CR_{T}_{_{N}}_{,K;ρ}_{_{N}}^{z(α)} |
| T_{N}~N(μ_{T}_{_{N}} [symbol] | ${\sum }_{j = 1}^{K} {μ}_{{T}_{N} , j} + z ( α ) {σ}_{{T}_{N} ; K , {ρ}_{N}}$ | CR_{T}_{_{N}}_{,K,ρ}_{_{N}}^{z(α)} = ETO_{N,K,ρ}_{_{N}}^{z(α)} = σ_{T}_{_{N}}_{;K,ρ}_{_{N}}ψ(z(α)) | |
| Management | Program/Portfolio | Program/Portfolio | Program/Portfolio |
| (X-Time | Mngt Time Baseline | Mngtt Time Overrun | Management Time Budget |
| PDF) | T_{B; X,K,ρ}_{_{X}}^{z(α′)} = | Contingency Reserve | B_{T}_{_{X}}_{,K}^{z(α′)} = T_{B; X,K; ρ}_{_{X}}^{z(α′)} + CR_{T}_{_{X}}_{,K; ρ}_{_{X}}^{z(α′)} |
| T_{X}~N(μ_{T}_{_{X}} [symbol] | ${\sum }_{j = 1}^{K} {μ}_{{T}_{X} , j} + z ( {α}^{′} ) {σ}_{{T}_{X} ; K , {ρ}_{X}}$ | CR_{T}_{_{X}}_{,K,ρ}_{_{X}}^{z(α′)} = ETO_{X,K,ρ}_{_{X}}^{z(α′)} = σ_{T}_{_{X}}_{;K,ρ}_{_{X}}ψ(z(α′)) | |
| Program | Program/Portfolio | Program/Portfolio | Program/Portfolio |
| Project | Program Time Baseline | Program Time Overrun | Program Time Budget |
| Times & | T_{B; N,X;K} = | Contingency Reserve | B_{T}_{_{NX}}_{;K} = T_{B; NX,K} + CR_{T}_{_{NX}}_{;K} |
| Management | T_{B; N,K,ρ}_{_{N}}^{z(α)} + T_{B; X,K,ρ}_{_{X}}^{z(α′)} | CR_{T}_{_{NX}}_{; K} = | B_{T}_{_{NX}}_{;K} = B_{T}_{_{N}}_{,K;ρ}_{_{N}}^{z(α)} + B_{T}_{_{X}}_{;K; ρ}_{_{X}}^{z(α′)} |
| Times | | CR_{T}_{_{N}}_{;K, ρ}_{_{N}}^{z(α)} + CR_{T}_{_{X}}_{;K, ρ}_{_{X}}^{z(α′)} | |

$ψ ( z ( α ) ) = \{ \frac{1}{\sqrt{2 π}} exp [ - \frac{{z ( α )}^{2}}{2} ] - z ( α ) {F}_{N} ( - z ( α ) ) \} ; ψ ( z ( {α}^{′} ) ) = \{ \frac{1}{\sqrt{2 π}} exp [ - \frac{{z ( {α}^{′} )}^{2}}{2} ] - z ( {α}^{′} ) {F}_{N} ( - z ( {α}^{′} ) ) \}$
σ_{T}_{_{N}}_{; K,ρ}_{_{Ni,j}}² = Σⱼ₌₁^{K} σ_{T}_{_{N}}_{,j}² + 2 Σᵢ₌₁^{K-1} Σⱼ₌ᵢ₊₁^{K} ρ_{N,i,j} σ_{T}_{_{N}}_{,i} σ_{T}_{_{N}}_{,j}; 0 ≤ ρ_{Ni,j} ≤ 1
σ_{T}_{_{X}}_{; K,ρ}_{_{Xi,j}}² = Σⱼ₌₁^{K} σ_{T}_{_{X}}_{,j}² + 2 Σᵢ₌₁^{K-1} Σⱼ₌ᵢ₊₁^{K} ρ_{X,i,j} σ_{T}_{_{X}}_{,i} σ_{T}_{_{X}}_{,j}; 0 ≤ ρ_{Xi,j} ≤ 1 [symbol]
indicates data missing or illegible when filed

Similarly, table 10 below summarizes the results for a replicated-project portfolio:

TABLE 10
Project, Management & Program
Time Contingency Reserves at the z(α) Time Baseline Of a Replicated-Project Portfolio
Project, Management & Program
Time Baselines, Contingency Reserves & Schedules from Endogenous & Exogenous Normal Time Probability
Distributions of a Replicated-Project Portfolio with The Expected Time Overrun Risk Measure

| Portfolio Size | Portfolio | Portfolio Time | Portfolio |
|---|---|---|---|
| K | Time Baselines | Contingency Reserves | Basic Time Schedules |
| Project | Project Portfolio | Project Portfolio | Project Portfolio |
| (N-Time PDF | Time Baseline | Time Contingency Reserve | Basic Time Schedule |
| T_{N}~N(μ_{T}_{_{N}}; σ_{T}_{_{N}}) | T_{B; N,P=K,ρ}_{_{N}}^{z(α)} = | ETO_{N;P=K; ρ}_{_{N}}^{z(α)} = | S_{N,P=K}^{z(α)} = |
| | Kμ_{T}_{_{N}} + | CR_{TN;P=K; ρ}_{_{N}}^{z(α)} = | T_{B;NP=K,ρ}_{_{N}}^{z(α)} + |
| | z(α) ω_{N}σ_{T}_{_{N}} | σ_{T}_{_{N}} ω_{N} Ψ(z(α)) | CR_{TN,P=K;ρ}_{_{N}}^{z(α)} |
| Management | Management | Management Portfolio Time | Management Portfolio |
| (X-Time PDF) | Portfolio | Contingency Reserve | Basic Time Schedule |
| T_{X}~N(μ_{T}_{_{X}}; σ_{T}_{_{X}}) | Time Baseline | ETO_{X;P=K; 0≤ρ}_{_{X}}_{≤1}^{z(α′)} = | S_{X,P=K}^{z(α′)} = |
| | T_{B; X,P=K,ρ}_{_{X}}^{z(α′)} = | CR_{TX;P=K; ρ}_{_{X}}^{z(α′)} = | T_{B; X,P=K,ρ}_{_{X}}^{z(α′)} + |
| | Kμ_{T}_{_{X}} + | σ_{TX} ω_{X} Ψ(z(α′)) | CR_{TX,P=K; ρ}_{_{X}}^{z(α′)} |
| | z(α′) ω_{X}σ_{T}_{_{X}} | | |
| Program | Program Portfolio | ProgramPortfolio | ProgramPortfolio |
| Project Times | Time Baseline | Time Contingency Reserve | Basic Time Schedule |
| & | T_{B; NX,P=K}^{z(α)} = | ETO_{NX; P=K}^{z(α)} = CR_{TNX; P=K}^{z(α)} = | S_{NX;P=K}^{z(α)} = T_{B; NX,P=K}^{z(α)} + |
| Management | T_{B; N,P=K,ρ}_{_{N}}^{z(α)} + | CR_{TN;P=K, ρ}_{_{N}}^{z(α)} + | CR_{NTX,P=} [symbol] ^{z(α′)} |
| Times | T_{B; X,P=K,ρ}_{_{X}}^{z(α)} | CRT_{CX;P=K, ρ}_{_{X}}^{z(α)} = | S_{NX;P=K}^{z(α)} = S_{N,P=K;ρ}_{_{N}}^{z(α)} + |
| | | σ_{T}_{_{N}} ω_{N}Ψ(z(α)) + | S_{X;P=K; ρ}_{_{X}}^{z(α′)} |
| | | σ_{T}_{_{X}} ω_{X}Ψ(z(α′)) | |

$Ψ ( z ( α ) ) = \{ \frac{1}{\sqrt{2 π}} exp [ - \frac{{z ( α )}^{2}}{2} ] - z ( α ) {F}_{N} ( - z ( α ) ) \} ; Ψ ( z ( α ) ) = \{ \frac{1}{\sqrt{2 π}} exp [ - \frac{{z ( α )}^{2}}{2} ] - z ( α ) {F}_{N} ( - z ( α ) ) \}$
${ω}_{N} = \sqrt{K [ 1 + {ρ}_{N} ( K - 1 ) ]} ; {ω}_{X} = \sqrt{K [ 1 + {ρ}_{X} ( K - 1 ) ]} ; 0 \leq {ρ}_{N} \leq 1 ; 0 \leq {ρ}_{X} \leq 1$ [symbol]
indicates data missing or illegible when filed

Finally, in step 2608, these results are shown to the user and/or recorded.

### Other Types of Probability Distributions

In some embodiments, as mentioned above, different types of probability distributions may be considered when assessing risk. Above, the PERT-Beta probability distribution was used and then generalized to a Normal probability distribution by risk compounding engine 104 and ECO/ETO Risk Measure Engine 108. The skilled technician will first understand that other types of probability distributions may also be used and, in some cases, further approximated to a Normal Probability distribution. For example, these may include, without limitation:
1) The Triangular probability distribution.
2) The Log-Normal probability distribution.

Thus, for example, in method 400 (or method 1500), steps 404 and 406 (steps 1504 and 1506) may be slightly modified so that the risk compounding process uses a different probability distribution than the PERT-Beta probability distribution.

In some embodiments, the probability distribution to be used by system 100 may be inputted or selected by the user (for example as part of the single project-related information 502 or portfolio-related information 2300 or 2306). In some cases, a multiplicity of probability distributions may be selected, so that the user may view simultaneously the corresponding outputs and compare them. In some embodiments, system 100 may suggest to the user a recommended probability distribution to use based, at least in part, on the single project-related information 502 provided by the user. In some embodiments, system 100 may provide a recommended probability distribution based on data from prior assessments compared to actual cost or time values that resulted from that project or portfolio.

In some embodiments, a uniform probability distribution may be used by risk compounding engine 104 and ECO/ETO Risk Measure Engine 106. The Uniform probability distribution serves in describing activity costs or time durations for which “experiential” information indicates that: all cost events are known to be equally likely to occur between a Minimum value (i.e. values 610 or 618) and a Maximum value (i.e. values 608 or 616), so that there is “most likely” cost or execution time (i.e. values 606 or 614); and that the cost (time) probabilities are symmetrically distributed around the mid-point mean cost (time). Thus, in these cases, the set of input values 604 or 612 will have only two values and the uniform probability distribution will be defined using these. This corresponds to highly uncertain activity costs or execution times.

In other words, the Uniform probability distribution may be used to carry on sensitivity analyses with respect to a Normal probability distribution from: a “best case” scenario with a low time variance, and a “worst case” scenario with a high time variance.

### The Project Expected Cost Overrun Under a Uniform Probability Distribution

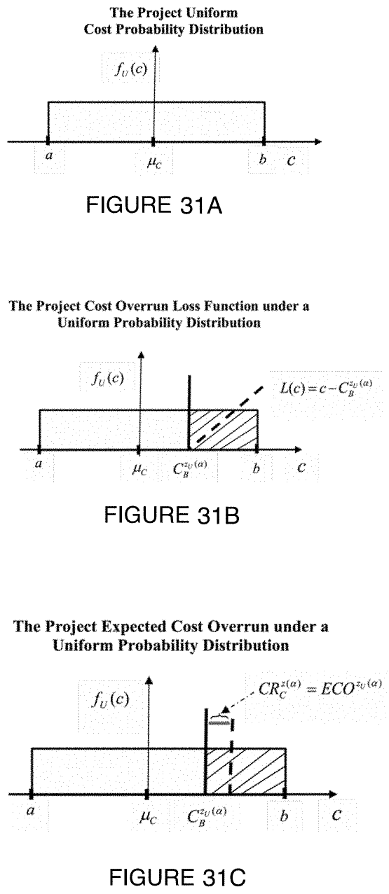

Let us consider a risky capital investment project whose random cost C is governed by a continuous Uniform probability distribution ƒ_{U}(c) as shown in FIG. 31A.

Thus, one may write: C˜U(a, b), wherein a is the compounded or expected minimum cost or execution time while b is the compounded or expected maximum cost or execution time. Its probability density function (PDF) is thus given by:

$$\{ \begin{matrix}{f}_{U} ( c ) = \frac{1}{( b - a )} & for a \leq c \leq b \\ {f}_{U} ( c ) = 0 & elsewhere\end{matrix} .$$

Its expected value is given by

E(C)=μ_{C}=(a+b)/2a

and its standard deviation is given by:

σ(C)=σ_{C}=(b−a)/\sqrt{12}.

The cumulative probability distribution (CPD) will be given by:

$$\{ \begin{matrix}{F}_{U} ( c ) = 0 & for c < a \\ {F}_{U} ( c ) = \frac{( c - a )}{( b - a )} & for a \leq c \leq b \\ {F}_{U} ( c ) = 1 & for c > b\end{matrix} .$$

and from the inverse function of the CPD one will be able to determine the cost percentile p_{α}:

F⁻¹(p)=a+p(b−a) for 0≤p≤1.

When written in terms of the mean and the standard deviation one obtains probability density function:

$$\{ \begin{matrix}{f}_{U} ( c ) = \frac{1}{2 {σ}_{C} \sqrt{3}} for & - {σ}_{C} \sqrt{3} \leq c - {μ}_{C} \leq {σ}_{C} \sqrt{3} \\ {f}_{U} ( c ) = 0 & elsewhere\end{matrix}$$

while the cumulative probability distribution (CDF) reads as follows:

$$\{ \begin{matrix}{F}_{U} ( c ) = 0 & for & \frac{c - {μ}_{C}}{{σ}_{C}} < - \sqrt{3} \\ {F}_{U} ( c ) = \frac{1}{2} ( \frac{c - {μ}_{C}}{{σ}_{C} \sqrt{3}} + 1 ) & ( \frac{c - {μ}_{C}}{{σ}_{C} \sqrt{3}} + \frac{1}{2} ) for & - \sqrt{3} \leq \frac{c - {μ}_{C}}{{σ}_{C}} + \sqrt{3} \\ {F}_{U} ( c ) = 1 & for & \frac{c - {μ}_{C}}{{σ}_{C} \sqrt{3}} >= \sqrt{3}\end{matrix}$$

and the inverse function of the CPD will be giving the cost percentile pa:

F⁻¹(p_{α})=μ_{C}+σ_{C}\sqrt{3}(2p_{α}−1) for 0≤p≤1.

One may write:

$$\{ \begin{matrix}a = {μ}_{C} - \sqrt{3} {σ}_{C} \\ b = {μ}_{C} + \sqrt{3} {σ}_{C} .\end{matrix}$$

The project cost baseline should be set at C_{B}^{z(α)}=μ_{C}+z_{U}(α)σ_{C} in compliance with the organization's z(α) risk acceptance policy when cost risk is under a continuous uniform probability distribution. The magnitude of the project cost overrun or loss function L(c) with respect to a project cost baseline shall be defined by the following conditional loss function:

$$\{ \begin{matrix}L ( c ) = c - {C}_{B}^{{z}_{U} ( α )} & if & c > {C}_{B}^{{z}_{U} ( α )} \\ L ( c ) = 0 & if & c \leq {C}_{B}^{{z}_{U} ( α )} .\end{matrix}$$

A situation that should worry a PM occurs when the project cost actually exceeds the project cost baseline C_{B}^{z}^{_{U}}^{(α)}. Such a cost baseline therefore becomes at the (1−α) level of significance the project cost overrun threshold value. Hence, we explicitly define the project Expected Cost Overrun (ECO^{z}^{_{U}}^{(α)}) at the (1−α) significance level under a Uniform probability density function ƒ_{U}(c) by the following definite integral:

ECO^{z}^{_{U}}^{(α)}=∫_{C}_{_{B}}_{^{z(α)}}^{b}L(c)·ƒ_{U}(c)dc

i.e.: ECO^{z}^{_{U}}^{(α)}=∫_{C}_{_{B}}_{^{z(α)}}^{b}(c−C_{B}^{z}^{_{U}}^{(α)})ƒ_{U}(c)dc.

Hence, the project ECO_{U}^{z(α)} will always be tail sensitive and yield a non-negative value. By superimposing the conditional cost overrun loss function L(c) over the Normal cost pdf ƒ_{N}(c) one obtains FIG. 31B.

We define the Expected Cost Overrun (ECO) by the following definite integral:

ECO^{z}^{_{U}}^{(α)}=∫_{C}_{_{B}}^{b}L(c)·ƒ_{U}(c)dc=∫_{C}_{_{B}}^{b}(c−C_{B})ƒ_{U}(c)dc

so that one obtains

$${ECO}^{{z}_{U} ( α )} = \frac{{( b - {C}_{B}^{{z}_{U} ( α )} )}^{2}}{2 ( b - a )} .$$

Setting the project cost overrun contingency reserve equal to the project Expected Cost Overrun implies that the cost overrun contingency reserve CR_{c} will be added to the project cost baseline C_{B} and therefore covering on average costs exceeding the cost baseline (as shown in FIG. 31C):

CR_{C}^{z(α)}=ECO^{z}^{_{U}}^{(α)}

### The Project Expected Time Overrun Under a Uniform Probability Distribution

Let us consider a risky capital investment project whose random time or duration T is governed by a continuous Uniform probability distribution ƒ_{U} (t) as shown in FIG. 32A.

Hence, as was discussed above, one may write: T˜U(a, b) and its probability density function (PDF) is given by:

$$\{ \begin{matrix}{f}_{U} ( t ) = \frac{1}{( b - a )} for & a \leq t \leq b \\ {f}_{U} ( t ) = 0 & elsewhere .\end{matrix}$$

Its expected value is given by E(T)=μ_{C}=(a+b)/land its standard deviation is given by σ(T)=σ_{T}=(b−a)/\sqrt{12}. From the inverse function of the CPD one will be able to determine the cost percentile p_{α}:

F⁻¹(p_{α})=a+p_{α}(b−a) for 0≤p_{α}≤1.

The project time baseline should be set at T_{B}^{z}^{_{U}}^{(α)}=μ_{T}+z_{U}(α)σ_{T} in compliance with the organization's z_{U}(α) risk acceptance policy when time complies with a continuous uniform probability distribution. The magnitude of the project time overrun or loss function L(t) with respect to a project time baseline shall be defined by the following conditional loss function:

$$\{ \begin{matrix}L ( t ) = t - {T}_{B}^{{z}_{U} ( α )} & if & t > {T}_{B}^{{z}_{U} ( α )} \\ L ( t ) = 0 & if & t \leq {T}_{B}^{{z}_{U} ( α )}\end{matrix}$$

A situation that should worry a PM occurs when the project duration actually exceeds the project time baseline T_{B}^{z}^{_{U}}^{(α)}. Such a time baseline therefore becomes at the (1−α) level of significance the project time overrun threshold value. Hence, we explicitly define the project Expected Time Overrun (ETO^{z}^{_{U}}^{(α)}) at the (1−α) significance level under a Uniform probability density function ƒ_{U}(t) by the following definite integral:

ETO^{z}^{_{U}}^{(α)}=∫_{T}_{_{B}}_{^{z(α)}}^{b}(t−T_{B}^{z}^{_{U}}^{(α)})ƒ_{U}(t)dt.

Hence, the project ETO^{z}^{_{U}}^{(α)} will always be tail sensitive and yield a non-negative value. By superimposing the conditional time overrun loss function L(t) over the Uniform time pdf ƒ_{U}(t) one obtains FIG. 32B.

We define the Expected Time Overrun (ETO) by the following definite integral:

ETO^{z}^{_{U}}^{(α)}=∫_{T}_{_{B}}^{b}L(t)·ƒ_{U}(t)dt=∫_{T}_{_{B}}^{b}(t−T_{B}^{z}^{_{U}}^{(α)})ƒ_{U}(t)dt;

substituting one obtains:

$${ETO}^{{z}_{U} ( α )} = \frac{{( b - {T}_{B}^{{z}_{U} ( α )} )}^{2}}{2 ( b - a )} .$$

Setting the project time overrun contingency reserve equal to the project Expected Time Overrun implies that the time overrun contingency reserve CR_{T} will be added to the project time baseline T_{B} and therefore covering on average time durations exceeding the time baseline (as illustrated in FIG. 32C):

CR_{T}^{z}^{_{U}}^{(α)}=ETO^{z}^{_{U}}^{(α)}

### The Project Expected Time Overrun Penalty

Let us now assume that the project is subjected to a time overrun penalty that is proportional to the project time overrun with respect to the contractor's project time baseline T_{B}^{z(α)}. Hence its conditional loss function becomes:

$$\{ \begin{matrix}{L}_{P} ( t ) = γ ( t - {T}_{B}^{{z}_{U} ( α )} ) & if & t > {T}_{B}^{{z}_{U} ( α )} ; \\ {L}_{P} ( t ) = 0 & if & t \leq {T}_{B}^{{z}_{U} ( α )} .\end{matrix}$$

Superimposing the project time overrun penalty function over the project time probability distribution yields FIG. 32D.

We define the project Expected Time Overrun Penalty (ETOP) at the (1−α) significance level, by the following definite integral:

ETOP^{z}^{_{U}}^{(α)}=∫_{T}_{_{B}}_{^{z(α)}}^{b}γL(t)·ƒ_{U}(t)dt

ETOP^{z}^{_{U}}^{(α)}=∫_{T}_{_{B}}_{^{z(α)}}^{+∞}γ(t−T_{B}^{z}^{_{U}}^{(α)}ƒ_{U}(t)dt

with the scalar γ≥0 defining the penalty per unit time overrun.

Hence:

ETOP^{z}^{_{U}}^{(α)}=γ∫_{T}_{_{B}}_{^{z(α)}}^{b}(t−T_{B}^{z}^{_{U}}^{(α)})ƒ_{U}(t)dt

and: ETOP^{z}^{_{U}}^{(α)}=γETO^{z}^{_{U}}^{(α)}.

Table 11 below summarizes the use of a uniform probability distribution as discussed above:

TABLE 11
The Project Cost Contingency Reserve & Budget
Under a Uniform Cost Probability Distribution
For Various z(α) Cost Budgeting Policies with
The Expected Cost Overrun Risk Measure

| Project Cost | | | | |
|---|---|---|---|---|
| Overrun | | | Project Cost | |
| Probability: | | Project Cost | Overrun | Project Cost |
| Significance | Project Cost | Baseline | Contingency | Budget |
| level | Budgeting | C_{B}^{z}^{_{U}}^{(α)} = | Reserve | B_{C}^{z}^{_{U}}^{(α)} = |
| Pr(C ≥ C_{B}^{z}^{_{U}}^{(α)}) = | Policy | μ_{C} + | CR_{C}^{z}^{_{U}}^{(α)} = | C_{B}^{z}^{_{U}}^{(α)} + |
| 1 − α | z_{U}(α) | z_{U}(α)σ_{C} | ECO^{z}^{_{U}}^{(α)} | CR_{C}^{z}^{_{U}}^{(α)} |
| 0.50 | 0.0000 | 15.0 | 1.25 | 16.25 |
| 0.40 | 0.3464 | 16.0 | 0.80 | 16.80 |
| 0.30 | 0.6928 | 17.0 | 0.45 | 17.45 |
| 0.20 | 1.0390 | 18.0 | 0.20 | 18.20 |
| 0.15 | 1.2100 | 18.5 | 0.1125 | 18.6125 |
| 0.10 | 1.3800 | 19.0 | 0.0500 | 19.0500 |
| 0.05 | 1.5500 | 19.5 | 0.0125 | 19.5125 |
| 0.0228 | 1.6500 | 19.77 | 0.0026 | 19.7746 |
| 0.01 | 1.6970 | 19.90 | 0.0005 | |

PROJECT COST PDF C~U(a = 10; b = 20); μ_{C} = 15; σ_{C} = 2.8867
${ECO}^{{z}_{U} ( α )} = \frac{{( b - {C}_{B}^{{z}_{U} ( α )} )}^{2}}{2 ( b - a )}$
a = μ_{C} − \sqrt{3}σ_{C}; b = μ_{C} + \sqrt{3}σ_{C}; z_{U}(α) = \sqrt{3}(2p_{α} − 1); 0 ≤ p_{α} ≤ 1;
C_{B}^{z}^{_{U}}^{(α)} = μ_{C} + z_{U}(α)σ_{C}; C_{B}^{z(α)} = F_{U}⁻¹(p_{α}) = a + p_{α}(b − a); 0 ≤ p_{α} ≤ 1;
C_{B}^{z(α)} = F⁻¹(p_{α}) = μ_{T} + σ_{T}\sqrt{3}(2p_{α} − 1)

### Examples

Below are examples of the methods discussed above, as according to one embodiment of system 100 implemented in the BUDGET PRO software application. Notably, these use the PERT-Beta probability distribution to assess the risks on the execution cost and execution time as an example only. As mentioned above, other probability distributions may be used as well. In this first example, method 400 will be applied to a fictitious project. In this first example, a fictitious company, herein referred to as Domotek Construction Inc., has decided to launch an exemplary residential development program, named The Manor. The Board of Directors has decided that its new single-family model home would be named the Rosedale. There would be three variants of the Rosedale model, but the construction costs of each variant would essentially be the same. Phase I of the development program would comprise 9 units of the Rosedale model.

As discussed above, in step 402 of method 400, the project-related information is entered by a user. These are discussed below.

### Construction Activities & Construction Costs of the Single-Family Rosedale Home

The cost engineer (CE) has identified the following exemplary construction activities of project Rosedale:

a₁: Excavation works
a₂: Concrete & steel foundations
a₃: Structure & roof
a₄: Electrical & plumbing
a₅: Stone sidings & tile roofing

### a₆: Landscaping.

To these activities the CE has assessed their most likely costs, i.e. their cost mode:

TABLE 12
Most Likely Execution Costs of Activities Project Rosedale

| | | | | | Stone | |
|---|---|---|---|---|---|---|
| | | | Structure | Electrical & | Sidings & | Landscaping |
| Project | Excavation | Foundations | & Roof | Plumbing | Roofing | Tile |
| Activities | a₁ | a₂ | a₃ | a₄ | a₅ | a₆ |
| Most | c(a_{1 mod}) | c(a_{2 mod}) | c(a_{3 mod}) | c(a_{4 mod}) | c(a₅ _{mod}) | c(a_{6 mod}) |
| Likely | $8,000 | $20,000 | $120,000 | $80,000 | $95,000 | $45,000 |
| Cost of | | | | | | |
| Project | | | | | | |
| Activities | | | | | | |

The base cost for each housing unit is therefore assessed at $368,000. However, such a cost estimate does not account for endogenous & exogenous risk factors that might increase the construction cost of each housing unit.

Among the most important risk factors that might impact the cost of project activities in the course of their execution the CE has identified the following endogenous & exogenous risk factor along with their probability of occurrence:

Endogenous/Contingent Risk Factors & their Probability of Occurrence:

F_{NC; 1}: Mismanagement of human resources: p_{NC;1}=0.15

F_{NC; 2}: Purchase & supply mismanagement: p_{NC;}2=0.20

F_{NC; 3}: Errors in project design: P_{NC;3}=0.30

Exogenous/contingent Risk Factors & their Probability of Occurrence:

F_{XC;1}: Exchange rate deterioration: P_{XC;1}=0.25

F_{XC;2}: Labor strike in construction industry: p_{XC;2}=0.20

F_{XC;3}: Supply issues from bankrupted supplier: p_{XC;3}=0.10

F^{XC;4}: New government environmental regulations: P_{XC;4}=0.30

### Assessing the Cost Impacts on Project Activities of Endogenous/Contingents & Exogenous/Contingent Risk Factors

The cost engineer (CE) must start the risk assessment process by assessing from the projects work breakdown structure (WBS) the percentagewise cost impacts of each endogenous/contingent and exogenous/contingent risk factor on each activity's most likely cost estimate or base cost estimate:

TABLE 13
Project Activity Risk Breakdown and Impact Assessment Matrix
of Endogenous & Exogenous Contingent Risk Factors and their Most
Likely Expected Cost Impact on Project Activities Project Rosedale

| | | | | | Stone | |
|---|---|---|---|---|---|---|
| | | | | | Sidings | |
| | | | Structure | Electrical & | & Tile | |
| Project | Excavation | Foundations | & Roof | Plumbing | Roofing | Landscaping |
| Activities | a₁ | a₂ | a₃ | a₄ | a₅ | a₆ |
| Most | c(a_{1 mod}) | c(a_{2 mod}) | c(a_{3 mod}) | c(a_{4 mod}) | c(a₅ _{mod}) | c(a_{6 mod}) |
| Likely | $8,000 | $20,000 | $120,000 | $80,000 | $95,000 | $45,000 |
| Cost of | | | | | | |
| Project | | | | | | |
| Activities | | | | | | |
| Endogenous/ | Project Endogenous/Contingent Risk Factors and their | | | | | |
| Contingent | Percentagewise Most Likely Cost Impacts on | | | | | |
| Risk | Project Activities | | | | | |
| Factors | | | | | | |
| F_{NC;1} | | | f_{NC, 3, 1} = | f_{NC, 4, 1} = | | |
| P_{NC;1} = | | | +15% | +10% | | |
| 0.15 | | | | | | |
| F_{NC;2} | | | f_{NC, 3, 2} = | f_{NC, 4, 2} = | f_{NC, 4, 2} = | |
| P_{NC;2} = | | | +10% | +5% | +20% | |
| 0.20 | | | | | | |
| F_{NC;3} | | f_{NC, 2, 3} | f_{NC, 3, 3} | f_{NC, 4, 3} | | |
| P_{NC;3} = | | = +30% | = +15% | = +5% | | |
| 0.30 | | | | | | |
| Exogenous/ | Project Exogenous/Contingent Risk Factors and their | | | | | |
| Contingent | Percentagewise Most Likely Cost Impacts on | | | | | |
| Risk | Project Activities | | | | | |
| Factors | | | | | | |
| F_{XC;1} | | f_{XC, 3, 1} = | | | f_{XC, 5, 1} = | |
| P_{XC;1} = | | +10% | | | +15% | |
| 0.25 | | | | | | |
| F_{XC;2} | | f_{XC, 3, 2} = | | | f_{XC, 5, 2} = | |
| P_{XC;2} = | | +20% | | | +10% | |
| 0.20 | | | | | | |
| F_{CX;3} | | | | | f_{XC, 5, 3} = | |
| P_{XC;3} = | | | | | +10% | |
| 0.10 | | | | | | |
| F_{XC;4} | f_{XC, 1, 4} = | | | | | f_{XC, 6, 4} = |
| P_{XC;4} = | +15% | | | | | +25% |
| 0.30 | | | | | | |

From these assessed values by the CE, the BUDGET PRO software will assess (via step 902 of step 404) the Most Likely Expected Cost Increase as indicated in Table 14 & Table 15 with Table 14 pertaining to endogenous/contingent risk factor cost impacts, and Table 15 pertaining to exogenous/contingent risk factor cost impacts.

TABLE 14
Project Activity Risk Breakdown and Impact Assessment Matrix of Endogenous/Contingent
Risk Factors and their Most Likely Expected Cost Impact on Project Activities
Project Rosedale

| Project | Excavation | Foundations | Structure | Electrical | Stone Sidings | Landscaping |
|---|---|---|---|---|---|---|
| Activities | a₁ | a₂ | & Roof | & | & Tile | a₆ |
| | | | a₃ | Plumbing | Roofing | |
| | | | | a₄ | a₅ | |
| Most | c(a_{1 mod}) | c(a_{2 mod}) | c(a_{3 mod}) | c(a_{4 mod}) | c(a_{5 mod}) | c(a_{6 mod}) |
| Likely Cost | $8,000 | $20,000 | $120,000 | $80,000 | $95,000 | $45,000 |
| of Project | | | | | | |
| Activities | | | | | | |
| Endogenous/ | Project Endogenous/Contingent Risk Factors and their | | | | | |
| Contingent | Percentagewise Most Likely Expected Cost Impact on | | | | | |
| Risk | Project Activities | | | | | |
| Factors | | | | | | |
| F_{NC;1} | | | f_{NC;3, 1}^{E} = | f_{NC;4, 1}^{E} = | | |
| p_{NC;1} = | | | 0.0225 = | 0.015 = | | |
| 0.15 | | | 0.15 × | 0.10 × | | |
| | | | 0.15 | 0.15 | | |
| F_{NC;2} | | | f_{NC;3, 2}^{E} = | f_{NC;4, 2}^{E} = | f_{NC;5, 2}^{E} = | |
| p_{NC;2} = | | | 0.02 = | 0.01 = | 0.04 | |
| 0.20 | | | 0.10 × | 0.05 × | 0.20 × | |
| | | | 0.20 | 0.20 | 0.20 | |
| F_{NC;3} | | f_{NC;2, 3}^{E} = | f_{NC;3, 3}^{E} = | f_{NC;4, 3}^{E} = | | |
| p_{NC;3} = | | 0.09 = | 0.045 = | 0.015 = | | |
| 0.30 | | 0.30 × | 0.15 × | 0.05 × | | |
| | | 0.30 | 0.30 | 0.30 | | |
| Activities' | f_{NC;1}^{E} = = | f_{NC;2}^{E} = = | f_{NC;3}^{E} = = | f_{NC;4}^{E} = = | f_{NC;5}^{E} = = | f_{NC;6}^{E} = = |
| Percentage- wise Most Likely Expected Cost Increase by Endogenous/ Contingent | $\begin{matrix}{\sum }_{r = 1}^{{R}_{NC , 1}} {f}_{NC ; 1 , r}^{E} == \\ 0.\end{matrix}$ | $\begin{matrix}{\sum }_{r = 1}^{{R}_{NC , 2}} {f}_{NC ; 2 , r}^{E} \\ 0.09 == \\ 0.09\end{matrix}$ | $\begin{matrix}{\sum }_{r = 1}^{{R}_{NC , 3}} {f}_{NC ; 3 , r}^{E} \\ 0.0225 + \\ 0.02 + \\ 0.045 == \\ 0.0875\end{matrix}$ | $\begin{matrix}{\sum }_{r = 1}^{{R}_{NC , 4}} {f}_{NC ; 4 , r}^{E} \\ 0.015 + \\ 0.01 + \\ 0.015 == \\ 0.04\end{matrix}$ | $\begin{matrix}{\sum }_{r = 1}^{{R}_{NC , 5}} {f}_{NC ; 5 , r}^{E} \\ 0.04 == \\ 0.04\end{matrix}$ | $\begin{matrix}{\sum }_{r = 1}^{{R}_{NC , 6}} {f}_{NC ; 6 , r}^{E} \\ 0. == \\ 0.\end{matrix}$ |
| Risk | | | | | | |
| Factors | | | | | | |
| Activities' | E[c_{NC}(a₁)] = | E[c_{NC}(a₂)] = | E[c_{NC}(a₃)] = | E[c_{NC}(a₄)] = | E[c_{NC}(a₅)] = | E[c_{NC}(a₆)] = |
| Expected | c(a₁) × | c(a₁) × | c(a₃) × | c(a₄) × | c(a₅) × | c(a₆) × |
| Cost | f_{NC;1}^{E} = | f_{NC;1}^{E} = | f_{NC;3}^{E} = | f_{NC;4}^{E} = | f_{NC;5}^{E} = | f_{NC;6}^{E} = |
| Increase by | $8,000 × | $20,000 × | $120,000 × | $80,000 × | $95,000 × | $45,000 × |
| Endogenous/ | 0.0 = = $0 | 0.09 = = | 0.0875 = = | 0.04 = = | 0.04 = = | 0.0 = = $0 |
| Contingent | | $1,800 | $10,500 | $3,200 | $3,800 | |
| Risk | | | | | | |
| Factors | | | | | | |

As discussed above, endogenous risk factor cost impacts must be assessed percentagewise with respect to the project activity base costs or most likely cost estimates. The total cost impact of endogenous risk factors may be obtained (step 952) by the addition of all individual risk factors' percentagewise endogenous cost impacts on a project activity. Hence, the N-cost probability distribution will contain all endogenous risk factor cost impacts in addition to the project activities' execution costs.

TABLE 15
Project Activity Risk Breakdown and Impact Assessment Matrix of Exogenous Contingent
Risk Factors and their Most Likely Expected Cost Impact on Project Activities
Project Rosedale

| Project | Excavation | Foundations | Structure | Electrical | Stone Sidings | Landscaping |
|---|---|---|---|---|---|---|
| Activities | a₁ | a₂ | & Roof | & | & Tile | a₆ |
| | | | a₃ | Plumbing | Roofing | |
| | | | | a₄ | a₅ | |
| Most Likely | c(a_{1 mod}) | c(a_{2 mod}) | c(a_{3 mod}) | c(a_{4 mod}) | c(a_{5 mod}) | c(a_{6 mod}) |
| Cost of | $8,000 | $20,000 | $120,000 | $80,000 | $95,000 | $45,000 |
| Project | | | | | | |
| Activities | | | | | | |
| Exogenous/ | Project Exogenous/Contingent Risk Factors and their | | | | | |
| Contingent | Percentagewise Most Likely Expected Cost Impact on | | | | | |
| Risk Factors | Project Activities | | | | | |
| F_{XC;1} | | | f_{XC;3, 1}^{E} = | | f_{XC;5, 1}^{E} = | |
| p_{XC;1} = 0.25 | | | 0.025 = | | 0.03750.15 × | |
| | | | (0.10) × | | 0.25 | |
| | | | 0.25 | | | |
| F_{XC;2} | | | f_{XC;3, 2}^{E} = | | f_{XC,5, 1}^{E} = | |
| p_{XC;2} = 0.20 | | | 0.04 = | | 0.02 = | |
| | | | (0.20) × | | 0.10 × | |
| | | | 0.20 | | 0.20 | |
| F_{XC;3} | | | | | f_{XC;5,3}^{E} = | |
| p_{XC;3} = 0.10 | | | | | 0.01 = | |
| | | | | | 0.10 × | |
| | | | | | 0.10 | |
| F_{XC;4} | f_{XC;1, 4}^{E} = | | | | | f_{XC;6, 4}^{E} = |
| p_{XC;4} = 0.30 | 0.045 = | | | | | 0.075 = |
| | 0.15 × | | | | | 0.25 × |
| | 0.30 | | | | | 0.30 |
| Activities' | f_{XC;1}^{E} = = | f_{XC;2}^{E} = = | f_{XC;3}^{E} = = | f_{XC;4}^{E} = = | f_{XC;5}^{E} = = | f_{XC;6}^{E} = = |
| Percentage- wise Most Likely Expected Cost Increase by Exogenous/ Contingent | $\begin{matrix}{\sum }_{r = 1}^{{R}_{XC , 1}} {f}_{XC ; 1 , r}^{E} = \\ 0.045 = \\ 0.045\end{matrix}$ | $\begin{matrix}{\sum }_{r = 1}^{{R}_{XC , 2}} {f}_{XC ; 2 , r}^{E} = \\ 0. = \\ 0.\end{matrix}$ | $\begin{matrix}{\sum }_{r = 1}^{{R}_{XC , 3}} {f}_{XC ; 3 , r}^{E} = \\ 0.025 + \\ 0.04 = \\ 0.065\end{matrix}$ | $\begin{matrix}{\sum }_{r = 1}^{{R}_{XC , 4}} {f}_{XC ; 4 , r}^{E} = \\ 0. = \\ 0.\end{matrix}$ | $\begin{matrix}{\sum }_{r = 1}^{{R}_{XC , 5}} {f}_{XC ; 5 , r}^{E} = \\ 0.0375 + \\ 0.04 + \\ 0.01 = \\ 0.0675\end{matrix}$ | $\begin{matrix}{\sum }_{r = 1}^{{R}_{XC , 6}} {f}_{XC ; 6 , r}^{E} = \\ 0.075 == \\ 0.075\end{matrix}$ |
| Risk Factors | | | | | | |
| Activities' | E[c_{XC}(a₁)] = | E[c_{XC}(a₂)] = | E[c_{XC}(a₃)] = | E[c_{XC}(a₄)] = | E[c_{XC}(a₅)] = | E[c_{XC}(a₆)] = |
| Expected | c(a₁) × | c(a₁) × | c(a₃) × | c(a₄) × | c(a₅) × | c(a₆) × |
| Cost Increase | f_{XC,1}^{E} = | f_{XC,1}^{E} = | f_{XC,3}^{E} = | f_{XC,4}^{E} = | f_{XC,5}^{E} = | f_{XC,6}^{E} = |
| by | $8,000 × | $20,000 × | $120,000 × | $80,000 × | $95,000 × | $45,000 × |
| Exogenous/ | 0.045 = = | 0.0 = = $0 | (0.065) = = | 0.0 = = $0 | 0.0675 = = | 0.075 = = |
| Contingent | $360 | | $7,800 | | $6,412.5 | $3,375 |
| Risk Factors | | | | | | |

The results of steps 902 and 952 are provided by the row above the last row of Table 10 & Table 11 will respectively serve in assessing endogenous N-cost and exogenous X-cost probability distributions. Concerning the results provided by the last row of Table 10 & Table 11 these will help the CE in identifying activities potentially subjected to relatively severe cost impacts from identifiable risk factors and, consequently, in devising appropriate active risk response strategies. Hence, the costs of activities 3, 4, & 5 are susceptible of being impacted by identifiable endogenous risk factors, while the costs of activities 3, 5 & 6 are susceptible of being impacted by identifiable exogenous risk factors.

From the last row of Table 9 & Table 10 one may conclude that endogenous risk factor cost impacts could increase the construction costs of a house by E(c_{NC})=Σᵢ₌₁⁶E[c_{NC}(aᵢ)]=$19,300, while exogenous risk factor cost impacts could increase the construction costs of a house by E(c_{XC})=Σᵢ₌₁⁶E[c_{XC}(aᵢ)]=$17,947.5 for a total construction expected cost increase of E(c_{NC})+E(c_{XC})=$37,247.5. Active risk response strategies should therefore identify those activities most at risk as well as the risk factors involved and devise specific risk response strategies to mitigate the probability of occurrence and/or the severity of the cost impact of those endogenous and exogenous risk factors.

### Assessing the Activities' PERT-Beta Cost Probability Distributions Subjected to Endogenous Risk Factors:

### The Endogenous N-Cost Normal Probability Distribution

The cost probability distribution of all 6 activities will be assessed by the CE through, as an example only, the PERT-Beta probability distribution assessment process. However, prior to carrying out such an assessment process and as discussed above, the CE will need to assess and enter into system 100 the cost estimation “errors” or cost variances by assessing over and under the most likely (realistic) cost of each activity 606, its maximum (pessimistic) 608 and its minimum (optimistic) 610 cost (i.e. input values 604). These estimates we shall refer to as the basic activity costs of the project and shall define their initial intrinsic cost estimate triplets of the PERT-Beta endogenous N-cost probability distribution assessment process.

The CE assessed the following cost error estimates or cost variances (maximum & minimum) above and under every project activities' base cost estimates or most likely cost estimates respectively with a 5% cost under-run probability and a 5% cost overrun probability:

TABLE 16
Activities’ Triplet Cost Estimates by CE: Minimum, Most
probable, & Maximum Activity Cost Estimates of Project Rosedale

| | C_{0, i min} | | C_{0, i max} |
|---|---|---|---|
| | (with 5% cost | | (with 5% cost |
| | underrun probability) | C_{0, i mod} | overrun probability) |
| a1 | c(a_{1 min}) | c(a_{1 mod}) | c(a_{1 max}) |
| Excavation | $7,000 | $8,000 | $9,000 |
| a2 | c(a_{2 min} | c(a_{2 mod}) | c(a_{2 max}) |
| Foundations | $18,000 | $20,000 | $24,000 |
| a3 | c(a_{3 min}) | c(a_{3 mod}) | c(a_{3 max}) |
| Structure & | $100,000 | $120,000 | $150,000 |
| Roof | | | |
| a4 | c(a_{4 min}) | c(a_{4 mod}) | c(a_{4 max}) |
| Electrical & | $70,000 | $80,000 | $95,000 |
| Plumbing | | | |
| a5 | c(a_{5 min}) | c(a_{5 mod}) | c(a_{5 max}) |
| Stone Sidings & | $85,000 | $95,000 | $115,000 |
| Tile Roofing | | | |
| a6 | c(a_{6 min}) | c(a_{6 mod}) | c(a_{6 max}) |
| Landscaping | $40,000 | $45,000 | $60,000 |

The values in Table 17, below, provide us with the starting point for assessing the PERT-Beta cost probability distributions of each project activity (steps 904 and 954). Table 17 reproduces from Table 14 the Activities' Most Likely Expected Cost Increase by Endogenous Contingent Risk Factors:

TABLE 17
Activities’ Percentagewise Most Likely Expected Activity Cost Increase by
Endogenous/Contingent Risk Factors Project Rosedale

| | | | | | Stone | |
|---|---|---|---|---|---|---|
| | | | Structure | Electrical & | Sidings & | Landscaping |
| Project | Excavation | Foundations | & Roof | Plumbing | Roofing | Tile |
| Activities | a₁ | a₂ | a₃ | a₄ | a₅ | a₆ |
| Project | f_{NC;1}^{E} = | f_{NC;2}^{E} = | f_{NC;3}^{E} = | f_{NC;4}^{E} = | f_{NC;5}^{E} = | f_{NC;6}^{E} = |
| Activities’ | = 0.00 | = 0.09 | = 0.0875 | = 0.04 | = 0.04 | = 0.00 |
| Percentage- | | | | | | |
| wise Most | | | | | | |
| Likely | | | | | | |
| Expected | | | | | | |
| Cost | | | | | | |
| Increase by | | | | | | |
| Endogenous/ | | | | | | |
| Contingent | | | | | | |
| Risk | | | | | | |
| Factors | | | | | | |

The endogenous risk factor compounding process is carried out by increasing the activities' three-point cost estimates or base cost estimates (e.g. compounded values) by each activity's most likely expected cost increase generated by endogenous contingent risk factors, as discussed above.

Once each project activity's cost triplet 604 is obtained, one may assess their endogenous N-cost probability distributions followed by the project's N-cost probability distribution from its expected value and standard deviation. Assessing each activity's cost-triplet is necessary in order to derive its PERT-Beta N-cost expected value, variance, & standard deviation. Combining the data from Table 16 and Table 17, for this example, one obtains (steps 1104) the following augmented activity cost estimates:

$$Activity a 1 \text{:} Excavation \\ ( {f}_{N , 1}^{E} = 0.0 )$$

$$\{ \begin{matrix}{C}_{N , 1 min} = {C}_{0 , 1 min} ( 1 + {f}_{NC , 1}^{E} ) = 7 , 000 \times 1.0 = 7 , 000 \\ {C}_{N , 1 mod} = {C}_{0 , 1 mod} ( 1 + {f}_{NC , 1}^{E} ) = 8 , 000 \times 1.0 = 8 , 000 \\ {C}_{N , 1 max} = {C}_{0 , 1 max} ( 1 + {f}_{NC , 1}^{E} ) = 8 , 000 \times 1.0 = 8 , 000\end{matrix} \\ Hence \text{:} \\ \{ \begin{matrix}E ( {C}_{N ; 1} ) = ( 7 , 000 + ( 4 + 8 , 000 ) + 9 , 000 ) \text{/} 6 = \$8 , 000 \\ V ( {C}_{N ; 1} ) = {( 9 , 000 - 7 , 000 )}^{2} \text{/} 36 = {\$}^{2} 111 , 111.11 \\ σ ( {C}_{N ; 1} ) = \sqrt{111 , 111.11} = \$333 .33\end{matrix} \\ Activity a 2 \text{:} Foundations \\ ( {f}_{N , 2}^{E} = 0.09 ) \\ \{ \begin{matrix}{C}_{N , 2 min} = {C}_{0 , 2 min} ( 1 + {f}_{NC , 2}^{E} ) = 18 , 000 \times 1.09 = 19 , 620 \\ {C}_{N , 2 mod} = {C}_{0 , 2 mod} ( 1 + {f}_{NC , 2}^{E} ) = 20 , 000 \times 1.09 = 21 , 800 \\ {C}_{N , 2 max} = {C}_{0 , 2 max} ( 1 + {f}_{NC , 2}^{E} ) = 24 , 000 \times 1.09 = 26 , 160\end{matrix} \\ Hence : \\ \{ \begin{matrix}E ( {C}_{N ; 2} ) = ( 19 , 620 + ( 4 \times 21 , 800 ) + 26 , 160 ) \text{/} 6 = \$22 , 163 \\ V ( {C}_{N ; 2} ) = {( 26 , 160 - 19 , 620 )}^{2} \text{/} 36 = {\$}^{2} 1 , 188 , 100 \\ σ ( {C}_{N ; 2} ) = \sqrt{1 , 188 , 100} = \$1 , 090\end{matrix} \\ Activity a 3 \text{:} Structure \& Roof \\ ( {f}_{N , 3}^{E} = 0.0875 ) \\ \{ \begin{matrix}{C}_{N , 3 min} = {C}_{0 , 3 min} ( 1 + {f}_{NC , 3}^{E} ) = 100 , 000 \times 1.0875 = 108 , 750 \\ {C}_{N , 3 mod} = {C}_{0 , 3 mod} ( 1 + {f}_{NC , 3}^{E} ) = 120 , 000 \times 1.0875 = 130 , 500 \\ {C}_{N , 3 max} = {C}_{0 , 3 max} ( 1 + {f}_{NC , 3}^{E} ) = 150 , 000 \times 1.0875 = 163 , 125\end{matrix} \\ Hence \text{:} \\ \{ \begin{matrix}E ( {C}_{N ; 3} ) = ( 108 , 750 + ( 4 \times 130 , 500 ) + 163 , 125 ) \text{/} 6 = \$132 , 312 \\ V ( {C}_{N ; 3} ) = {( 163 , 125 - 108 , 750 )}^{2} \text{/} 36 = {\$}^{2} 82 , 128 , 906.25 \\ σ ( {C}_{N ; 2} ) = \sqrt{82 , 128 , 906.25} = \$9 , 062.5\end{matrix} \\ Activity a 4 \text{:} Electrical \& Plumbing \\ ( {f}_{NC , 4}^{E} = 0.040 ) \\ \{ \begin{matrix}{C}_{N , 4 min} = {C}_{0 , 4 min} ( 1 + {f}_{NC , 4}^{E} ) = 70 , 000 \times 1.04 = 72 , 800 \\ {C}_{N , 4 mod} = {C}_{0 , 4 mod} ( 1 + {f}_{NC , 4}^{E} ) = 80 , 000 \times 1.04 = 83 , 200 \\ {C}_{N , 4 max} = {C}_{0 , 4 max} ( 1 + {f}_{NC , 4}^{E} ) = 95 , 000 \times 1.04 = 98 , 800\end{matrix} \\ Hence \text{:} \\ \{ \begin{matrix}E ( {C}_{N ; 4} ) = ( 72 , 800 + ( 4 \times 83 , 200 + 98 , 800 ) \text{/} 6 = \$84 , 067 \\ V ( {C}_{N ; 4} ) = {( 98 , 800 - 72 , 800 )}^{2} \text{/} 36 = {\$}^{2} 18 , 777 , 777.78 \\ σ ( {C}_{N ; 4} ) = \sqrt{18 , 777 , 777.78} = \$4 , 333.33\end{matrix} \\ Activity a 5 \text{:} Stone Walling \& Tile Roofing \\ ( {f}_{NC , 5}^{E} = 0.04 ) \\ \{ \begin{matrix}{C}_{N , 5 min} = {C}_{0 , 5 min} ( 1 + {f}_{NC , 5}^{E} ) = 85 , 000 \times 1.04 = 88 , 400 \\ {C}_{N , 5 mod} = {C}_{0 , 5 mod} ( 1 + {f}_{NC , 5}^{E} ) = 95 , 000 \times 1.04 = 98 , 800 \\ {C}_{N , 5 max} = {C}_{0 , 5 max} ( 1 + {f}_{NC , 5}^{E} ) = 115 , 000 \times 1.04 = 119 , 600\end{matrix} \\ Hence \text{:} \\ \{ \begin{matrix}E ( {C}_{N ; 5} ) = ( 88 , 400 + ( 4 \times 98 , 800 + 119 , 600 ) \text{/} 6 = \$100 , 533 \\ V ( {C}_{N ; 5} ) = {( 119 , 600 - 88 , 400 )}^{2} \text{/} 36 = {\$}^{2} 27 , 040 , 000 \\ σ ( {C}_{N ; 5} ) = \sqrt{27 , 040 , 000} = \$5 , 200\end{matrix} \\ Activity a 6 \text{:} Landscaping \\ ( {f}_{NC , 6}^{E} = 0.0 ) \\ \{ \begin{matrix}{C}_{N , 6 min} = {C}_{0 , 6 min} ( 1 + {f}_{NC , 6}^{E} ) = 40 , 000 \times 1.0 = 40 , 000 \\ {C}_{N , 6 mod} = {C}_{0 , 6 mod} ( 1 + {f}_{NC , 6}^{E} ) = 45 , 000 \times 1.0 = 45 , 000 \\ {C}_{N , 6 max} = {C}_{0 , 6 max} ( 1 + {f}_{NC , 6}^{E} ) = 60 , 000 \times 1.0 = 60 , 600\end{matrix} \\ Hence \text{:} \\ \{ \begin{matrix}E ( {C}_{N ; 6} ) = ( 40 , 000 + ( 4 \times 45 , 000 + 60 , 000 ) \text{/} 6 = \$46 , 666 \\ V ( {C}_{N ; 6} ) = {( 60 , 000 - 40 , 000 )}^{2} \text{/} 36 = {\$}^{2} 11 , 111 , 111.11 \\ σ ( {C}_{N ; 6} ) = \sqrt{11 , 111 , 111.11} = \$3 , 333.34\end{matrix}$$

As discussed above, from these endogenous activity cost triplets, one can assess the project expected cost or mean cost by adding the project activities' expected endogenous costs.

Table 18, below, summarizes the endogenous cost expected values, variances, and standard deviations of each activity and those of the project (step 1106):

TABLE 18
Project Rosedale
Expected Value, Variance, & Standard Deviation of Project and
Activities' Construction Costs From Endogenous Risk Factors

| | Expected Value | Variance | Standard Deviation |
|---|---|---|---|
| Activity | E(C_{N; i}) | V(C_{N, i}) | σ(C_{N, i}) = \sqrt{V(C_{N, i})} |
| a1 | $8,000 | $²111,111 | $333.33 |
| Excavation | | | |
| a2 | $22,163 | $²1,188,100 | $1,090 |
| Foundations | | | |
| a3 | $132,312 | $²82,128,906 | $9,062.5 |
| Structure & | | | |
| Roof | | | |
| a4 | $84,067 | $²18,777,835 | $4,333.33 |
| Electrical & Plumbing | | | |
| a5 | $100,533 | $²2,7,040,000 | $5,200 |
| Stone Sidings & | | | |
| Tile Roofing | | | |
| a6 | $46,666 | $²11,111,155 | $3,333.34 |
| Landscaping | | | |
| Total Endogenous Construction Cost of Residence | $\begin{matrix}E ( {C}_{N} ) = {\sum }_{i = 1}^{n} E ( {C}_{N ; i} ) = \\ {µ}_{{C}_{N}} = \$393 , 741\end{matrix}$ | $\begin{matrix}V ( {C}_{N} ) = {\sum }_{i = 1}^{n} V ( {C}_{N , i} ) = \\ {σ}_{{C}_{N}}^{2} = {\$}^{2} 140 , 357 , 26.3\end{matrix}$ | $\begin{matrix}σ ( {C}_{N} ) = \sqrt{{\sum }_{i = 1}^{n} V ( {C}_{N , i} )} = \\ {σ}_{{C}_{N}} = \$11 , 842.3\end{matrix}$ |

Thus, in this example, the expected endogenous N-cost of each residence is $393 741, which is a 7.0% cost increase over its basic initial cost estimate of $368 000. We assume that the probability distribution of the project endogenous N-cost is Normal with an expected value of μ_{C}_{_{N}}=$393,741 and a standard deviation of σ_{C}_{_{N}}=$11,842, i.e.:

C_{N}˜N(μ_{C}_{_{N}}=$393,741;σ_{C}_{_{N}}=$11,842) (87)

### Assessing the Activities' PERT-Beta Cost Probability Distributions Subjected to Exogenous Risk Factors: The Exogenous X-Cost Normal Probability Distribution

The exogenous risk factor compounding process is carried out by increasing the activities' three-point cost estimates or base cost estimates by each activity's most likely expected cost increase generated by exogenous contingent risk factors, as given by the following endogenous cost triplet. Table 19, shown below, reproduces from Table 15 the Activities' Most Likely Expected Cost Increase by Exogenous Contingent Risk Factors. The values in Table 19 provide the starting point for assessing the PERT-Beta cost probability distributions of each project activity. Applying these rates to the minimum, most likely, and maximum values of each activity's base costs, as previously indicated in Table 16, we shall be able to derive the project activities' PERT-Beta exogenous X-cost expected values and variances, and eventually the project's exogenous cost expected value and standard deviation, i.e. the project exogenous X-cost probability distribution.

From the data in Table 16 and applying those of the activities Percentagewise Most Likely Expected Activity Cost Increase by Exogenous/Contingent Risk Factors given in Table 19, reproduced from Table 15, one will be in a position to assess the Activities' Most Likely Expected Cost Increase by Exogenous Contingent Risk Factors.

TABLE 19
Activities’ Percentagewise Most Likely Expected Activity Cost
Increase by Exogenous/Contingent Risk Factors Project Rosedale

| | | | | | Stone | |
|---|---|---|---|---|---|---|
| | | | Structure | Electrical & | Sidings & | Landscaping |
| Project | Excavation | Foundations | & Roof | Plumbing | Roofing | Tile |
| Activities | a₁ | a₂ | a₃ | a₄ | a₅ | a₆ |
| Project | f_{XC;1}^{E} = | f_{XC;2}^{E} = | f_{XC;3}^{E} = | f_{XC;4}^{E} = | f_{XC;5}^{E} = | f_{XC;6}^{E} = |
| Activities’ | 0.045 | 0.0 | 0.065 | 0.0 | 0.0875 | = 0.075 |
| Percentage- | | | | | | |
| wise Most | | | | | | |
| Likely | | | | | | |
| Expected | | | | | | |
| Cost | | | | | | |
| Increase by | | | | | | |
| Exogenous/ | | | | | | |
| Contingent | | | | | | |
| Risk Factors | | | | | | |

As discussed above, one must recall that exogenous risk factor cost impacts are assessed just like endogenous risk factors with respect to the project activities' basic cost estimate triplets. Once each project activity's cost triplet is obtained one may assess their exogenous expected values and variances followed by the project's X-cost probability distribution from its expected value and standard deviation (step 954). The project X-cost probability distribution assessment process starts with the assessment (step 1154) of the activities' cost triplets (e.g. computing the compounded cost values):

$$Activity a 1 \text{:} Excavation \\ ( {f}_{XC , 1}^{E} = 0.045 )$$

$$\{ \begin{matrix}{C}_{X , 1 min} = {C}_{0 , 1 min} ( 1 + {f}_{XC , 1}^{E} ) = 7 , 000 \times 0.045 = 315 \\ {C}_{X , 1 mod} = {C}_{0 , 1 mod} ( 1 + {f}_{XC , 1}^{E} ) = 8 , 000 \times 0.045 = 360 \\ {C}_{X , 1 max} = {C}_{0 , 1 max} ( 1 + {f}_{XC , 1}^{E} ) = 9 , 000 \times 0.045 = 405\end{matrix} \\ Hence \text{:} \\ \{ \begin{matrix}E ( {C}_{X ; 1} ) = ( 315 + ( 4 + 360 ) + 405 ) \text{/} 6 = \$360 \\ V ( {C}_{X ; 1} ) = {( 405 - 315 )}^{2} \text{/} 36 = {\$}^{2} 225 \\ σ ( {C}_{X ; 1} ) = \sqrt{225} = \$15\end{matrix} \\ Activity a 2 \text{:} Foundations \\ ( {f}_{XC , 2}^{E} = 0.0 ) \\ \{ \begin{matrix}{C}_{X , 2 min} = {C}_{0 , 2 min} ( 1 + {f}_{XC , 2}^{E} ) = 18 , 000 \times 0.0 = 0 \\ {C}_{X , 2 mod} = {C}_{0 , 2 mod} ( 1 + {f}_{XC , 2}^{E} ) = 20 , 000 \times 0.0 = 0 \\ {C}_{X , 2 max} = {C}_{0 , 2 max} ( 1 + {f}_{XC , 2}^{E} ) = 24 , 000 \times 0.0 = 0\end{matrix} \\ Hence : \\ \{ \begin{matrix}E ( {C}_{X ; 2} ) = \$0 \\ V ( {C}_{X ; 2} ) = {\$}^{2} 0 \\ σ ( {C}_{X ; 2} ) = \$0\end{matrix} \\ Activity a 3 \text{:} Structure \& Roof \\ ( {f}_{XC , 3}^{E} = 0.065 ) \\ \{ \begin{matrix}{C}_{X , 3 min} = {C}_{0 , 3 min} ( 1 + {f}_{XC , 3}^{E} ) = 100 , 000 \times 0.065 = 6 , 500 \\ {C}_{X , 3 mod} = {C}_{0 , 3 mod} ( 1 + {f}_{XC , 3}^{E} ) = 120 , 000 \times 0.065 = 7 , 800 \\ {C}_{X , 3 max} = {C}_{0 , 3 max} ( 1 + {f}_{XC , 3}^{E} ) = 150 , 000 \times 0.065 = 9 , 750\end{matrix} \\ Hence \text{:} \\ \{ \begin{matrix}E ( {C}_{X ; 3} ) = ( 6 , 500 + ( 4 \times 7 , 800 ) + 9 , 750 ) \text{/} 6 = \$7 , 908 \\ V ( {C}_{X ; 3} ) = {( 9 , 750 - 6 , 500 )}^{2} \text{/} 36 = {\$}^{2} 293 , 402.7 \\ σ ( {C}_{X ; 3} ) = \sqrt{293 , 402.7} = \$541 .66\end{matrix} \\ Activity a 4 \text{:} Electrical \& Plumbing \\ ( {f}_{XC , 4}^{E} = 0.0 ) \\ \{ \begin{matrix}{C}_{X , 4 min} = {C}_{0 , 4 min} ( 1 + {f}_{XC , 4}^{E} ) = 70 , 000 \times 0.0 = 0 \\ {C}_{X , 4 mod} = {C}_{0 , 4 mod} ( 1 + {f}_{XC , 4}^{E} ) = 80 , 000 \times 0.0 = 0 \\ {C}_{X , 4 max} = {C}_{0 , 4 max} ( 1 + {f}_{XC , 4}^{E} ) = 95 , 000 \times 0.0 = 0\end{matrix} \\ Hence \text{:} \\ \{ \begin{matrix}E ( {C}_{X ; 4} ) = \$0 \\ V ( {C}_{X ; 4} ) = {\$}^{2} 0 \\ σ ( {C}_{X ; 4} ) = \$0\end{matrix} \\ Activity a 5 \text{:} Stone Walling \& Tile Roofing \\ ( {f}_{XC , 5}^{E} = 0.0675 ) \\ \{ \begin{matrix}{C}_{X , 5 min} = {C}_{0 , 5 min} ( 1 + {f}_{XC , 5}^{E} ) = 85 , 000 \times 0.0675 = 5 , 737.5 \\ {C}_{X , 5 mod} = {C}_{0 , 5 mod} ( 1 + {f}_{XC , 5}^{E} ) = 95 , 000 \times 0.0675 = 6 , 412.5 \\ {C}_{X , 5 max} = {C}_{0 , 5 max} ( 1 + {f}_{XC , 5}^{E} ) = 115 , 000 \times 0.0675 = 7 , 762.5\end{matrix} \\ Hence \text{:} \\ \{ \begin{matrix}E ( {C}_{X ; 5} ) = ( 5 , 737.5 + ( 4 \times 6 , 412.5 + 7 , 762.5 ) \text{/} 6 = \$6 , 525 \\ V ( {C}_{X ; 5} ) = {( 7 , 762.5 - 5 , 737.5 )}^{2} \text{/} 36 = {\$}^{2} 113 , 906.25 \\ σ ( {C}_{X ; 5} ) = \sqrt{113 , 906.25} = \$337 .5\end{matrix} \\ Activity a 6 : Landscaping \\ ( {f}_{XC ; 6}^{E} = 0.075 ) \\ \{ \begin{matrix}{C}_{X , 6 min} = {C}_{0 , 6 min} ( 1 + {f}_{XC , 6}^{E} ) = 40 , 000 \times 0.075 = 3 , 000 \\ {C}_{X , 6 mod} = {C}_{0 , 6 mod} ( 1 + {f}_{XC , 6}^{E} ) = 45 , 000 \times 0.075 = 3 , 375 \\ {C}_{X , 6 max} = {C}_{0 , 6 max} ( 1 + {f}_{XC , 6}^{E} ) = 60 , 000 \times 0.075 = 4 , 500\end{matrix} \\ Hence \text{:} \\ \{ \begin{matrix}E ( {C}_{X ; 6} ) = ( 3 , 000 + ( 4 \times 3375 + 4500 ) \text{/} 6 = 3500 \$ \\ V ( {C}_{X 6} ) = {( 4500 - 3000 )}^{2} \text{/} 36 = 62500 {\$}^{2} \\ σ ( {C}_{X ; 6} ) = \sqrt{2250000} = 250 \$\end{matrix}$$

and as discussed above, from these exogenous activity cost triplets, one can assess the project expected exogenous X-cost or mean cost by adding the project activities' exogenous expected costs. Table 20, below, summarizes the exogenous cost expected values, variances, and standard deviations of each activity and those of the project (step 1156):

TABLE 20
Project Rosedale
Expected Value, Variance, & Standard Deviation of Project and
Activities' Construction Cost Increases From Exogenous Risk Factors

| | Expected Value | Variance | Standard Deviation |
|---|---|---|---|
| Activity | E(C_{X; i}) | V(C_{X, i}) | σ(C_{X, i}) = \sqrt{V(C_{X, i})} |
| a1 | $360 | $²225 | $15 |
| Excavation | | | |
| a2 | $0 | $²0 | $0 |
| Foundations | | | |
| a3 | $7,908 | $²293,402.7 | $541.66 |
| Structure & | | | |
| Roof | | | |
| a4 | $0 | $²0 | $0 |
| Electrical & Plumbing | | | |
| a5 | $6,525 | 1$²13,906.25 | $337.5 |
| Stone Sidings & | | | |
| Tile Roofing | | | |
| a6 | $3,500 | $²62,500 | $250 |
| Landscaping | | | |
| Total Exogenous Construction Cost of Residence | $\begin{matrix}E ( {C}_{X} ) = {\sum }_{i = 1}^{n} E ( {C}_{X ; i} ) = \\ {μ}_{{C}_{X}} = \$18 , 293\end{matrix}$ | $\begin{matrix}V ( {C}_{X} ) = {\sum }_{i = 1}^{n} V ( {C}_{X , i} ) = \\ {σ}_{{C}_{X}}^{2} = {\$}^{2} 470 , 026.8.25\end{matrix}$ | $\begin{matrix}σ ( {C}_{X} ) = \sqrt{{\sum }_{i = 1}^{n} V ( {C}_{X , i} )} = \\ {σ}_{{C}_{X}} = \$685 \text{.58}\end{matrix}$ |

Thus, in this example, the additional expected cost generated by exogenous risk factors to complete the residential project amounts to $18,293. Assuming that exogenous costs follow a Normal probability distribution, with expected value of μ_{C}_{_{X}}=$18,293 and standard deviation of σ_{C}_{_{X}}=$686, then one concludes that the value of additional project costs generated by exogenous risk factors will comply with the following Normal probability distribution:

C_{X}˜N(μ_{C}_{_{X}}=$18, 293;σ_{C}_{_{X}}=$686) (88)

The project exogenous cost probability distribution accounts for the cost increases to the basic construction costs generated by the exogenous risk factors.

### Project & Management Cost Contingency Reserves for Endogenous & Exogenous Risk Factors

Having at one's disposal the cost probability distributions of endogenous and exogenous cost probability distributions, we may n assess (step 406) their respective endogenous and exogenous cost overrun contingency reserve and budget. The project endogenous and exogenous N-cost and X-cost probability distributions were respectively given by:

C_{N}˜N(μ_{C}_{_{N}}=$393,741;σ_{C}_{_{N}}=$11,842)

and: C_{X}˜N(μ_{C}_{_{X}}=$18, 293;σ_{C}_{_{X}}=$686)

the project significance level has been set by upper management at (1−α)=0.15, while the management significance level has been set at (1−α)=0.05. From a Normal standardized probability distribution. It therefore follows that the project cost baseline will be set at (step 1002):

$$\{ \begin{matrix}{C}_{B ; N}^{z ( α = 0.85 )} = {μ}_{{C}_{N}} + z ( α = 0.85 ) {σ}_{{C}_{N}} \\ {C}_{B ; N}^{z ( α = 0.85 )} = {μ}_{{C}_{N}} + 1 {σ}_{{C}_{N}} \\ {C}_{B ; N}^{z ( α = 0.85 )} = 393 , 741 + 11 , 842 = \$405 , 583\end{matrix} \qquad ( 89 )$$

while the management cost baseline will be set at (step 1052):

$$\{ \begin{matrix}{C}_{B ; X}^{z ( {α}^{′} = 0.95 )} == {μ}_{{C}_{X}} + z ( α = 0.85 ) {σ}_{{C}_{X}} . \\ {C}_{B ; X}^{z ( {α}^{′} = 0.95 )} = {μ}_{{C}_{X}} + 1.65 {σ}_{{C}_{X}} \\ {C}_{B ; X}^{z ( {α}^{′} = 0.95 )} = 18 , 293 + ( 1.65 \times 686 ) = \$19 , 425\end{matrix} \qquad ( 90 )$$

and one can readily determine the project cost contingency reserve as (step 1004):

$$\{ \begin{matrix}{CR}_{{C}_{N}}^{z ( α = 0.85 )} = ψ ( z ( α = 0.85 ) ) {σ}_{{C}_{N}} \\ {CR}_{{C}_{N}}^{z ( α = 0.85 )} = 0.08327 {σ}_{{C}_{N}} \\ {CR}_{{C}_{N}}^{z ( α = 0.85 )} = 0.08327 \times 11 , 842 = \$986\end{matrix} \qquad ( 91 )$$

and the management cost contingency reserve at (step 1054):

$$\{ \begin{matrix}{CR}_{{C}_{X}}^{z ( {α}^{′} = 0.95 )} = ψ ( z ( {α}^{′} = 0.95 ) ) {σ}_{{C}_{X}} \\ {CR}_{{C}_{X}}^{z ( {α}^{′} = 0.95 )} = 0.01976 {σ}_{{C}_{X}} \\ {CR}_{{C}_{X}}^{z ( {α}^{′} = 0.95 )} = 0.01976 \times 686 = \$14\end{matrix} \qquad ( 91 )$$

Hence, the project endogenous N-cost budget will be set at:

$$\{ \begin{matrix}{B}_{{C}_{N}}^{z ( α = 0.85 )} = {C}_{B ; N}^{z ( α )} + {CR}_{{C}_{N}}^{z ( α )} \\ {B}_{{C}_{N}}^{z ( α = 0.85 )} == 405 , 583 + 986 = \$406 , 569\end{matrix} \qquad ( 93 )$$

and the management exogenous X-cost budget will be set at:

$$\{ \begin{matrix}{B}_{{C}_{X}}^{z ( {α}^{′} = 0.95 )} = {C}_{B , ; X}^{z ( {α}^{′} = 0.95 )} + {CR}_{{C}_{X}}^{z ( {α}^{′} = 0.95 )} \\ {B}_{{C}_{X}}^{z ( α = 0.85 )} = 19 , 425 + 14 = \$19 , 439\end{matrix} \qquad ( 94 )$$

This is summarized in the following table, which includes the Program cost baseline 804, program cost overrun contingency reserve 806, and program cost budget 808 as computed in step 408:

TABLE 21
Project, Management & Program
Cost Baselines, Contingency Reserves & Budgets from
Endogenous & Exogenous Normal Cost Probability Distributions with t
The Expected Cost Overrun Risk Measure for a
Single-Project Portfolio Program

| Size of | | | |
|---|---|---|---|
| Program/ | | | |
| Portfolio | Cost | Cost Overrun | Cost |
| K = 1 | Baseline | Contingency Reserve | Budget |
| Project Costs | Project | Project Cost Overrun | Project |
| N-Cost PDF | Cost Baseline | Contingency Reserve | Cost Budget |
| C_{N} ~ N(μ_{C}_{_{N}} = | C_{B;N}^{z(α)} = | CR_{C}_{_{N}}^{z(α)} = ECO_{N}^{z(α)} = | B_{C}_{_{N}}^{z(α)} = |
| $393.7K; | μ_{C}_{_{N}} + | σ_{C}_{_{N}}ψ(z(α))CR_{C}_{_{N}}^{z(α=0.85)} = | C_{B,;N}^{z(α)} + |
| σ_{C}_{_{N}} = | z(α)σ_{C}_{_{N}} | $0.986K | CR_{C}_{_{N}}^{z(α)} |
| $11.85K) | C_{B;N}^{z(α=0.85)} = | | B_{C}_{_{N}}^{z(α=0.85)} = |
| (α = 0.85) | $405.583K | | $406.569K |
| Management | Management | Mngt Cost Overrun | Management |
| Costs | Cost Baseline | Contingency Reserve | Cost Budget |
| X-Cost PDF | C_{B;X}^{z(α′)} = | CR_{C}_{_{X}}^{z(α′)} = | B_{C}_{_{X}}^{z(α′)} = |
| C_{X} ~ N(μ_{C}_{_{X}} = | μ_{C}_{_{X}} + | ECO_{X}^{z(α′)} = | C_{B;X}^{z(α′)} + |
| $18.3K; | z(α′)σ_{C}_{_{X}} | σ_{C}_{_{X}}ψ(z(α′)) | CR_{C}_{_{X}}^{z(α′)} |
| σ_{C}_{_{X}} = | C_{B;X}^{z(α′=0.95)} = | CR_{C}_{_{X}}^{z(α′=0.95} = | B_{C}_{_{X}}^{z(α′=0.95)} = |
| $0.686K) | $19.425K | $0.014K | $19.439K |
| (α′ = 0.95) | | | |
| Program | Program Cost | Program Cost Overrun | Program |
| Project | Baseline | Contingency Reserve | Cost Budget |
| Costs & | C_{B;NX} = | CR_{C}_{_{NX}} = | B_{C}_{_{NX}} = |
| Management | C_{B;N}^{z(α)} + | CR_{C}_{_{N}}^{z(α)} + CR_{C}_{_{X}}^{z(α′)} | B_{C}_{_{N}}^{z(α)} + |
| Costs | C_{B;X}^{z(α′)} | CR_{C}_{_{NX}} = | B_{C}_{_{X}}^{z(α′)} |
| | C_{B;NX} = | $1K | B_{C}_{_{NX}} = |
| | $425.008K | | C_{B;NX} + |
| | | | CR_{C}_{_{NX}} |
| | | | B_{C}_{_{NX}} = |
| | | | $426.008K |

### The Replicated-Project Portfolio

Below, the same example is used for method 2500 so as to compute the portfolio-related quantities. In step 2502, the portfolio-related cost information is acquired. Herein a replicated-portfolio is used, meaning that replicated portfolio related information 2306 is used. Some of this information has already been computed above.

Indeed, it has been established above that the single-family residence endogenous costs would comply with a Normal probability distribution such that:

C_{N}˜N(μ_{C}_{_{N}}=$393,741;σ_{C}_{_{N}}=$11,842)

while additional costs generated by exogenous risk factors would be described also by a Normal probability distribution such that:

C_{X}˜N(μ_{C}_{_{X}}=$18, 293;σ_{C}_{_{X}}=$686)

Assessing the construction costs of a portfolio of 9 replicated units (i.e. Number of replicated projects 2308) would involve a reassessment of the financial risks of the residential development program. Portfolio risk diversification effects must be accounted for through the portfolio cost variance. In that respect, the project CE of Domotek Construction Inc. has assessed from Table 22 below the correlation coefficients 2304 between project endogenous costs and project exogenous costs. The CE has estimated that the project correlation coefficient 2304 between project endogenous costs as weak and therefore set at ρ_{N}=0.15 while the project correlation coefficient between project exogenous costs has been assessed as strong and therefore set at ρ_{X}=0.80.

Table 22
Exemplary Correlation Coefficients
between Project Construction Costs

| Correlation Coefficient | |
|---|---|
| Between Project Costs | ρ |
| Weak | 0.15 |
| Moderate | 0.45 |
| Strong | 0.80 |

Thus, in step 2504, Phase I expected endogenous N-costs of program The Manor are estimated at:

$$\{ \begin{matrix}E ( {C}_{N , K = 9} ) = {μ}_{{C}_{N} , K = 9} = {\sum }_{j = 1}^{K = 9} E ( {\tilde{C}}_{N} ) = K {μ}_{{C}_{N}} \\ E ( {C}_{N , K = 9} ) = {μ}_{{C}_{N} , K = 9} = 9 \times \$393 , 741 = \$3 , 543 , 669\end{matrix} \qquad ( 95 )$$

while its expected exogenous X-costs of program The Manor are estimated at:

$$\{ \begin{matrix}E ( {C}_{X , K = 9} ) = {μ}_{{C}_{X} , K = 9} = {\sum }_{j = 1}^{K = 9} E ( {C}_{X} ) = K {μ}_{{C}_{X}} \\ E ( {C}_{X , K = 9} ) = {μ}_{{C}_{X} , K = 9} = 9 \times \$18 , 293 = \$164 , 637\end{matrix} \qquad ( 96 )$$

wherein the Phase I standard deviation of the portfolio endogenous N-costs will need to account for the correlational effects between project endogenous costs and will be assessed by:

$$\{ \begin{matrix}\begin{matrix}{σ}_{{C}_{N} ; K , {ρ}_{N}} = σ ( {C}_{N , K , {ρ}_{N}} ) \\ = {σ}_{{C}_{N}} {ω}_{N} \\ = {σ}_{{C}_{N}} \sqrt{K [ 1 + {ρ}_{N} ( K - 1 )}\end{matrix} \\ \begin{matrix}{σ}_{{C}_{N} ; K , {ρ}_{N}} = σ ( {C}_{N , K = 9 , {ρ}_{N} = 0.15} ) \\ = \$11 , 842 \sqrt{9 [ 1 + ( 0.15 ) ( 8 ) ]} \\ = \$11 , 842 \times 4.449719\end{matrix} \\ {σ}_{{C}_{N} ; K , {ρ}_{N}} = σ ( {C}_{N , K = 9 , {ρ}_{N} = 0.15} ) = \$52 , 693\end{matrix} \qquad ( 97 )$$

while Phase I standard deviation of the portfolio exogenous X-costs will also need to account for the correlational effects between project exogenous costs and will be assessed by:

$$\{ \begin{matrix}\begin{matrix}{σ}_{{C}_{X} ; K , {ρ}_{X}} = σ ( {C}_{X , K , {ρ}_{X}} ) \\ = {σ}_{{C}_{X}} {ω}_{X} \\ = {σ}_{{C}_{X}} \sqrt{K [ 1 + {ρ}_{X} ( K - 1 ) ]}\end{matrix} \\ \begin{matrix}{σ}_{{C}_{X} ; K , {ρ}_{X}} = σ ( {C}_{X , K = 9 , {ρ}_{X} = 0.8} ) \\ = \$686 \sqrt{9 [ 1 + ( 0.8 ) ( 8 ) ]} \\ = \$686 \times 8.160882\end{matrix} \\ {σ}_{{C}_{X} ; K , {ρ}_{X}} = σ ( {C}_{X , K = 9 , {ρ}_{X} = 0.8} ) = \$5 , 598\end{matrix} \qquad ( 98 )$$

It follows that the endogenous N-cost probability distribution of Phase I of The Manor Program will also comply with a Normal probability distribution and will be defined by:

C_{N,K=9, ρ}_{_{N}}_{=0.15}˜N(μ_{C}_{_{N,K=9}}=$3,543,669;σ_{C}_{_{N}}_{,K=9,ρ}_{_{N}}_{=0.15}=$52,716)

while the exogenous X-cost probability distribution of Phase I of The Manor Program will also comply with a Normal probability distribution and will be defined by:

C_{X,K=9}˜N(μ_{C}_{_{X,K}}₌₉=$164,637;σ_{C}_{_{X}}_{,K=9,ρ}_{_{X}}_{=0.80}=$5,598) (99)

The endogenous N-cost baseline of The Manor Program has been set at the (1−α)=0.15 significance level, which implies a cost budgeting policy of z(α=0.85)=1. Consequently, the program endogenous N-cost baseline will be set at:

$$\{ \begin{matrix}{C}_{B ; N ; K = 9}^{z ( α = \text{.85} ) = 1} = {μ}_{{C}_{N} , K = 9} + z ( α = 0.85 ) {σ}_{{C}_{N} ; K = 9 , {ρ}_{N} = 0.15} \\ {C}_{B ; N ; K = 9}^{z ( α = \text{.85} ) = 1} = 3 , 543 , 669 + ( 1 \times 52 , 693 ) = \$3 , 596 , 362\end{matrix} \qquad ( 100 )$$

and the program endogenous project contingency reserve at:

$$\{ \begin{matrix}{CR}_{{C}_{N} , K = 9 , {ρ}_{N} = 0.8}^{z ( α = 0.85 ) = 1} = {σ}_{{C}_{N} , K , {ρ}_{N}} ψ ( z ( α = 0.85 ) ) \\ {CR}_{{C}_{N} , K = 9 , {ρ}_{N} = 0.8}^{z ( α = 0.85 ) = 1} = 0.08327 {σ}_{{C}_{N} , K , {ρ}_{N}} \\ {CR}_{{C}_{N} ; K = 9 , {ρ}_{N} = 0.8}^{z ( α = 0.85 ) = 1} = 0.08327 \times 52 , 693 = \$4 , 388\end{matrix} \qquad ( 101 )$$

Consequently, the program endogenous project budget will be estimated at:

$$\{ \begin{matrix}{B}_{{C}_{N} , K = 9}^{z ( α = 0.85 ) = 1} = {C}_{B ; N ; K = 9}^{z ( α = \text{.85} )} + {CR}_{{C}_{N} , K = 9 , {ρ}_{N} = 0.15}^{z ( α = 0.85 )} \\ {B}_{{C}_{N} , K = 9}^{z ( α = 0.85 ) = 1} = \$3 , 596 , 362 + \$4 , 388 = \$3 , 600 , 750\end{matrix} \qquad ( 102 )$$

Turning our attention to The Manor Program exogenous X-cost, its X-cost baseline has been set at the (1−α′)=0.05 significance level, which implies a cost budgeting policy of z(α′=0.95)=1.65. Consequently, the program exogenous X-cost baseline will be set at:

$$\{ \begin{matrix}{C}_{B ; X ; K = 9}^{z ( {α}^{′} = \text{.95} ) = 1.65} = {μ}_{{C}_{X} , K = 9} + z ( {α}^{′} = 0.95 ) {σ}_{{C}_{X} ; K = 9 , {ρ}_{X} = 0.8} \\ {C}_{B ; X ; K = 9}^{z ( {α}^{′} = \text{.95} ) = 1.65} == 164 , 637 + ( 1.65 \times 5 , 598 ) = \$173 , 873\end{matrix} \qquad ( 103 )$$

while the program exogenous project contingency reserve will be set at:

$$\{ \begin{matrix}{CR}_{{C}_{X} ; K = 9 , {ρ}_{X} 0.8}^{z ( {α}^{′} = 0.95 ) = 1.65} = {σ}_{{C}_{X} , K , {ρ}_{X}} ψ ( z ( {α}^{′} = 0.95 ) ) \\ {CR}_{{C}_{X} ; K = 9 , {ρ}_{X} = 0.8}^{z ( {α}^{′} = 0.95 ) = 1.65} = 0.01976 {σ}_{{C}_{X} , K , {ρ}_{X}} \\ {CR}_{{C}_{X} ; K = 9 , {ρ}_{X} = 0.8}^{z ( {α}^{′} = 0.95 ) = 1.65} = 0.01976 \times 5 , 598 = \$110\end{matrix} \qquad ( 104 )$$

Consequently, the program endogenous project budget will be estimated at:

$$\{ \begin{matrix}{B}_{{C}_{X} , K = 9}^{z ( {α}^{′} = 0.95 ) = 1.65} = {C}_{B ; X ; K = 9}^{z ( {α}^{′} = \text{.95} )} + {CR}_{{C}_{X} ; K = 9 , {ρ}_{X} = 0.8}^{z ( {α}^{′} = 0.95 )} \\ {B}_{{C}_{X} , K = 9}^{z ( {α}^{′} = 0.95 ) = 1.65} = 173 , 873 + 110 = \$173 , 983\end{matrix} \qquad ( 105 )$$

Table 23, below, summarizes all these results and includes the Program/Portfolio Cost Baselines and Overrun Contingency Reserves as computed in step 2506:

TABLE 23
Project, Management & Program
Cost Baselines, Cost Overrun Contingency Reserves & Budgets from Endogenous &
Exogenous Normal Cost Probability Distributions with The Expected Cost
Overrun Risk Measure for a Replicated-Project Program/Portfolio

| Size of | | Program/Portfolio | |
|---|---|---|---|
| Program/Portfolio | Program/Portfolio | Cost Overrun | Program/Portfolio |
| K = 9 | Cost Baselines | Contingency Reserves | Cost Budgets |
| Program/Portfolio | Program/Portfolio | Program/Portfolio | Program/Portfolio |
| Project Cost | Project Cost Baseline | Project Cost Overrun | Project Cost Budget |
| N-Cost PDF | C_{B; N,K,p}_{_{N}}^{z(α=0.85)} = | Contingency Reserve | B_{C}_{_{N}}_{,K}^{z(α=0.85)} = |
| C_{N,K}~N(μ_{C}_{_{N}},_{K} = | μ_{C}_{_{N}}_{;K} + | CR_{C}_{_{N}}_{;K; ρ}_{_{N}}^{z(α=0.85)} = | C_{B;NK,ρ}_{_{N}}^{z(α)} + |
| $3,543K; | z(α) σ_{C}_{_{N}}_{;K; ρ}_{_{N}} = | ECO_{N;K; ρ}_{_{N}}^{z(α=0.85)} = | CR_{C}_{_{N}}_{,K;ρ}_{_{N}}^{z(α)}= |
| σ_{C}_{_{N}},_{K},_{ρ}_{_{N}} = | $3,596.36K | σ_{C}_{_{N}}_{;K; ρ}_{_{N}}ψ(z(α)) = | $3,600.748K |
| $52.7K) | | $4.388K | |
| (α = 0.85) | | | |
| Program/Portfolio | Program/Portfolio | Program/Portfolio | Program/Portfolio |
| Management Cost | Mngt Cost Baseline | MngtCost Overrun | Management Cost Budget |
| X-Cost PDF | C_{B; X,K,ρ}_{_{X}}^{z(α′=0.95)} = | Contingency Reserve | B_{C}_{_{X}}_{,K}^{z(α′=0.95)} = |
| C_{X,K}~N(μ_{C}_{_{X}}_{,K} = | μ_{C}_{_{X}}_{;K} + | CR_{C}_{_{X}}_{,K; ρ}_{_{X}}^{z(α′=0.95)} = | C_{B; X,K,ρ}_{_{X}}^{z(α′)} + |
| $164.64K; | z(α′) σ_{C}_{_{X}}_{,K;ρ}_{_{X}} = | ECO_{X;K; ρ}_{_{X}}^{z(α′=0.95)} = | CR_{C}_{_{X}}_{;K, ρ}_{_{X}}^{z(α′)} = |
| σ_{C}_{_{X}},_{K,ρ}_{_{X}} = = | $173.9K | σ_{C}_{_{X}}_{,K; ρ}_{_{X}}ψ(z(α′)) = | $174.01K |
| $5.598K) | | $0.11K | |
| (α′ = 0.95) | | | |
| Program/Portfolio | Program/Portfolio | Program/Portfolio | Program/Portfolio |
| Program Costs | ProgramCost Baseline | Program Cost Overrun | Program Cost Budget |
| Project Costs | C_{B; NX;K} = = | Contingency Reserve | B_{NX;K} = C_{B;NX,K}^{z(α)} + |
| & | C_{B; N,K,ρ}_{_{N}}^{z(α)} + | CR_{C}_{_{NX}}_{;K.} = ECO_{NX,K} = = | CR_{CN,} [symbol] ^{z(α)} |
| Management Costs | C_{B; X,K,ρ}_{_{X}}^{z(α′)} = | CR_{C}_{_{N}}_{;K, ρ}_{_{N}}^{z(α)} + | B_{C}_{_{NX}}_{;K} = B_{C}_{_{N}},_{K;ρ}_{_{N}}z^{(α)} + |
| | $3,770.26K | CR_{C}_{_{X}}_{;K, ρ}_{_{X}}^{z(α′)} = | B_{C}_{_{X}}_{;K; ρ}_{_{X}}^{z(α′)} = |
| | | $4,498K | $3,774.758K |

$ψ ( z ( α ) ) = \frac{1}{\sqrt{2 π}} exp [ - \frac{{z}^{2} ( α )}{2} ] - z ( α ) {F}_{N} ( - z ( α ) )$ [symbol]
indicates data missing or illegible when filed

Below, continuing with the same example, and in accordance with the same exemplary embodiment, the execution time metric will now be assessed. Thus, method 1500 will be demonstrated. Firstly, at step 1502, the project-related information is entered. As discussed above with regard to execution costs, again three variants of the Rosedale model are herein considered, but the construction times of each variant are taken to be essentially be the same. In addition, the construction activities are the same as discussed above, but here the assessment matrix includes the most likely time estimates, i.e. the time mode, for each project activity. All activities sit on the project's critical path which means that any increase in the duration of any activity will also result in an increase of the project duration.

The table below summarizes this information (Most Probable Execution Time 614 for each activity):

TABLE 24
Exemplary Most Likely Execution Time of Project Activities
Project Rosedale (d: days)

| | | | | | Stone | |
|---|---|---|---|---|---|---|
| | | | Structure | Electrical & | Sidings & | Landscaping |
| Project | Excavation | Foundations | & Roof | Plumbing | Roofing | Tile |
| Activities | a₁ | a₂ | a₃ | a₄ | a₅ | a₆ |
| Most | t (a_{1 mod}) | t (a_{2 mod}) | t (a_{3 mod}) | t (a_{4 mod}) | t (a₅ _{mod}) | t (a_{6 mod}) |
| Likely | 2 d | 4 d | 30 d | 20 d | 25 d | 15 d |
| Time | | | | | | |

The base time for each housing unit is therefore assessed at 96 days, i.e. a little over 3 months. However, such a time estimates do not account for endogenous & exogenous risk factors which might very well increase the construction time of each housing unit. Those have already been discussed above, including their probability of occurrence (706 and 716).

### Assessing the Time Impacts on Project Activities of Endogenous/Contingents & Exogenous/Contingent Risk Factors

The cost engineer (CE) must start the risk assessment process by assessing from the projects work breakdown structure (WBS) the percentagewise time impacts of each endogenous/contingent (710) and exogenous/contingent (720) risk factor on each activity's most likely cost estimate or base cost estimate:

TABLE 25
Project Activity Risk Breakdown and Impact Assessment Matrix of
Endogenous & Exogenous Contingent Risk Factors and their Most Likely
Expected Time Impact on Project Activities Project Rosedale

| | | | | | Stone | |
|---|---|---|---|---|---|---|
| | | | Structure | Electrical & | Sidings & | Landscaping |
| Project | Excavation | Foundations | & Roof | Plumbing | Roofing | Tile |
| Activities | a₁ | a₂ | a₃ | a₄ | a₅ | a₆ |
| Most | t (a_{1 mod}) | t (a_{2 mod}) | t (a_{3 mod}) | t (a_{4 mod}) | t (a₅ _{mod}) | t (a_{6 mod}) |
| Likely | 2 d | 4 d | 30 d | 20 d | 25 d | 15 d |
| Time | | | | | | |
| Endogenous/ | Project Endogenous/Contingent Risk Factors and their | | | | | |
| contingent | Percentagewise Most Likely Time Impacts on | | | | | |
| Risk | Project Activities | | | | | |
| Factors | | | | | | |
| F_{NC;1} | | | f_{NC, 3, 1} = | f_{NC, 4, 1} = | | |
| P_{NC;1} = | | | +40% | +30% | | |
| 0.15 | | | | | | |
| F_{NC;2} | | | f_{NC, 3, 2} = | f_{NC, 4, 2} = | f_{NC, 4, 2} = | |
| P_{NC;2} = | | | +60% | +75% | +50% | |
| 0.20 | | | | | | |
| F_{NC;3} | | f_{NC, 2, 3} = | f_{NC, 3, 3} = | f_{NC, 4, 3} = | | |
| P_{NC;3} = | | +40% | +75% | +50% | | |
| 0.30 | | | | | | |
| Exogenous/ | Project Exogenous/Contingent Risk Factors and their | | | | | |
| contingent | Percentagewise Most Likely Time t Impacts on | | | | | |
| Risk | Project Activities | | | | | |
| Factors | | | | | | |
| F_{XC;1} | | | | | | |
| P_{XC;1} = | | | | | | |
| 0.25 | | | | | | |
| F_{XC;2} | | f_{XC, 2, 2} = | f_{XC, 3, 2} = | f_{XC, 4, 2} = | f_{XC, 5, 2} = | f_{XC, 6, 2} = |
| P_{XC;2} = | | +50% | +75% | +50% | +90% | +25% |
| 0.20 | | | | | | |
| F_{XC;3} | | | | | f_{XC, 5, 3} = | |
| P_{XC;3} = | | | | | +50% | |
| 0.10 | | | | | | |
| F_{XC;4} | f_{XC, 1, 4} = | | | | | f_{XC, 6, 4} = |
| P_{XC;4} = | +35% | | | | | +25% |
| 0.30 | | | | | | |

From these assessed values by the CE, BUDGET PRO software will calculate (step 1504) the Most Likely Expected Time Increase as indicated in Table 26 & Table 27, shown below; Table 26 pertaining to endogenous/contingent risk factor time impacts (computed at step 1602), and Table 27 pertaining to the exogenous/contingent risk factor time impacts (computed at step 1602):

TABLE 26
Project Activity Risk Breakdown and Impact Assessment Matrix of Endogenous/Contingent
Risk Factors and their Most Likely Expected Time Impact on Project Activities
Project Rosedale

| Project | Excavation | Foundations | Structure | Electrical & | Stone Sidings & | Landscaping |
|---|---|---|---|---|---|---|
| Activities | a₁ | a₂ | & Roof | Plumbing | Tile Roofing | a₆ |
| | | | a₃ | a₄ | a₅ | |
| Most Likely | t (a_{1 mod}) | t (a_{2 mod}) | t (a_{3 mod}) | t (a_{4 mod}) | t (a_{5 mod}) | t (a_{6 mod}) |
| Time | 2 d | 4 d | 30 d | 20 d | 25 d | 15 d |
| Endogenous/ | Project Endogenous/Contingent Risk Factors and their | | | | | |
| contingent | Percentagewise Most Likely Expected Time Impact on | | | | | |
| Risk Factors | Project Activities | | | | | |
| F_{NC,1} | | | f_{NC,3, 1}^{E} = 0.06 = | f_{NC;4, 1}^{E} = | | |
| p_{NC,1} = 0.15 | | | 0.40 × 0.15 | 0.045 = | | |
| | | | | 0.30 × | | |
| | | | | 0.15 | | |
| F_{NC;2} | | | f_{NC;3, 2}^{E} = 0.12 = | f_{NC;4, 2}^{E} = | f_{NC;5, 2}^{E} = 0.10 = | |
| p_{NC;2} = 0.20 | | | 0.60 × 0.20 | 0.15 = | 0.50 × 0.20 | |
| | | | | 0.75 × | | |
| | | | | 0.20 | | |
| F_{NC;3} | | f_{NC;2, 3}^{E} = | f_{NC;3, 2}^{E} = 0.225 = | f_{NC;4, 3}^{E} = | | |
| p_{NC;3} = 0.30 | | 0.12 = | 0.75 × 0.30 | 0.15 = | | |
| | | 0.40 × | | 0.50 × | | |
| | | 0.30 | | 0.30 | | |
| Activities' | f_{NC;1}^{E} = = | f_{NC;2}^{E} = = | f_{NC;3}^{E} = = | f_{NC; 4}^{E} = = | f_{NC;5}^{E} = = | f_{NC;6}^{E} = = |
| Percentage- wise Most Likely Expected Time Increase by Endogenous/ Contingent | $\begin{matrix}{\sum }_{r = 1}^{{R}_{NC , 1}} {f}_{NC ; 1 , r}^{E} \\ 0. == \\ 0.\end{matrix}$ | $\begin{matrix}{\sum }_{r = 1}^{{R}_{NC , 2}} {f}_{NC ; 2 , r}^{E} \\ 0.12 == \\ 0.12\end{matrix}$ | $\begin{matrix}{\sum }_{r = 1}^{{R}_{NC , 3}} {f}_{NC ; 3 , r}^{E} 0. + \\ 0.12 + \\ 0.225 == \\ 0.405\end{matrix}$ | $\begin{matrix}{\sum }_{r = 1}^{{R}_{NC , 4}} {f}_{NC ; 4 , r}^{E} \\ 0.045 + \\ 0.15 + \\ 0.15 == \\ 0.345\end{matrix}$ | $\begin{matrix}{\sum }_{r = 1}^{{R}_{NC , 5}} {f}_{NC ; 5 , r}^{E} \\ 0.1 == \\ 0.1\end{matrix}$ | $\begin{matrix}{\sum }_{r = 1}^{{R}_{NC , 6}} {f}_{NC ; 6 , r}^{E} \\ 0. == \\ 0.\end{matrix}$ |
| Risk Factors | | | | | | |
| Expected | E[t_{NC}(a₁)] = | E[t_{NC}(a₂)] = | E[t_{NC}(a₃)] = | E[t_{NC}(a₄)] = | E[t_{NC}(a₅)] = | E[t_{NC}(a₆)] = |
| Time | t(a₁) × | t(a₁) × | t(a₃) × | t(a₄) × | t(a₅) × | t(a₆) × |
| Increase on | f_{NC;1}^{E} = | f_{NC;1}^{E} = | f_{NC;3}^{E} = | f_{NC;4}^{E} = | f_{NC;5}^{E} = | f_{NC;6}^{E} = |
| Project | 2 × 0.0 = = | 4 × 0.12 = = | 30 × 0.405 = = | 20 × 0.345 = = | 25 × 0.10 = = | 25 × 0.0 = = |
| Activities by | 0 d | 0.48 d | 12.15 d | 6.9 d | 2.5 d | 0 d |
| Endogenous/ | | | | | | |
| Contingent | | | | | | |
| Risk Factors | | | | | | |

Endogenous risk factor time impacts must be assessed percentagewise with respect to the project activity base time or most likely time estimate. The total time impact of endogenous risk factors is obtained by the addition of all individual risk factors' percentagewise endogenous time impacts on a project activity. Hence, the N-time probability distribution will contain all endogenous risk factor time impacts in addition to the project activities' basic execution times.

Below, Table 27 pertains to the exogenous/contingent risk factor time impacts (step 1652):

TABLE 27
Project Activity Risk Breakdown and Impact Assessment Matrix of Exogenous/Contingent
Risk Factors and their Most Likely Expected Time Impact on Project Activities
Project Rosedale

| Project | Excavation | Foundations | Structure | Electrical & | Stone Sidings & | Landscaping |
|---|---|---|---|---|---|---|
| Activities | a₁ | a₂ | & Roof | Plumbing | Tile Roofing | a₆ |
| | | | a₃ | a₄ | a₅ | |
| Most Likely | t (a_{1 mod}) | t (a_{2 mod}) | t (a_{3 mod}) | t (a_{4 mod}) | t (a_{5 mod}) | t (a_{6 mod}) |
| Time | 2 d | 4 d | 30 d | 20 d | 25 d | 15 d |
| Endogenous/ | Project Endogenous/Contingent Risk Factors and their | | | | | |
| contingent | Percentagewise Most Likely Expected Time Impact on | | | | | |
| Risk Factors | Project Activities | | | | | |
| F_{XC;1} | | | | | | |
| p_{XC;1} = 0.25 | | | | | | |
| F_{XC;2} | | f_{XC;2, 2}^{E} = | f_{XC;3, 2}^{E} = | f_{XC;4, 2}^{E} = | f_{XC;5, 2}^{E} = | f_{XC;5, 2}^{E} = |
| p_{XC;2} = 0.20 | | 0.10 = | 0.15 = | 0.10 = | 0.18 = | 0.05 = |
| | | (0.50) × | (0.75) × | (0.50) × | 0.90 × | 0.25 × |
| | | 0.20 | 0.20 | 0.20 | 0.20 | 0.20 |
| F_{XC;3} | | | | | f_{XC;5, 3}^{E} = | |
| p_{XC;3} = 0.10 | | | | | 0.05 = | |
| | | | | | 0.50 × | |
| | | | | | 0.10 | |
| F_{XC;4} | f_{XC;1, 4}^{E} = | | | | | f_{XC;6, 4}^{E} = |
| p_{XC;4} = 0.30 | 0.105 = | | | | | 0.075 = |
| | 0.35 × | | | | | 0.25 × |
| | 0.30 | | | | | 0.30 |
| Activities' | f_{XC;1}^{E} = = | f_{XC;2}^{E} = = | f_{XC;3}^{E} = = | f_{XC;4}^{E} = = | f_{XC;5}^{E} = = | f_{XC;6}^{E} = = |
| Percentage- wise Most Likely Expected Time Increase by Endogenous/ | $\begin{matrix}{\sum }_{r = 1}^{{R}_{XC , 1}} {f}_{XC ; 1 , r}^{E} = \\ 0.105 = \\ 0.105\end{matrix}$ | $\begin{matrix}{\sum }_{r = 1}^{{R}_{XC , 2}} {f}_{XC ; 2 , r}^{E} = \\ 0.1 = \\ 0.1\end{matrix}$ | $\begin{matrix}{\sum }_{r = 1}^{{R}_{XC , 3}} {f}_{XC ; 3 , r}^{E} = \\ 0.15 = \\ 0.15\end{matrix}$ | $\begin{matrix}{\sum }_{r = 1}^{{R}_{XC , 4}} {f}_{XC ; 4 , r}^{E} = \\ 0.1 = \\ 0.1\end{matrix}$ | $\begin{matrix}{\sum }_{r = 1}^{{R}_{XC , 5}} {f}_{XC ; 5 , r}^{E} = \\ 0.18 + \\ 0.05 = \\ 0.23\end{matrix}$ | $\begin{matrix}{\sum }_{r = 1}^{{R}_{XC , 6}} {f}_{XC ; 6 , r}^{E} = \\ 0.05 + \\ 0.075 == \\ 0.125\end{matrix}$ |
| Contingent | | | | | | |
| Risk Factors | | | | | | |
| Expected | E[t_{XC}(a₁)] = | E[t_{XC}(a₂)] = | E[t_{XC}(a₃)] = | E[t_{XC}(a₄)] = | E[t_{XC}(a₅)] = | E[t_{XC}(a₆)] = |
| Time | t(a₁) × | t (a₁) × | t (a₃) × | t (a₄) × | t (a₅) × | t (a₆) × |
| Increase on | f_{XC;1}^{E} = | f_{XC;1}^{E} = | f_{XC;3}^{E} = | f_{XC;4}^{E} = | f_{XC;5}^{E} = | f_{XC;6}^{E} = |
| Project | 2 × 0.105 = = | 4 × 0.10 = = | 30 × (0.15) = = | 20 × 0.10 = = | 25 × 0.23 = = | 15 × 0.125 = = |
| Activities by | 0.21 d | 0.40 d | 4.5 d | 2 d | 5.75 d | 1.875 d |
| Endogenous/ | | | | | | |
| Contingent | | | | | | |
| Risk Factors | | | | | | |

The results provided by the row above the last row of Table 26 & Table 27 will respectively serve in assessing endogenous N-time and exogenous X-time probability distributions. Concerning the results provided by the last row of Table 26 & Table 27 they will help the CE in identifying activities potentially subjected to relatively severe time impacts from identifiable risk factors and, consequently, in devising appropriate active risk response strategies. Hence, the times of activities 3 & 4 are susceptible of being impacted by identifiable endogenous risk factors, while the times of activities 3, 4 & 5 are susceptible of being impacted by identifiable exogenous risk factors.

From the last row of Table 26 & Table 27 one may conclude that endogenous risk factors could increase the construction time of a house by E(t_{NC})=Σᵢ₌₁⁶E[t_{NC}(aᵢ)]=22.03 d, while the exogenous risk factor cost impacts could increase the construction time of a house by E(t_{XC})=Σᵢ₌₁⁶E[t_{XC}(aᵢ)]=14.735 d. In total, one may expect a total construction time increase for each house unit of E(t_{NC})+E(t_{XC})=36.765 d≈37 d, i.e. 1¼ month. Active risk response strategies should therefore identify those activities most at risk as well as the origin of the risk and devise specific active risk response strategies to reduce those potential risk-induced times.

### Assessing the Project Endogenous N-Time Probability Distribution and the Project Exogenous X-Time Probability Distribution

### Assessing the Activities' PERT-Beta Time Probability Distributions Subjected to Endogenous Risk Factors: The Endogenous N-Time Normal Probability Distribution

The time probability distribution of all 6 activities will be carried out through the PERT-Beta assessment process by the CE (at steps 1604 and 1654). However, prior to carrying out such an assessment process the CE will need to assess the time estimation “errors” or time variances by assessing over and under the most likely (realistic) time of each activity, its maximum (pessimistic) and its minimum (optimistic) time. These estimates we shall refer to as the basic activity times of the project and shall define their initial intrinsic time estimate triplets of the PERT-Beta endogenous N-cost probability distribution assessment process.

The CE provided the following exemplary time error estimates or time variances (maximum 616 & minimum 618) above and under every project activities' base time estimates or most likely time estimates respectively with a 5% time under-run probability and a 5% time overrun probability:

TABLE 28
Activities’ Triplet Time Estimates by CE: Minimum, Most
probable, & Maximum Activity Time Estimates of Project Rosedale

| | T_{0, imin} | | T_{0, imax} |
|---|---|---|---|
| | (with 5% time | | (with 5% time |
| | underrun probability) | T_{0, imod} | overrun probability)) |
| a1 | t(a_{1 min}) | t(a_{1 mod}) | t(a_{1 max}) |
| Excavation | 1 d | 2 d | 5 d |
| a2 | t(a_{2 min}) | t(a_{2 mod}) | t(a_{2 max}) |
| Foundations | 3 d | 4 d | 6 d |
| a3 | t(a_{3 min}) | t(a_{3 mod}) | t(a_{3 max}) |
| Structure & | 25 d | 30 d | 40 d |
| Roof | | | |
| a4 | t(a_{4 min}) | t(a_{4 mod}) | t(a_{4 max}) |
| Electrical & | 15 d | 20 d | 30 d |
| Plumbing | | | |
| a5 | t(a_{5 min}) | t(a_{5 mod}) | t(a_{5 max}) |
| Stone | 20 d | 25 d | 35 d |
| Sidings & | | | |
| Tile Roofing | | | |
| a6 | t(a_{6 min}) | t(a_{6 mod}) | t(a_{6 max}) |
| Landscaping | 12 d | 15 d | 20 d |

Below, the values in Table 29 provide us with the starting point for assessing the PERT-Beta time probability distributions of each project activity. Table 29 reproduces from Table 26 the Activities' Most Likely Expected Time Increase by Endogenous Contingent Risk Factors:

TABLE 29
Activities’ Percentagewise Most Likely Expected Activity Time
Increase by Endogenous/Contingent Risk Factors Project Rosedale

| | | | | | Stone | |
|---|---|---|---|---|---|---|
| | | | Structure | Electrical & | Sidings & | Landscaping |
| Project | Excavation | Foundations | & Roof | Plumbing | Roofing | Tile |
| Activities | a₁ | a₂ | a₃ | a₄ | a₅ | a₆ |
| Activities’ | f_{NC;1}^{E} = | f_{NC;2}^{E} = | f_{NC;3}^{E} = | f_{NC;4}^{E} = | f_{NC;5}^{E} = | f_{NC;6}^{E} = |
| Percentage- | = 0.00 | = 0.12 | = 0.405 | = 0.345 | = 0.10 | = 0.0 |
| wise | | | | | | |
| Most | | | | | | |
| Likely | | | | | | |
| Expected | | | | | | |
| Time | | | | | | |
| Increase | | | | | | |
| by | | | | | | |
| Exogenous/ | | | | | | |
| Contingen | | | | | | |
| Risk | | | | | | |
| Factors | | | | | | |

Once each project activity's time triplet is obtained, one may assess their endogenous N-time probability distributions followed by the project's N-time probability distribution from its expected value and standard deviation (step 1604). Assessing each activity's time-triplet is necessary in order to derive their PERT-Beta N-time expected value, variance, & standard deviation. Combining the data from Table 26 and Table 27, one obtains the following augmented activity time estimates (step 1804):

$$Activity {a}_{1} : Excavation \\ ( {f}_{N , 1}^{E} = 0. ) \\ \{ \begin{matrix}{T}_{N , 1 m i n} = {T}_{0 , 1 m i n} ( 1 + {f}_{NC , 1}^{E} ) = 1 \times 1. = 1 \\ {T}_{N , 1 mo d} = {T}_{0 , 1 mo d} ( 1 + {f}_{NC , 1}^{E} ) = 2 \times 1. = 2 \\ {T}_{N , 1 m ax} = {T}_{0 , 1 m ax} ( 1 + {f}_{NC , 1}^{E} ) = 5 \times 1. = 5\end{matrix}$$

$$Hence : \\ \{ \begin{matrix}E ( {T}_{N ; 1} ) = ( 1 + ( 4 \times 2 ) + 5 ) / 6 = 2.33 d \\ V ( {T}_{N ; 1} ) = {( 5 - 1 )}^{2} / 36 = 0.444444 {d}^{2} \\ σ ( {T}_{N ; 1} ) = \sqrt{0.444444} = 0.667 d\end{matrix}$$

$$Activity {a}_{2} : Foundations \\ ( {f}_{N , 2}^{E} = 0.12 ) \\ \{ \begin{matrix}{T}_{N , 2 m i n} = {T}_{0 , 2 m i n} ( 1 + {f}_{NC , 2}^{E} ) = 3 \times 1.12 = 3.36 \\ {T}_{N , 2 m o d} = {T}_{0 , 2 mo d} ( 1 + {f}_{NC , 2}^{E} ) = 4 \times 1.12 = 4.48 \\ {T}_{N , 2 m ax} = {T}_{0 , 2 m ax} ( 1 + {f}_{NC , 2}^{E} ) = 6 \times 1.12 = 6.72\end{matrix}$$

$$Hence : \\ \{ \begin{matrix}E ( {T}_{N ; 2} ) = ( 3.36 + ( 4 \times 4.48 ) + 6.72 ) / 6 = 4.67 d \\ V ( {T}_{N ; 2} ) = {( 6.72 - 3.36 )}^{2} / 36 = 0.3136 {d}^{2} \\ σ ( {T}_{N ; 2} ) = \sqrt{0.3136} = 0.56 d\end{matrix}$$

$$Activity {a}_{3} : Structure \& Roof \\ ( {f}_{N , 3}^{E} = 0.405 ) \\ \{ \begin{matrix}{T}_{N , 3 m i n} = {T}_{0 , 3 m i n} ( 1 + {f}_{NC , 3}^{E} ) = 25 \times 1.405 = 35.125 \\ {T}_{N , 3 m o d} = {T}_{0 , 3 m od} ( 1 + {f}_{NC , 3}^{E} ) = 30 \times 1.405 = 42.15 \\ {T}_{N , 3 m ax} = {T}_{0 , 3 m ax} ( 1 + {f}_{NC , 3}^{E} ) = 40 \times 1.405 = 56.2\end{matrix}$$

$$Hence : \\ \{ \begin{matrix}E ( {T}_{N ; 3} ) = ( 35.125 + ( 4 \times 42.15 ) + 56.2 ) / 6 = 43.32 d \\ V ( {T}_{N ; 3} ) = {( 56.2 - 35.125 )}^{2} / 36 = 12.3376 {d}^{2} \\ σ ( {T}_{N ; 2} ) = \sqrt{12.3376} = 3.51 d\end{matrix}$$

$$Activity {a}_{4} : Electrical \& Plumbing \\ ( {f}_{NC , 4}^{E} = 0.345 ) \\ \{ \begin{matrix}{T}_{N , 4 m i n} = {T}_{0 , 4 m i n} ( 1 + {f}_{NC , 4}^{E} ) = 15 \times 1.345 = 20.175 \\ {T}_{N , 4 mo d} = {T}_{0 , 4 mo d} ( 1 + {f}_{NC , 4}^{E} ) = 20 \times 1.345 = 26.9 \\ {T}_{N , 4 m ax} = {T}_{0 , 4 ma x} ( 1 + {f}_{NC , 4}^{E} ) = 30 \times 1.345 = 40.35\end{matrix}$$

$$Hence : \\ \{ \begin{matrix}E ( {T}_{N ; 4} ) = ( 20.175 + ( 4 \times 26.9 ) + 40.35 ) / 6 = 28.02 d \\ V ( {T}_{N ; 4} ) = {( 40.35 - 20.175 )}^{2} / 36 = 11.3064 {d}^{2} \\ σ ( {T}_{N ; 4} ) = \sqrt{11.3064} = 3.3625 d\end{matrix}$$

$$Activity {a}_{5} : Stone Walling \& Tile Roofing \\ ( {f}_{NC , 5}^{E} = 0.1 ) \\ \{ \begin{matrix}{T}_{N , 5 m i n} = {T}_{0 , 5 m i n} ( 1 + {f}_{NC , 5}^{E} ) = 20 \times 1.1 = 22 \\ {T}_{N , 5 m od} = {T}_{0 , 5 mo d} ( 1 + {f}_{NC , 5}^{E} ) = 25 \times 1.1 = 27.5 \\ {T}_{N , 5 m ax} = {T}_{0 , 5 m ax} ( 1 + {f}_{NC , 5}^{E} ) = 35 \times 1.1 = 38.5\end{matrix}$$

$$Hence : \\ \{ \begin{matrix}E ( {T}_{N ; 5} ) = ( 22 + ( 4 \times 27.5 ) + 38.5 ) / 6 = 28.4 d \\ V ( {T}_{N ; 5} ) = {( 38.5 - 22 )}^{2} / 36 = 7.5625 {d}^{2} \\ σ ( {T}_{N ; 5} ) = \sqrt{7.5625} = 2.75 d\end{matrix}$$

$$Activity {a}_{6} : Landscaping \\ ( {f}_{NC , 6}^{E} = 0. ) \\ \{ \begin{matrix}{T}_{N , 6 m i n} = {T}_{0 , 6 m i n} ( 1 + {f}_{NC , 6}^{E} ) = 12 \times 1. = 12 \\ {T}_{N , 6 m od} = {T}_{0 , 6 m o d} ( 1 + {f}_{NC , 6}^{E} ) = 15 \times 1. = 15 \\ {T}_{N , 6 m ax} = {T}_{0 , 6 m ax} ( 1 + {f}_{NC , 6}^{E} ) = 20 \times 1. = 20\end{matrix}$$

$$Hence : \\ \{ \begin{matrix}E ( {T}_{N ; 6} ) = ( 12 + ( 4 \times 15 + 20 ) / 6 = 15.34 d \\ V ( {T}_{N ; 6} ) = {( 20 - 12 )}^{2} / 36 = 1.78 {d}^{2} \\ σ ( {T}_{N ; 6} ) = \sqrt{1.78} = 1.34 d\end{matrix}$$

As discussed above, from these endogenous activity time expected value and variances, one can assess the project expected cost or mean cost by adding the project activities' expected costs, while the project's endogenous time variance will be obtained by adding the project activities' endogenous time variances. Hence, one derives the project's endogenous time standard deviation.

Table 30 below summarizes the statistical calculations performed on each activity when subjected to endogenous risk factors, including, on the last line, the total endogenous expected value, variance and standard deviation as computed in step 1806:

TABLE 30
Project Rosedale
Expected Value, Variance, & Standard Deviation of Project and its
Activities' Construction Times From Endogenous Risk Factors

| | | | Standard |
|---|---|---|---|
| | Expected Value | Variance | Deviation |
| Activity | E(T_{N; i}) | V(T_{N, i}) | σ(T_{N, i}) = \sqrt{V(T_{N, i})} |
| a₁ | 2.33d | 0.444444d² | 0.667 d |
| Excavation | | | |
| a₂ | 4.67d | 0.3136 d² | 0.56d |
| Foundations | | | |
| a₃ | 43.32d | 12.3376d² | 3.51d |
| Structure & Roof | | | |
| a₄ | 28.02d | 11.3064d² | 3.36d |
| Electrical & | | | |
| Plumbing | | | |
| a₅ | 28.4 d | 7.5625d² | 2.75d |
| Stone Sidings & | | | |
| Tile Roofing | | | |
| a₆ | 15.34d | 1.78d² | 1.34d |
| Landscaping | | | |
| Total Endogenous Construction Time of Residence | $\begin{matrix}E ( {T}_{N} ) = \\ {\sum }_{i = 1}^{n} E ( {T}_{N ; i} ) = \\ {µ}_{{T}_{N}} = 122.04 d\end{matrix}$ | $\begin{matrix}V ( {T}_{N} ) = \\ {\sum }_{i = 1}^{n} V ( {T}_{N , i} ) = \\ {σ}_{{T}_{N}}^{2} = 33.7262 {d}^{2}\end{matrix}$ | $\begin{matrix}σ ( {T}_{N} ) = \\ \sqrt{{\sum }_{i = 1}^{n} V ( {T}_{N ; i} )} = \\ {σ}_{{T}_{N}} = 5.8 d\end{matrix}$ |

The expected endogenous construction time of each residence is 126.5 days, which is a 31.8% time increase with respect to its basic initial time estimate of 96 days. We assume that the probability distribution of the project endogenous N-time is Normal with an expected value of μ_{T}_{_{N}}=122 d and a standard deviation of σ_{T}_{_{N}}=5.80d, i.e.:

T_{N}˜N(μ_{T}_{_{N}}=122d;σ_{T}_{_{N}}=5.80d) (106).

Assessing the Activities' PERT-Beta Time Probability Distributions Subjected to Exogenous Risk Factors: The Exogenous X-Time Normal Probability Distribution

With reference to Table 28 above, the project X-time probability distribution assessment process starts with the assessment of the activities' time triplets. Once each project activity's time triplet is obtained one may assess their exogenous expected values and variances followed by the project's X-time probability distribution from its expected value and standard deviation. The project X-time probability distribution assessment process starts with the assessment of the activities' time triplets. Thus, at step 1854:

$$Activity {a}_{1} : Excavation \\ ( {f}_{XC ; 1}^{E} = 0.105 ) \\ \{ \begin{matrix}{T}_{X , 1 m i n} = {T}_{0 , 1 m i n} \times {f}_{XC , 1}^{E} = 1 \times 0.105 = 0.105 \\ {T}_{X , 1 m od} = {T}_{0 , 1 m od} \times {f}_{XC , 1}^{E} = 2 \times 0.105 = 0.21 \\ {T}_{X , 1 ma x} = {T}_{0 , 1 m ax} \times {f}_{XC , 1}^{E} = 5 \times 0.105 = 0.525\end{matrix}$$

$$Hence : \\ \{ \begin{matrix}E ( {T}_{X ; 1} ) = ( 0.105 + ( 4 \times 0.21 ) + 0.525 ) / 6 = 0.245 d \\ V ( {T}_{X ; 1} ) = {( 0.525 - 0.105 )}^{2} / 36 = 0.0049 {d}^{2} \\ σ ( {T}_{X ; 1} ) = \sqrt{0.0049} = 0.07 d\end{matrix}$$

$$Activity {a}_{2} : Foundations \\ ( {f}_{XC ; 2}^{E} = 0.1 ) \\ \{ \begin{matrix}{T}_{X , 2 m i n} = {T}_{0 , 2 m i n} \times {f}_{XC , 2}^{E} = 3 \times 0.1 = 0.3 \\ {T}_{X , 2 m od} = {T}_{0 , 2 mo d} \times {f}_{XC , 2}^{E} = 4 \times 0.1 = 0.4 \\ {T}_{X , 2 m ax} = {T}_{0 , 2 ma x} \times {f}_{XC , 2}^{E} = 6 \times 0.1 = 0.6\end{matrix}$$

$$Hence : \\ \{ \begin{matrix}E ( {T}_{X ; 2} ) = ( 0.3 + ( 4 \times 0.4 ) + 0.6 ) / 6 = 0.4167 d \\ V ( {T}_{X ; 2} ) = {( 0.6 - 0.3 )}^{2} / 36 = 0.0025 {d}^{2} \\ σ ( {T}_{X ; 2} ) = \sqrt{0.0025} = 0.05 d\end{matrix}$$

$$Activity {a}_{3} : Structure \& Roof \\ ( {f}_{XC ; 3}^{E} = 0.15 ) \\ \{ \begin{matrix}{T}_{X , 3 m i n} = {T}_{0 , 3 m i n} \times {f}_{XC , 3}^{E} = 25 \times 0.15 = 3.75 \\ {T}_{X , 3 m od} = {T}_{0 , 3 m od} \times {f}_{XC , 3}^{E} = 30 \times 0.15 = 4.5 \\ {T}_{X , 3 m ax} = {T}_{0 , 3 ma x} \times {f}_{XC , 3}^{E} = 40 \times 0.15 = 6.\end{matrix}$$

$$Hence : \\ \{ \begin{matrix}E ( {T}_{X ; 3} ) = ( 3.75 + ( 4 \times 4.5 ) + 6. ) / 6 = 4.625 d \\ V ( {T}_{X ; 3} ) = {( 6 - 3.75 )}^{2} / 36 = 0.14625 {d}^{2} \\ σ ( {T}_{X ; 3} ) = \sqrt{0.14625} = 0.375 d\end{matrix}$$

$$Activity {a}_{4} : Electrical \& Plumbing \\ ( {f}_{XC ; 4}^{E} = 0.1 ) \\ \{ \begin{matrix}{T}_{X , 4 m i n} = {T}_{0 , 4 m i n} \times {f}_{XC , 4}^{E} = 15 \times 0.1 = 1.5 \\ {T}_{X , 4 m od} = {T}_{0 , 4 m od} \times {f}_{XC , 4}^{E} = 20 \times 0.1 = 2 \\ {T}_{X , 4 m ax} = {T}_{0 , 4 m ax} \times {f}_{XC , 4}^{E} = 30 \times 0.1 = 3\end{matrix}$$

$$Hence : \\ \{ \begin{matrix}E ( {T}_{X ; 4} ) = ( 1.5 + ( 4 \times 2 ) + 3 ) / 6 = 2.0833 d \\ V ( {T}_{X ; 4} ) = {( 3 - 1.5 )}^{2} / 36 = 0.0625 {d}^{2} \\ σ ( {T}_{X ; 4} ) = \sqrt{0.0625} = 0.25 d\end{matrix}$$

$$Activity {a}_{5} : Stone Walling \& Roof Tiling \\ ( {f}_{XC ; 5}^{E} = 0.23 ) \\ \{ \begin{matrix}{T}_{X , 5 m i n} = {T}_{0 , 5 m i n} \times {f}_{XC , 5}^{E} = 20 \times 0.23 = 4.6 \\ {T}_{X , 5 m od} = {T}_{0 , 5 mo d} \times {f}_{XC , 5}^{E} = 25 \times 0.23 = 5.75 \\ {T}_{X , 5 m ax} = {T}_{0 , 5 m ax} \times {f}_{XC , 5}^{E} = 35 \times 0.23 = 8.05\end{matrix}$$

$$Hence : \\ \{ \begin{matrix}E ( {T}_{X ; 5} ) = ( 4.6 + ( 4 \times 5.75 ) + 8.05 ) / 6 = 5.94 d \\ V ( {T}_{X ; 5} ) = {( 8.05 - 4.6 )}^{2} / 36 = 0.330625 {d}^{2} \\ σ ( {T}_{X ; 5} ) = \sqrt{0.330625} = 0.575 d\end{matrix}$$

$$Activity {a}_{6} : Landscaping \\ ( {f}_{XC ; 6}^{E} = 0.125 ) \\ \{ \begin{matrix}{T}_{X , 6 m i n} = {T}_{0 , 6 m i n} \times {f}_{XC , 6}^{E} = 12 \times 0.125 = 1.5 \\ {T}_{X , 6 mo d} = {T}_{0 , 6 m od} \times {f}_{XC , 6}^{E} = 15 \times 0.125 = 1.875 \\ {T}_{X , 6 m ax} = {T}_{0 , 6 m ax} \times {f}_{XC , 6}^{E} = 20 \times 0.125 = 2.5\end{matrix}$$

$$Hence : \\ \{ \begin{matrix}E ( {T}_{X ; 6} ) = ( 1.5 + ( 4 \times 1.875 ) + 2.5 ) / 6 = 1.92 d \\ V ( {T}_{X 6} ) = {( 2.5 - 1.5 )}^{2} / 36 = 0.027777 {d}^{2} \\ σ ( {T}_{X ; 6} ) = \sqrt{0.027777} = 0.166666 d\end{matrix}$$

As discussed above, from these exogenous activity cost triplets, one can assess the project expected exogenous X-cost or mean X-cost by adding the project activities' expected X-cost, and their project's exogenous time variance by adding the project activities' exogenous time variances, from which one derives the project's exogenous time standard deviation.

Table 31, below, summarizes the exogenous time expected values, variances, and standard deviations of each activity and those of the project. These exogenous times represent additional times generated by exogenous risk factors. Once more, the total exogenous time expected value, variance and standard deviation is shown on the last line, as computed in step 1856:

TABLE 30
Project Rosedale
Expected Value, Variance, & Standard Deviation of Project and its Activities'
Construction Time Increases From Exogenous Risk Factors

| | Expected Value | Variance | Standard Deviation |
|---|---|---|---|
| Activity | E(T_{X, i}) | V(T_{X, i}) | σ(T_{X, i}) = \sqrt{V(T_{X, i})} |
| a1 | 0.245d | 0.0049d² | 0.07d |
| Excavation | | | |
| a2 | 0.4167d | 0.0025d² | 0.05d |
| Foundations | | | |
| a3 | 4.625d | 0.14625d² | 0.375d |
| Structure & Roof | | | |
| a4 | 2.0833d | 0.0625d² | 0.25d |
| Electrical & | | | |
| Plumbing | | | |
| a5 | 5.94d | 0.330625d² | 0.575d |
| Stone Sidings & | | | |
| Tile Roofing | | | |
| a6 | 1.92d | 0.027777d² | 0.166666d |
| Landscaping | | | |
| Total Exogenous Construction Time of Residence | $\begin{matrix}E ( {T}_{X} ) = {\sum }_{i = 1}^{n} E ( {T}_{X ; i} ) = \\ {μ}_{{T}_{X}} = 15.23 d\end{matrix}$ | $\begin{matrix}V ( {T}_{X} ) = {\sum }_{i = 1}^{n} V ( {T}_{X , i} ) = \\ {σ}_{{T}_{X}}^{2} = 0.5689275 {d}^{2}\end{matrix}$ | $\begin{matrix}σ ( {T}_{X} ) = \sqrt{{\sum }_{i = 1}^{n} V ( {T}_{X ; i} )} = \\ {σ}_{{T}_{X}} = 0.75 d\end{matrix}$ |

Thus, in this example, the additional expected times generated by exogenous risk factors to complete the residential project amount to 15.23 days. Assuming that exogenous times follow a Normal probability distribution, with expected value of μ_{T}_{_{X}}=15.23 d and standard deviation of σ_{T}_{_{X}}=0.75d then one concludes that the value of additional project times generated by exogenous risk factors will comply with the following Normal probability distribution:

T_{X}˜N(μ_{T}_{_{X}}=15.23d;σ_{T}_{_{X}}=0.75d) (107).

### Project & Management Time Contingency Reserves for Endogenous & Exogenous Risk Factors

Having at our disposal the time probability distributions respectively of endogenous and exogenous risk factors, we may now assess (step 1506) their respective operational endogenous and strategic exogenous time contingency reserve and time budgets. The project endogenous and exogenous N-time and X-time probability distributions were respectively assessed at:

T_{N}˜N(μ_{T}_{_{N}}=122.0d;σ_{T}_{_{N}}=5.80d)

and: T_{X}˜N(μ_{T}_{_{X}}=15.23d;σ_{T}_{_{X}}=0.75d).

In this example, the project significance level has been set by upper management at (1−α)=0.15, while the management significance level has been set at (1−α′)=0.05.

From a Normal standardized probability distribution, it therefore follows that the project endogenous N-time baseline will be set rat:

$$\{ \begin{matrix}{T}_{B ; N}^{z ( α = 0.85 ) = 1} = {μ}_{{T}_{N}} + z ( α = 0.85 ) {σ}_{{T}_{N}} \\ {T}_{B ; N}^{z ( α = 0.85 ) = 1} = {μ}_{{T}_{N}} + 1 {σ}_{{T}_{N}} = 122 + 5.8 \\ {T}_{B ; N}^{z ( α = 0.85 ) = 1} = 127.8 d .\end{matrix}$$

As shown in Table 33 below, one can readily determine the project endogenous N-time contingency reserve:

$$\{ \begin{matrix}{CR}_{{T}_{N}}^{z ( α = 0.85 )} = ψ ( z ( α = 0.85 ) ) {σ}_{{T}_{N}} \\ {CR}_{{T}_{N}}^{z ( α = 0.85 )} = 0.08327 {σ}_{{C}_{T}} \\ {CR}_{{T}_{N}}^{z ( α = 0.85 )} = 0.08327 \times 5.8 = 0.482 d .\end{matrix}$$

Hence, one can determine the project time budget at:

$$\{ \begin{matrix}{B}_{{T}_{N}}^{z ( α = 0.85 )} = {T}_{B ; N}^{z ( α )} + {CR}_{{T}_{N}}^{z ( α )} . \\ {B}_{{T}_{N}}^{z ( α = 0.85 )} = 127.8 + 0.482 = 128.28 d .\end{matrix}$$

Similarly, the management exogenous X-time baseline will be set at:

$$\{ \begin{matrix}{T}_{B ; X}^{z ( {α}^{′} = 0.95 ) = 1.65} == {μ}_{{T}_{X}} + z ( α = 0.95 ) {σ}_{{T}_{X}} . \\ {T}_{B ; X}^{z ( {α}^{′} = 0.95 ) = 1.65} = {μ}_{{T}_{X}} + 1.65 {σ}_{{T}_{X}} \\ \begin{matrix}{T}_{B ; X}^{z ( {α}^{′} = 0.95 ) = 1.65} = 15.23 + ( 1.65 \times 0.75 ) = \\ 16.4675 d ≅ 16.47 d .\end{matrix}\end{matrix}$$

One can readily determine the management exogenous X-time contingency reserve as:

$$\{ \begin{matrix}{CR}_{{T}_{X}}^{z ( {α}^{′} = 0.95 )} = ψ ( z ( {α}^{′} = 0.95 ) ) {σ}_{{T}_{X}} \\ {CR}_{{T}_{X}}^{z ( {α}^{′} = 0.95 )} = 0.01976 {σ}_{{T}_{X}} \\ {CR}_{{T}_{X}}^{z ( {α}^{′} = 0.95 )} = 0.01976 \times 0.75 = 0.01482 d \approx 0 d .\end{matrix}$$

Hence, one can determine the management time budget at:

$$\{ \begin{matrix}{B}_{{T}_{X}}^{z ( {α}^{′} = 0.95 )} = {T}_{B ; X}^{z ( {α}^{′} = 0.95 )} + {CR}_{{T}_{X}}^{z ( {α}^{′} = 0.95 )} . \\ {B}_{{T}_{X}}^{z ( {α}^{′} = 0.95 )} = 16.4675 + 0 = 16.4675 d ≅ 16.47 d .\end{matrix}$$

Table 32 below summarizes all these results, including the program time budget, which includes the time baseline and the time overrun contingency reserve as computed at step 1508:

TABLE 32
Project, Management & Program
Time Baselines, Time Overrun Contingency Reserves & Budgets from Endogenous & Exogenous Normal Time
Probability Distributions of a Single-Project Program with the Expected Time Overrun Risk Measure

| Size of | | | |
|---|---|---|---|
| Program/Portfolio | Time | Time Overrun | Time |
| K = 1 | Baseline | Contingency Reserve | Budget |
| Project | Project Time | Project Time Overrun | Project Time |
| N-Time PDF | Baseline | Contingency Reserve | Budget |
| T_{N}~N(μ_{T}_{_{N}} = 126.56. d; | T_{B;N}^{z(α)} = μ_{T}_{_{N}} + z(α)σ_{T}_{_{N}} | CR_{T}_{_{N}}^{z(α)} = ETO_{N}^{z(α)} = | B_{T}_{_{N}}^{z(α)} = T_{B,;N}^{z(α)} + CR_{T}_{_{N}}^{z(α)} |
| σ_{T}_{_{N}} = 6.69 d) | T_{B;N}^{z(α=0.85)} = 127.80d | σ_{T}_{_{N}}ψ(z(α))CR_{T}_{_{N}}^{z(α=0.85)} = | B_{T}_{_{N}}^{z(α=0.85)} = 128.82d |
| (α = 0.85) | | 0.482d | |
| Management | Management Time | Mngt Time Overrun | Management Time |
| X-Time PDF | Baseline | Contingency Reserve | Budget |
| T_{X}~N(μ_{T}_{_{X}} = 15.23d; | T_{B;X}^{z(α′)} = | CR_{T}_{_{X}}^{z(α′)} = EtO_{X}^{z(α′)} = | B_{T}_{_{X}}^{z(α′)} = T_{B; X}^{z(α′)} + CR_{T}_{_{X}}^{z(α′)} |
| σ_{T}_{_{X}} = 0.75 d) | μ_{T}_{_{X}} + z(α′)σ_{T}_{_{X}} | σ_{T}_{_{X}}ψ(z(α′)) | B_{T}_{_{X}}^{z(α′=0.95)} = 16.47d |
| (α′ = 0.95) | T_{B;X}^{z(α′=0.95)} = 16.47d | CR_{T}_{_{X}}^{z(α′=0.95)} = 0d | |
| Program | Program Time | Program Time Overrun | Program Time |
| Project Times | Baseline | Contingency Reserve | Budget |
| & | T_{B; NX} = T_{B;N}^{z(α)} + T_{B;X}^{z(α′)} | CR_{T}_{_{NX}} = CR_{T}_{_{N}}^{z(α)} + CR_{T}_{_{X}}^{z(α′)} | B_{T}_{_{NX}} = B_{T}_{_{N}}^{z(α)} + B_{T}_{_{X}}^{z(α′)} |
| Management Times | T_{B; NX} = 149.72 d | CR_{T}_{_{NX}} = 0.56d | B_{T}_{_{NX}} = T_{B;NX} + CR_{T}_{_{NX}} |
| | | | B_{T}_{_{NX}} = 150.28 d |

$ψ ( z ( α ) ) = \frac{1}{\sqrt{2 π}} exp [ - \frac{{z}^{2} ( α )}{2} ] - z ( α ) {F}_{N} ( - z ( α ) )$

Table 33 below summarizes different time-related outputs as a function of the project z(α) Policy, in accordance with one embodiment:

TABLE 33
The Project z(α) Policy, Time Contingency Reserve & Budget Under a Normal Cost
Probability Distribution with the Expected Time Overrun Risk Measure

| Project Time | | | | |
|---|---|---|---|---|
| Overrun | | | Project Time Overrun | Project Time |
| Probability: | Project Time | Project Time | Contingency Reserve | Budget |
| Significance Level | Budgeting | Baseline | CR_{T}^{z(α)} = | B_{T}^{z(α)} = |
| Pr(T ≥ T_{B}^{z(α)}) = | Policy | T_{B}^{z(α)} = | ETO^{z(α)} = | T_{B}^{z(α)} + |
| PTO^{z(α)} = 1 − α | z(α) | μ_{T} + z(α)σ_{T} | σ_{T} ψ(z(α)) | CR_{T}^{z(α)} |
| 0.50 | 0 | μ_{T} | 0.39894σ_{T} | μ_{T} + 0.3989 σ_{T} |
| 0.40 | 0.25 | μ_{C} + 0.25 σ_{T} | 0.28666σ_{T} | μ_{C} + 0.53667σ_{T} |
| 0.30 | 0.525 | μ_{C} + 0.525 σ_{T} | 0.19008σ_{T} | μ_{C} + 0.7151 σ_{T} |
| 0.20 | 0.84 | μ_{C} + 0.84 σ_{T} | 0.11234σ_{T} | μ_{C} + 0.95234 σ_{T} |
| 0.15 | 1 | μ_{T} + σ_{T} | 0.08327σ_{T} | μ_{T} + 1.08327 σ_{T} |
| 0.10 | 1.28 | μ_{T} + 1.28σ_{T} | 0.04785 σ_{C} | μ_{C} + 1.32785σ_{C} |
| 0.05 | 1.65 | μ_{T} + 1.65σ_{T} | 0.01976σ_{T} | μ_{T} + 1.66976 σ_{T} |
| 0.0228 | 2 | μ_{T} + 2σ_{T} | 0.00839σ_{T} | μ_{T} + 2.00839 σ_{T} |
| 0.01 | 2.33 | μ_{T} + 2.33σ_{T} | 0.003126σ_{T} | μ_{T} + 2.33312 σ_{T} |

$ψ ( z ( α ) ) = \frac{1}{\sqrt{2 π}} exp [ - \frac{{z}^{2} ( α )}{2} ] - z ( α ) {F}_{N} ( - z ( α ) )$
PROJECT TIME PDF T~N(μ_{T}; σ_{T})

### The Replicated-Project Portfolio

Once more, the above-computed quantities will be used to apply method 2600 for a project portfolio. Again, at step 2602, replicated portfolio-related information 2406 is acquired. However, the endogenous and exogenous probability distributions have already been computed above. It has been established above that the single-family residence endogenous time durations of construction would comply with a Normal probability distribution such that:

T_{N}˜N(μ_{T}_{_{N}}=122.0d;σ_{T}_{_{N}}=5.80d)

while additional time durations generated by exogenous risk factors would also be described also by a Normal probability distribution such that:

T_{X}˜N(μ_{T}_{_{X}}=15.23d;σ_{T}_{_{X}}=0.75d).

Assessing the construction costs of a portfolio of 9 replicated units would involve a reassessment of the risks of the residential development program. Portfolio risk diversification effects must be accounted for through the portfolio time durations variance. In that respect, the project CE of Domotek Construction Inc. has assessed from Table 34 the correlation coefficients 2304 between project endogenous time durations and project exogenous time durations. The CE has estimated that the project correlation coefficient between project endogenous time durations as strong and therefore set at ρ_{N}=0.80 while the project correlation coefficient between project exogenous time durations has been assessed as Moderate and therefore set at ρ_{X}=0.45.

TABLE 34
Correlation Coefficients between
Project Construction Costs

| Correlation Coefficient | |
|---|---|
| Between Project Costs | ρ |
| Weak | 0.15 |
| Moderate | 0.45 |
| Strong | 0.80 |

Then, at step 2604, the expected endogenous N-times of Phase I Manor Program is estimated at:

$$\{ \begin{matrix}E ( {T}_{N , K = 9} ) = {μ}_{{T}_{N} , K = 9} = {\sum }_{j = 1}^{K = 9} E ( {T}_{N} ) = K {μ}_{{T}_{N}} \\ E ( {C}_{T , K = 9} ) = {μ}_{{T}_{N} , K = 9} = 9 \times 122. d \\ E ( {C}_{T , K = 9} ) = {μ}_{{T}_{N} , K = 9} = 1 , 98. d\end{matrix}$$

while its expected exogenous X-times of program The Manor are estimated at:

$$\{ \begin{matrix}E ( {T}_{X , K = 9} ) = {μ}_{{T}_{X} ; K = 9} = {\sum }_{j = 1}^{K = 9} E ( {T}_{X} ) = K {μ}_{{T}_{X}} \\ E ( {T}_{X , K = 9} ) = {μ}_{{T}_{X} ; K = 9} = 9 \times 15.23 d \\ E ( {T}_{X , K = 9} ) = 137. d .\end{matrix}$$

Phase I standard deviation of the portfolio endogenous N-times will need to account for the correlational effects between project endogenous time durations and will be assessed by:

$$\{ \begin{matrix}{σ}_{{T}_{N} ; K , {ρ}_{N}} = σ ( {T}_{N , K , {ρ}_{N}} ) = {σ}_{{T}_{N}} {ω}_{N} = {σ}_{{T}_{N}} \sqrt{K [ 1 + {ρ}_{N} ( K - 1 ) ]} \\ \begin{matrix}{σ}_{{T}_{N} ; K , {ρ}_{N}} = σ ( {T}_{N , K = 9 , {ρ}_{N} = 0.8} ) = \\ 5.8 d \sqrt{9 [ 1 + ( 0.8 ) ( 8 ) ]} = 5.8 d \times 8.16\end{matrix} \\ {σ}_{{T}_{N} ; K , {ρ}_{N}} = σ ( {T}_{N , K = 9 , {ρ}_{N} = 0.8} ) = 47.33 d\end{matrix}$$

while Phase I standard deviation of the portfolio exogenous X-times will also need to account for the correlational effects between project exogenous times and will be assessed by:

$$\{ \begin{matrix}{σ}_{{T}_{X} ; K , {ρ}_{X}} = σ ( {T}_{X , K , {ρ}_{X}} ) = {σ}_{{T}_{X}} {ω}_{X} = {σ}_{{T}_{X}} \sqrt{K [ 1 + {ρ}_{X} ( K - 1 ) ]} \\ \begin{matrix}{σ}_{{T}_{X} ; K , {ρ}_{X}} = σ ( {T}_{X , K = 9 , {ρ}_{X} = 0.45} ) = 0.75 d \sqrt{9 [ 1 + {ρ}_{X} ( K - 1 ) ]} = \\ 0.75 d \times 6.4342\end{matrix} \\ {σ}_{{T}_{X} ; K , {ρ}_{X}} = σ ( {T}_{X , K = 9 , {ρ}_{X} = 0.45} ) = 4.825 d .\end{matrix}$$

It follows that the endogenous N-time duration probability distribution of Phase I of The Manor Program will also comply with a Normal probability distribution and will be defined by:

T_{N,K=9, ρ}_{_{N}}_{=0.80}˜N(μ_{T}_{_{N,K=9}}=1,098.0d;σ_{T}_{_{N}}_{,K=9,ρ}_{_{N}}_{=0.80}=47.33d)

while the exogenous X-time duration probability distribution of Phase I of The Manor Program will also comply with a Normal probability distribution and will be defined by:

T_{X,K=9,ρ}_{_{X}}_{=0.45}˜N(μ_{T}_{_{X,K=9}}=137.0d;σ_{T}_{_{X}}_{,K=9,ρ}_{_{X}}₌0.45=4.825d).

The endogenous N-cost baseline of The Manor Program has been set at the (1−α)=0.15 significance level, which implies a cost budgeting policy of z(α=0.85)=1. Consequently, the program endogenous N-cost baseline will be set at:

$$\{ \begin{matrix}{T}_{B ; N ; K = 9}^{z ( α = \text{.85} ) = 1} = {μ}_{{T}_{N} , K = 9} + z ( α = 0.85 ) {σ}_{{T}_{N} ; K = 9 , {ρ}_{N} = 0.8} \\ {T}_{B ; N ; K = 9}^{z ( α = \text{.85} ) = 1} = 1 , 98. d + ( 1 \times 47.33 d ) \\ {T}_{B ; N ; K = 9}^{z ( α = \text{.85} ) = 1} = 1 , 145.33 d .\end{matrix}$$

The program endogenous project time duration contingency reserve is set at:

$$\{ \begin{matrix}{CR}_{{T}_{N} , K = 9 , {ρ}_{N} = 0.8}^{z ( α = 0.85 ) = 1} = {σ}_{{T}_{N} , K , {ρ}_{N}} ψ ( z ( α = 0.85 ) ) \\ {CR}_{{T}_{N} , K = 9 , {ρ}_{N} = 0.8}^{z ( α = 0.85 ) = 1} = 0.08327 {σ}_{{T}_{N} , K , {ρ}_{N}} = 0.08327 \times 47.33 d ) \\ {CR}_{{T}_{N} ; K = 9 , {ρ}_{N} = 0.8}^{z ( α = 0.85 ) = 1} = 3.94 d .\end{matrix}$$

Consequently, the program endogenous project budget will be estimated at:

$$\{ \begin{matrix}{B}_{{T}_{N} ; K = 9}^{z ( {α}^{′} = 0.85 ) = 1} = {T}_{B ; N ; K = 9}^{z ( α = 0.85 )} + {CR}_{{T}_{N} , K = 9 , {ρ}_{N} = 0.8}^{z ( α = 0.85 )} \\ {B}_{{T}_{N} ; K = 9}^{z ( {α}^{′} = 0.85 ) = 1} = 1 , 145.33 d + 3.94 d \\ {B}_{{T}_{N} ; K = 9}^{z ( {α}^{′} = 0.85 ) = 1} = 1 , 149.27 d .\end{matrix}$$

Turning our attention to The Manor Program exogenous X-time duration, its baseline has been set at the (1−α′)=0.05 significance level, which implies a cost budgeting policy of z(α′=0.95)=1.65. Consequently, the program exogenous X-cost baseline will be set at:

$$\{ \begin{matrix}{T}_{B ; X ; K = 9}^{z ( {α}^{′} = \text{.95} ) = 1.65} = {μ}_{{T}_{X} , K = 9} + z ( {α}^{′} = 0.95 ) {σ}_{{T}_{X} ; K = 9 , {ρ}_{X} = 0.45 )} \\ {T}_{B ; X ; K = 9}^{z ( {α}^{′} = \text{.95} ) = 1.65} = 137. d + ( 1.65 \times 4.825 d ) \\ {T}_{B ; X ; K = 9}^{z ( {α}^{′} = \text{.95} ) = 1.65} = 145. d\end{matrix}$$

while the program exogenous project contingency reserve will be set at:

$$\{ \begin{matrix}{CR}_{{T}_{X} ; K = 9 , {ρ}_{X} = 0.45}^{z ( {α}^{′} = 0.95 ) = 1.65} = {σ}_{{C}_{X} , K , {ρ}_{X}} ψ ( z ( {α}^{′} = 0.95 ) ) \\ {CR}_{{T}_{X} ; K = 9 , {ρ}_{X} = 0.45}^{z ( {α}^{′} = 0.95 ) = 1.65} = 0.01976 {σ}_{{T}_{X} , K , {ρ}_{X}} \\ {CR}_{{T}_{X} ; K = 9 , {ρ}_{X} = 0.45}^{z ( {α}^{′} = 0.95 ) = 1.65} = 0.01976 \times 4.825 d = 0.095 d .\end{matrix}$$

Consequently, the program endogenous project budget will be estimated at:

$$\{ \begin{matrix}{B}_{{T}_{X} , K = 9}^{z ( {α}^{′} = 0.95 ) = 1.65} = {T}_{B ; X ; K = 9}^{z ( {α}^{′} = 0.95 )} + {CR}_{{T}_{X} ; K = 9 , {ρ}_{X} = 0.45}^{z ( {α}^{′} = 0.95 )} \\ {B}_{{T}_{X} , K = 9}^{z ( {α}^{′} = 0.95 ) = 1.65} = 145. d + 0.095 d \\ {B}_{{T}_{X} , K = 9}^{z ( {α}^{′} = 0.95 ) = 1.65} = 145.095 d .\end{matrix}$$

Table 35, below, summarizes all these results. Included on the bottom line is the Program/Portfolio Time Baseline, Overrun Contingency Reserve and Time Budget as computed at step 2606:

TABLE 35
Project, Management & Program
Time Baselines, Time Overrun Contingency Reserves & Budgets from Endogenous & Exogenous Normal Time
Probability Distributions with The Expected Time Overrun Risk Measure for a Replicated-Project Program/Portfolio

| Size of | | Program/Portfolio | |
|---|---|---|---|
| Program/Portfolio | Program/Portfolio | Time Overrun | Program/Portfolio |
| K = 9 | Time Baselines | Contingency Reserves | Time Budgets |
| Program/Portfolio | Program/Portfolio | Program/Portfolio | Program/Portfolio |
| Project Time | Project Time | Project Time Overrun | Project Time Budget |
| N-Cost PDF | Baseline | Contingency Reserve | B_{T}_{_{N}}_{,K}^{z(α=0.85)} = |
| T_{N,K=9,} _{ρ}_{_{N}}_{=0.80}~ | T_{B; N,K,ρ}_{_{N}}^{z(α=0.85)} = | CR_{T}_{_{N}}_{;K; ρ}_{_{N}}^{z(α=0.85)} = | T_{B;NK,ρ}_{_{N}}^{z(α)} + CR_{T}_{_{N}}_{,K;ρ}_{_{N}}^{z(α)} = |
| N(μ_{T}_{_{N,K=9}} = 1,138.95 d; | μ_{T}_{_{N}}_{;K} + z(α) σ_{T}_{_{N}}_{;K; ρ}_{_{N}} = | ETO_{N;K; ρ}_{_{N}}^{z(α=0.85)} = | 1,149.27 d |
| σ_{T}_{_{N}}_{,K=9,ρ}_{_{N}}_{=0.80} = 54.59 d) | 1,145.33 d | σ_{T}_{_{N}}_{;K; ρ}_{_{N}}ψ(z(α)) = | |
| (α = 0.85) | | 3.94 d | |
| Program/Portfolio | Program/Portfolio | Program/Portfolio | Program/Portfolio |
| Management Time | Mngt Time Baseline | Mngt Time Overrun | Management Time |
| X-Cost PDF | T_{B; X,K,ρ}_{_{X}}^{z(α′=0.95)} = | Contingency Reserve | Budget |
| T_{X,K=9,ρ}_{_{X}}_{=0.45}~ | μ_{T}_{_{X}}_{;K} + z(α′) σ_{T}_{_{X}}_{,K;ρ}_{_{X}} = | CR_{T}_{_{X}}_{,K; ρ}_{_{X}}z^{(α′=0.95)} = | B_{T}_{_{X}}_{,K}^{z(α′=0.95)} = |
| N(μ_{T}_{_{X,K=9}} = 137.0 d; | 145.0 d | ETO_{X;K; ρ}_{_{X}}^{z(α′=0.95)} = | T_{B;X,K,ρ}_{_{X}}^{z(α′)} + |
| σ_{T}_{_{X}}_{,K=9,ρ}_{_{X}}_{=0.45} = 4.825 d) | | σ_{T}_{_{X}}_{,K; ρ}_{_{X}}ψ(z(α′)) = | CR_{T}_{_{X}}_{,K; ρ}_{_{X}}^{z(α′)} = 145.095 d |
| (α′ = 0.95) | | 0.095 d | |
| Program/Portfolio | Program/Portfolio | Program/Portfolio | Program/Portfolio |
| Program Times | ProgramTime | Program Time Overrun | Program Timet Budget |
| Poject Times | Baseline | Contingency Reserve | B_{T}_{_{NX}}_{;K} = T_{B; NX,K}^{z(α)} + CR_{T}^{z} [symbol] |
| & | T_{B; NX;K} = = T_{B; N,K,ρ}_{_{N}}^{z(α)} + | CR_{T}_{_{NX}}_{;K.} = ETO_{NX,K} = = | B_{T}_{_{NX}}_{;K} = B_{T}_{_{N}}_{,K;ρ}_{_{N}}^{z(α)} + |
| Management Times | T_{B; X,K,ρ}_{_{X}}^{z(α′)} = 1,290.33 d | CR_{T}_{_{N}}_{;K, ρ}_{_{N}}^{z(α)} + CR_{T}_{_{X}}_{;K, ρ}_{_{X}}^{z(α′)} = | B_{T}_{_{X}}_{;K; ρ}_{_{X}}^{z(α′)} = 1,294.365 d |
| | | 4.645d | |

$ψ ( z ( α ) ) = \frac{1}{\sqrt{2 π}} exp [ - \frac{{z}^{2} ( α )}{2} ] - z ( α ) {F}_{N} ( - z ( α ) ) ; ψ ( z ( {α}^{′} ) ) = \{ \frac{1}{\sqrt{2 π}} exp [ - \frac{{z ( {α}^{′} )}^{2}}{2} ] - z ( {α}^{′} ) {F}_{N} ( - z ( {α}^{′} ) ) \}$ [symbol]
indicates data missing or illegible when filed

From Table 35 may therefore conclude that carrying out Program Manor will require 1,294.365 days, i.e. the equivalent of 3½ years of work. This does not mean that Program Manor will be completed in 3½ years. One must make a distinction between the calendar time and the total time duration or total execution time needed by all project activities to complete and deliver Program Manor. Indeed, Program Manor could be completed within 1 year, or even 6 months if the proper construction schedule, planning, and controls are set up and the necessary resources made available.

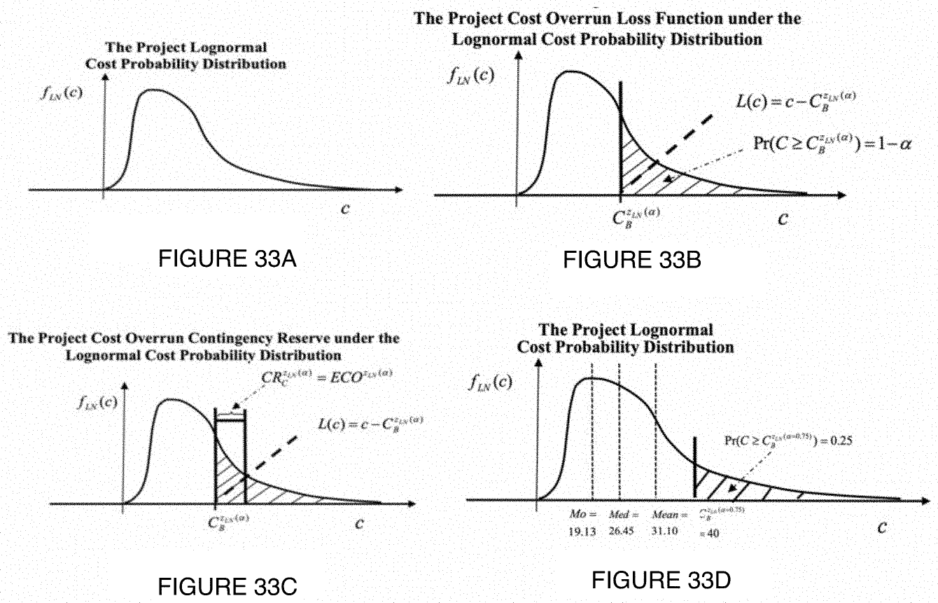

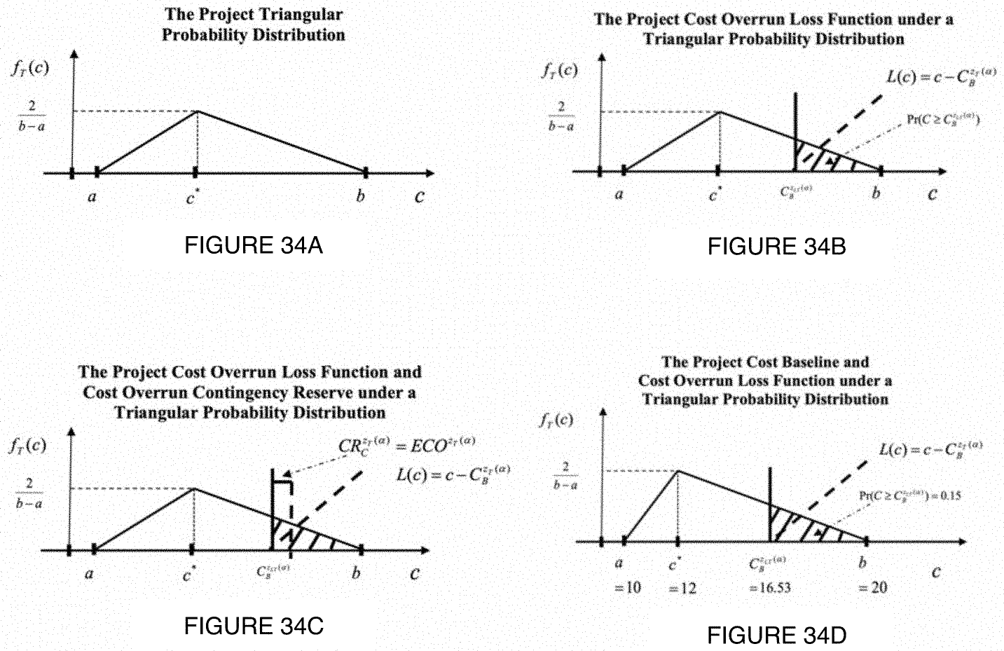

With reference to FIGS. 33A to 34D, and in accordance with one embodiment, the project Expected Cost Overrun (ECO) under a lognormal or triangular probability distributions will be discussed below.

### The Project Expected Cost Overrun Under a Lognormal Probability Distribution

Let us consider a risky capital investment project whose random cost C is governed by a lognormal probability distribution ƒ_{LN}(c) as shown in FIG. 33A. Hence, one writes: C˜LN(μ_{ln C}, σ_{ln C}²) and its probability density function (PDF) is given by:

$${f}_{LN} ( c ) = \frac{1}{c {σ}_{ln C} \sqrt{2 π}} exp [ - \frac{1}{2} {( \frac{ln c - {μ}_{ln C}}{{σ}_{ln C}} )}^{2} ] for c > 0.$$

Under the Lognormal distribution the expected value or mean is given in the lognormal scale by

$$m = E ( C ) = {e}^{( {μ}_{ln C} + \frac{{σ}_{ln C}^{2}}{2} )} = exp ( {μ}_{ln C} + \frac{{σ}_{ln C}^{2}}{2} )$$

(i.e. μ_{ln C}=ln m−½σ_{ln C}² and its variance is given by V(C)=(e^{σ}^{_{ln C}}^{²}−1)e^{(2μ}^{_{ln C}}^{+σ}^{_{ln C}}^{²})=(exp σ_{ln C}²−1)exp(2μ_{ln C}+σ_{ln C}²), while its median is given by Me_{C}=e^{μ}^{_{ln C}}=exp μ_{ln C} and its mode by Mod_{C}=e^{μ}^{_{ln C}}^{-σ}^{_{ln C}}^{²}=exp(μ_{ln C}−σ_{ln C}²).

The project cost baseline should be set at C_{B}^{z}^{_{LN}}^{(α)}=μ_{C}+z_{LN}(α)σ_{C} in compliance with the organization's z_{LN}(α) risk acceptance policy when cost risk is under a lognormal probability distribution. The magnitude of the project cost overrun or loss function L(c) with respect to a project cost baseline shall be defined, as illustrated in FIG. 33B, by the following conditional loss function:

$$\{ \begin{matrix}L ( c ) = c - {C}_{B}^{{z}_{LN} ( α )} & if c > {C}_{B}^{{z}_{LN} ( α )} \\ L ( c ) = 0 & if c \leq {C}_{B}^{{z}_{LN} ( α )}\end{matrix} .$$

Hence, we explicitly define the project Expected Cost Overrun (ECO^{z}^{_{LN}}^{(α)}) at the (1−α) significance level under a Lognormal probability density function ƒ_{LN}(c) by the following definite integral:

ECO^{z}^{_{LN}}^{(α)}=∫_{C}_{_{B}}_{^{z(α)}}^{+∞}L(c)·ƒ_{LN}(c)dc

which may be written as:

ECO^{z}^{_{LN}}^{(α)}=∫_{C}_{_{B}}_{^{z(α)}}^{+∞}(c−C_{B}^{z}^{_{LN}}^{(α)})ƒ_{LN}(c)dc.

Hence, the project ECO^{z}^{_{LN}}^{(α)} will always be tail sensitive and yield a non-negative value, i.e., ECO^{z}^{_{LN}}^{(α)}>0. By superimposing the conditional cost overrun loss function L(c) over the lognormal cost PDF ƒ_{LN}(c) one obtains FIG. 33C:

The project cost overrun contingency reserve CR_{C}^{z}^{_{LN}}^{(α)} will be set equal to the project expected cost overrun ECO^{z}^{_{LN}}^{(α)} so that cost overruns will, on average, be covered by the project cost overrun contingency reserve. A unique and exact closed-form solution to of the project ECO^{z}^{_{LN}}^{(α)} will be given by:

$${ECO}^{{z}_{LN} ( α )} = exp [ {μ}_{ln C} + \frac{{σ}_{ln C}^{2}}{2} ] Φ ( \frac{- ln {C}_{B}^{{z}_{LN} ( α )} + {μ}_{ln C} + {σ}_{ln C}^{2}}{{σ}_{ln C}} ) - {C}_{B}^{{z}_{LN} ( α )} Φ ( \frac{- ln {C}_{B}^{{z}_{LN} ( α )} + {μ}_{ln C}}{{σ}_{ln C}} )$$

where Φ(⋅)=F_{N}(⋅) is the cumulative probability distribution of a standardized N(0,1) Normal probability distribution.

In one example, let us consider a project whose cost probability distribution is Log Normal as given in table 35 below:

TABLE 35

| Cost | Mid-point of | Probability of | Cumulated | Logarithm of |
|---|---|---|---|---|
| Interval | Cost Interval | Cost Interval | Probability | Cost mid-point |
| C | c | φ(c) | Φ(c) | ln(c) |
| 0-10 | 5 | 0.05 | 0.05 | 1.6094 |
| 10-20 | 15 | 0.20 | 0.25 | 2.7080 |
| 20-30 | 25 | 0.30 | 0.55 | 3.2188 |
| 30-40 | 35 | 0.20 | 0.75 | 3.5553 |
| 40-50 | 45 | 0.15 | 0.90 | 3.8056 |
| 50-60 | 55 | 0.07 | 0.97 | 4.0073 |
| 60-70 | 65 | 0.03 | 1.00 | 4.1743 |

From the Log Normal probability density function (PDF) given by:

$${f}_{LN} ( c ) = \frac{1}{c {σ}_{ln C} \sqrt{2 π}} exp [ - \frac{1}{2} {( \frac{ln c - {μ}_{ln C}}{{σ}_{ln C}} )}^{2} ] for c > 0$$

where μ_{ln C} and σ_{ln C} are respectively the mean and standard deviation of the logarithm of project costs. Hence, the mean or expected value is given by:

μ_{ln C}=Σₖ ln cₖ·φ(cₖ)=3.2755

and its variance and standard deviation respectively are given by:

σ_{ln C}²=Σₖ(ln cₖ−μ_{ln C})²φ(cₖ)=Σₖ ln c_{k k}²·φ(cₖ)−μ_{ln C}²=0.3238

σ_{ln C}=0.5691

One may therefore determine on the cost natural scale is:

$${Mean}_{C} = {μ}_{C} = exp [ {μ}_{ln C} + \frac{{σ}_{ln C}^{2}}{2} ] = exp [ 3.2755 + \frac{0.3238}{2} ] = 31.1078$$

$${Med}_{C} = exp [ {μ}_{ln C} ] = exp [ 3.2755 ] = 26.45$$

$${Mod}_{C} = exp [ {μ}_{ln C} - {σ}_{ln C}^{2} ] = exp [ 3.2755 - 0.3238 ] = 19.13$$

$$and : V ( C ) = {σ}_{C}^{2} = ( exp [ {σ}_{ln C}^{2} ] - 1 ) exp [ 2 {μ}_{ln C} + {σ}_{ln C}^{2} ] = 369.6 .$$

Hence, its standard deviation is: σ(C)=σ_{c}=19.22. The Coefficient of Variation is given on the cost natural scale by:

CV_{C}=(exp[σ_{ln C}²]−1)^{1/2}=(exp[0.3238]−1)^{1/2}=0.6183=61.83%

which is indicative of a high volatility of the project cost probability distribution. The above discussed results are shown graphically in FIG. 33D.

Table 36 below summarizes the results obtained for the project cost overrun contingency reserve and budget under various cost budgeting policies when the project cost probability distribution is lognormal:

TABLE 36
Project Cost Overrun Contingency Reserve & Budget Under a Log Normal
Cost Probability Distribution For Various Cost Budgeting Policies
with The Expected Cost Overrun Risk Measure

| Project Cost | | Project Cost | |
|---|---|---|---|
| Overrun | | Overrun | |
| Probability: | | Contingency | Project Cost |
| Significance level | Project Cost | Reserve | Budget |
| Pr(C ≥ C_{B}^{z}^{_{LN}}^{(α)}) = | Baseline | CR_{C}^{z}^{_{LN}}^{(α)} = | B_{C}^{z}^{_{LN}}^{(α)} = |
| 1 − α | C_{B}^{z}^{_{LN}}^{(α)} | ECO^{z}^{_{LN}}^{(α)} | C_{B}^{z}^{_{LN}}^{(α)} + CR_{C}^{z}^{_{LN}}^{(α)} |
| 0.25 | 40 | 3.4941 | 43.4941 |
| 0.10 | 50 | 2.4893 | 52.4893 |
| 0.03 | 60 | 1.4849 | 61.4849 |

$\begin{matrix}{ECO}^{{z}_{LN} ( α )} = exp [ {μ}_{C} + \frac{{σ}_{C}^{2}}{2} ] Φ ( \frac{- ln {C}_{B}^{{2}_{LN} ( α )} + {μ}_{ln C}}{{σ}_{ln C}} ) - \\ {C}_{B}^{{2}_{LN} ( α )} Φ ( \frac{- ln {C}_{B}^{{2}_{LN} ( α )} + {μ}_{ln C}}{{σ}_{ln C}} )\end{matrix}$
PROJECT COST PDF C~LN(μ_{lnC} = 3.2755; σ_{lnC} = 0.5691)

### The Project Expected Cost Overrun Under a Triangular Probability Distribution

Let us consider a risky capital investment project whose random cost C is governed by a Triangular probability distribution ƒ_{T}(c) as shown in FIG. 34A.

Hence, one writes: C˜T(a, c*, b) and its probability density function (PDF) is given by:

$${f}_{T} ( c ) = \{ \begin{matrix}0 & for c < a \\ \frac{2 ( c - a )}{( b - a ) ( {c}^{*} - a )} & for a < c \leq {c}^{*} \\ \frac{2}{( b - a )} & for c = {c}^{*} \\ \frac{2 ( b - c )}{( b - a ) ( b - {c}^{*} )} & for {c}^{*} < c \leq b \\ 0 & for c > b\end{matrix} .$$

Its expected value is given by E(C)=μ_{C}=(a+c*+b)/3 and its variance is given by. σ²(C)=σ_{C}²=a²+b²+c^{*2}−ab−ac*−bc*/18.

Its median is given by:

$$Me ( C ) = a + \sqrt{\frac{( b - a ) ( {c}^{*} - a )}{2}} if {c}^{*} > \frac{a + b}{2}$$

$$Me ( C ) = a - \sqrt{\frac{( b - a ) ( {c}^{*} - a )}{2}} if {c}^{*} < \frac{a + b}{2} .$$

The project cost baseline should be set at C_{B}^{z}^{_{T}}^{(α)} in compliance with the organization's z(α) risk acceptance policy when cost risk is under a triangular probability distribution.

As shown in FIG. 34B, the magnitude of the project cost overrun or loss function L(c) with respect to a project cost baseline shall be defined by the following conditional loss function:

$$\{ \begin{matrix}L ( c ) = c - {C}_{B}^{{z}_{T} ( α )} & if c > {C}_{B}^{{z}_{T} ( α )} \\ L ( c ) = 0 & if c \leq {C}_{B}^{{z}_{T} ( α )}\end{matrix} .$$

The loss function L(C) is defined over the right part of the PDF, i.e.:

$${f}_{T} ( c ) = \frac{2 ( b - c )}{( b - a ) ( b - {c}^{*} )} for {c}^{*} < {C}_{B}^{{z}_{LT} ( α )} < c \leq b$$

hence the Expected Cost Overrun (ECO) will be defined by the following definite integral (as shown in FIG. 34C):

$${ECO}^{{z}_{T} ( α )} = {\int }_{{C}_{B}}^{b} L ( c ) {f}_{T} ( c ) d c = {\int }_{{C}_{B}}^{b} ( c - {C}_{B} ) {f}_{T} ( d ) d c for {c}^{*} < c \leq b .$$

In one example, let us consider a project whose cost probability distribution is Triangular and is described by: C˜T(a=10; c*=12; b=20).

The cost budgeting policy under the Triangular probability distribution is set at z_{T}(α=0.85), i.e. at the (1−α)=0.15 significance level. Hence, given that:

$${F}_{T} ( c ) = 1 - \frac{{( b - c )}^{2}}{( b - a ) ( b - {c}^{*} )} = α = 0.85 for {c}^{*} < c \leq b .$$

It follows that:

C_{B}^{z}^{_{T}}^{(α=0.95)}=F_{T}⁻¹(α0.95)=c_{0.95}=b−\sqrt{(1−α)(b−a)(b−c*)}

i.e.: C_{B}^{z}^{_{T}}^{(α=0.95)}=c_{0.95}=20−\sqrt{(0.05)(10)(8)}=18

Therefore, a unique and exact closed-form solution to the ECO equation under a Triangular probability distribution will be given by:

$${ECO}^{{z}_{T} ( α )} = \frac{2}{( b - a ) ( b - {c}^{*} )} \{ ( {C}_{B} + b ) ( \frac{{b}^{2}}{2} - \frac{{C}_{B}^{2}}{2} ) - {C}_{B} b ( b - {C}_{B} ) - ( \frac{{b}^{3}}{3} - \frac{{C}_{B}^{3}}{3} ) \}$$

$${ECO}^{{z}_{T} ( α = 0.95 )} = \frac{2}{( 10 ) ( 8 )} \{ ( 18 + 20 ) ( \frac{{20}^{2}}{2} - \frac{{( 18 )}^{2}}{2} ) - ( 18 ) ( 20 ) ( 20 - 18 ) - ( \frac{{20}^{3}}{3} - \frac{{( 18 )}^{3}}{3} ) \}$$

$$\begin{matrix}{ECO}^{{z}_{T} ( α = 0.95 )} = {CR}_{C}^{{z}_{T ( α = 095 )}} = 0.0333 . & \end{matrix}$$

When the cost budgeting policy under the Triangular probability distribution is set at z_{T}(α=0.97), i.e. at the (1−α)=0.03 significance level. Hence, given that:

$${F}_{T} ( c ) = 1 - \frac{{( b - c )}^{2}}{( b - a ) ( b - {c}^{*} )} = α = 0.97 for {c}^{*} < c \leq b .$$

It follows that:

C_{B}^{z}^{_{T}}^{(α=0.97)}=F_{T}⁻¹(α0.97)=c_{0.97}=b−\sqrt{(1−α)(b−a)(b−c*)};

i.e.: C_{B}^{z}^{_{T}}^{(α=0.97)}=c_{0.97}=20−\sqrt{(0.03)(10)(8)}=18.45.

Therefore, a unique and exact closed-form solution to the ECO equation under a Triangular probability distribution will be given by:

$${ECO}^{{z}_{T} ( α )} = \frac{2}{( b - a ) ( b - {c}^{*} )} \{ ( {C}_{B} + b ) ( \frac{{b}^{2}}{2} - \frac{{C}_{B}^{2}}{2} ) - {C}_{B} b ( b - {C}_{B} ) - ( \frac{{b}^{3}}{3} - \frac{{C}_{B}^{3}}{3} ) \}$$

$${ECO}^{{z}_{T} ( α = 0.95 )} = \frac{2}{( 10 ) ( 8 )} \{ ( 18.45 + 20 ) ( \frac{{20}^{2}}{2} - \frac{{( 18.45 )}^{2}}{2} ) - ( 18.45 ) ( 20 ) ( 20 - 18.45 ) - ( \frac{{20}^{3}}{3} - \frac{{( 18.45 )}^{3}}{3} ) \}$$

$${ECO}^{{z}_{T} ( α = 0.97 )} = {CR}_{C}^{{z}_{T ( α = 097 )}} = 0.0155 .$$

These results are summarized in the table below and illustrated in FIG. 34D:

TABLE 37
The Project Cost Contingency Reserve & Budget Under a Triangular Cost
Probability Distribution For Various Cost Budgeting Policies with
The Expected Cost Overrun Risk Measure

| Project Cost | | Project Cost | |
|---|---|---|---|
| Overrun | | Overrun | |
| Probability: | | Contingency | Project Cost |
| Significance level | Project Cost | Reserve | Budget |
| Pr(C ≥ C_{B}^{z}^{_{T}}^{(α)}) = | Baseline | CR_{C}^{z}^{_{T}}^{(α)} = | B_{C}^{z}^{_{T}}^{(α)} = |
| 1 − α | C_{B}^{z}^{_{T}}^{(α)} | ECO^{z}^{_{T}}^{(α)} | C_{B}^{z}^{_{T}}^{(α)} + CR_{C}^{z}^{_{T}}^{(α)} |
| 0.15 | 16.53 | 0.1741 | 16.7041 |
| 0.10 | 17.17 | 0.0944 | 17.2644 |
| 0.05 | 18.00 | 0.0333 | 18.0333 |
| 0.03 | 18.45 | 0.0155 | 18.4655 |

$\begin{matrix}{ECO}^{{2}_{T} ( α )} = \frac{2}{( b - a ) ( b - {c}^{*} )} \\ \{ ( {C}_{B} + b ) ( \frac{{b}^{2}}{2} - \frac{{C}_{B}^{2}}{2} ) - {C}_{B} b ( b - {C}_{B} ) - ( \frac{{b}^{3}}{3} - \frac{{C}_{B}^{3}}{3} ) \}\end{matrix}$
PROJECT COST PDF C~T(a = 10; c* = 12; b = 20)

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims. Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the disclosure.

What is claimed is:

1. A risk assessment and project management system, said project comprising a plurality of project-related activities, the system comprising:
a computing device comprising internal memory and an input interface, said input interface operable to receive and store in said internal memory project-related information comprising:
for each activity in said plurality of project-related activities:
a set of input values corresponding to a designated assessment metric of said project; and
at least one set of risk factors, each of said at least one set of risk factors comprising:
an associated risk acceptance policy z(α); and
one or more sets of risk factor parameters, each set of risk factor parameters comprising:
a probability of occurrence;
a set of percentage-wise most likely impact values on said set of input values; and
the computing device further comprising at least one digital processor communicatively linked to said internal memory and said input interface and programmed to:
derive, for each set of risk factors in said at least one set of risk factors, a baseline and an overrun contingency reserve corresponding to the associated risk acceptance policy of said each set of risk factors and to said designated assessment metric; and
combine said baseline and said overrun contingency reserve for each of said at least one set of risk factors into a single program baseline and program overrun contingency reserve, respectively.

2. The system of claim 1, wherein said deriving includes:
computing, for each of said at least one set of risk factors, a single probability distribution;
generating said baseline from said single probability distribution at said associated risk acceptance policy; and
defining said overrun contingency reserve from said single probability distribution at said associated risk acceptance policy.

3. The system of claim 2, wherein said baseline is generated at least from the expectation value and variance of said single probability distribution at said associated risk acceptance policy.

4. The system of claim 3, wherein said defining said overrun contingency reserve from said single probability distribution at said associated risk acceptance policy comprises:
computing an overrun tail expectation of said single probability distribution above said baseline at a (1−α) significance level corresponding to said risk acceptance policy z(α) using an overrun loss function.

5. The system of claim 2, wherein said computing said single probability distribution characterizing each of said at least one set of risk factors comprises the steps of:
for each set of risk factors in said at least one set of risk factors, independently:
for each activity in said project-related activities:
compound said probability of occurrence and said percentage-wise most likely impact value on said set of input values for said activity to obtain a corresponding set of compounded values;
characterize said activity via a probability distribution from said set of compounded values;
combine said probability distribution characterizing each activity into a corresponding said single probability distribution characterizing said plurality of project-related activities for said each set of risk factors in at least one set of risk factors on said project.

6. The system of claim 5, wherein said set input values comprises an estimated minimum value, an estimated most likely value and an estimated maximum value of said assessment metric, and wherein said corresponding set of compounded values comprises a compounded minimum value, a compounded most likely value, and a compounded maximum value.

7. The system of claim 6, wherein said probability distribution is a Normal probability distribution and said characterizing said activity via a probability distribution from said set of compounded values comprises:
constructing a PERT-Beta probability distribution using said compounded minimum value, compounded maximum value and compounded most likely value;
defining said normal probability distribution as having the same expected value and variance as said PERT-Beta probability distribution.

8. The system of claim 1, wherein said project is included in a project portfolio, said project portfolio comprising a multiplicity of projects, the system further being operable to, via said input interface, to receive:
said project-related information for each project in said project portfolio;
a set of correlation coefficients characterizing the correlation between the assessment metric of each project in said project portfolio; and
wherein said at least one digital processor being further programmed to:
for each set of risk factors in said at least one set of risk factors:
for each project in said project portfolio:
computing said one probability distribution; and
combining the one probability distribution of each project to define a corresponding portfolio probability distribution;
deriving a portfolio baseline and portfolio overrun contingency reserve at said corresponding risk acceptance policy;
combining each portfolio baseline to obtain a portfolio program baseline and each portfolio overrun contingency reserve to obtain a portfolio program overrun contingency reserve.

9. The system of claim 1, wherein said designated assessment metric is either one of: an execution cost or an execution time.

10. A computer-implemented risk assessment and project management method, said project comprising a plurality of project-related activities, comprising the steps of:
receiving, on a computing device comprising at least one digital processor communicatively coupled to an internal memory and an input interface, project-related information comprising:
for each activity in said plurality of project-related activities:
a set of input values corresponding to a designated assessment metric of said project; and
at least one set of risk factors, each of said at least one set of risk factors comprising:
an associated risk acceptance policy z(α); and
one or more sets of risk factor parameters, each set of risk factor parameters comprising:
a probability of occurrence;
a set of percentage-wise most likely impact values on said set of input values; and
deriving, by said computing device, for each set of risk factors in said at least one set of risk factors, a baseline and an overrun contingency reserve corresponding to the associated risk acceptance policy of said each set of risk factors and to said designated assessment metric; and
combining, by said computing device, said baseline and said overrun contingency reserve for each of said at least one set of risk factors into a single program baseline and program overrun contingency reserve, respectively.

11. The computer-implemented method of claim 10, wherein said deriving by said computing device includes:
computing, for each of said at least one set of risk factors, a single probability distribution;
generating said baseline from said single probability distribution at said associated risk acceptance policy; and
defining said overrun contingency reserve from said single probability distribution at said associated risk acceptance policy.

12. The computer-implemented method of claim 11, wherein said baseline is generated at least from the expectation value and variance of said single probability distribution at said associated risk acceptance policy.

13. The computer-implemented method of claim 12, wherein said defining said overrun contingency reserve from said single probability distribution at said associated risk acceptance policy comprises:
computing an overrun tail expectation of said single probability distribution above said baseline at a (1−α) significance level corresponding to said risk acceptance policy z(α) using an overrun loss function.

14. The computer-implemented method of claim 11, wherein said computing said single probability distribution characterizing each of said at least one set of risk factors comprises the steps of:
for each set of risk factors in said at least one set of risk factors, independently:
for each activity in said project-related activities:
compound said probability of occurrence and said percentage-wise most likely impact value on said set of input values for said activity to obtain a corresponding set of compounded values;
characterize said activity via a probability distribution from said set of compounded values;
combine said probability distribution characterizing each activity into said single probability distribution characterizing said plurality of project-related activities for said each set of risk factors in at least one set of risk factors on said project.

15. The computer-implemented method of claim 14, wherein said set input values comprises an estimated minimum value, an estimated most likely value, and an estimated maximum value of said assessment metric, and wherein said corresponding set of compounded values comprises a compounded minimum value, a compounded most likely value, and a compounded maximum value.

16. The computer-implemented method of claim 15, wherein said probability distribution is a Normal probability distribution and said characterizing said activity via a probability distribution from said set of compounded values comprises:
constructing a PERT-Beta probability distribution using said compounded minimum value, compounded maximum value and compounded most likely value;
defining said normal probability distribution as having the same expected value and variance as said PERT-Beta probability distribution.

17. The computer-implemented method of claim 10, wherein said project is included in a project portfolio, said project portfolio comprising a multiplicity of projects, the system further being operable to, via said input interface, to receive:
said project-related information for each project in said project portfolio;
a set of correlation coefficients characterizing the correlation between the assessment metric of each project in said project portfolio; and
wherein said at least one digital processor being further programmed to:
for each set of risk factors in said at least one set of risk factors:
for each project in said project portfolio:
computing said one probability distribution; and
combining the one probability distribution of each project to define a corresponding portfolio probability distribution;
deriving a portfolio baseline and portfolio overrun contingency reserve at said corresponding risk acceptance policy;
combining each portfolio baseline to obtain a portfolio program baseline and each portfolio overrun contingency reserve to obtain a portfolio program overrun contingency reserve.

18. The computer-implemented method of claim 10, wherein said designated assessment metric is either one of: an execution cost or an execution time.

19. A non-transitory computer-readable medium having statements and instructions stored thereon to be executed by a digital processor to automatically:
receive:
project-related information comprising:
for each activity in said plurality of project-related activities:
a set of input values corresponding to a designated assessment metric of said project; and
at least one set of risk factors, each of said at least one set of risk factors comprising:
an associated risk acceptance policy z(α); and
one or more sets of risk factor parameter, each set of risk factor parameters comprising:
a probability of occurrence;
a set of percentage-wise most likely impact values on said set of input values; and
derive, for each set of risk factors in said at least one set of risk factors, a baseline and an overrun contingency reserve corresponding to the associated risk acceptance policy of said each set of risk factors and to said designated assessment metric; and
combine said baseline and said overrun contingency reserve for each of said at least one set of risk factors into a single program baseline and program overrun contingency reserve, respectively.

20. The non-transitory computer-readable medium of claim 19, wherein said deriving includes:
computing, for each of said at least one set of risk factors, a single probability distribution;
generating said baseline from said single probability distribution at said associated risk acceptance policy; and
defining said overrun contingency reserve from said single probability distribution at said associated risk acceptance policy; and
wherein said single probability distribution is selected from the group consisting of: a normal probability distribution, a lognormal probability distribution, a triangular probability distribution or a uniform probability distribution.
